(19) United States
(12) Patent Application Publication
(10) Pub. No.: US 2026/0056546 A1
(43) Pub. Date: Feb. 26, 2026

(54) INFORMATION PROCESSING METHOD, TERMINAL, AND RECORDING MEDIUM

(71) Applicant: Panasonic Intellectual Property Management Co., Ltd., Osaka (JP)

(72) Inventors: Motoshi ANABUKI, Hyogo (JP); Stephen William JOHN, Nara (JP); Koji KAMIYAMA, Osaka (JP); Sicong HUANG, Saitama (JP); Yuta SHIMOTSUMA, Osaka (JP); Yusuke KUSHIKI, Osaka (JP); Shunsuke KUHARA, Osaka (JP); Yoshimasa HONDA, Hyogo (JP)

(21) Appl. No.: 19/371,716

(22) Filed: Oct. 28, 2025

Related U.S. Application Data
(63) Continuation of application No. PCT/JP2024/010057, filed on Mar. 14, 2024.

(30) Foreign Application Priority Data
May 11, 2023 (JP) 2023-078802

(51) Int. Cl. G05D 1/227; G05D 107/10

(52) U.S. Cl. CPC G05D 1/2279; G05D 2107/10

(57) ABSTRACT

An information processing method for remote control of one or more mobile bodies including a first mobile body by one or more operators including a first operator includes: obtaining an assignment request for assigning responsibility for remote control of the first mobile body to the first operator; obtaining, from the first operator, an operation regarding whether the assignment request obtained is acknowledged; and assigning the responsibility for the first mobile body and a right to operate the first mobile body to the first operator, when a first operation acknowledging the assignment request is obtained from the first operator.

### CROSS REFERENCE TO RELATED APPLICATIONS

This is a continuation application of PCT International Application No. PCT/JP2024/010057 filed on Mar. 14, 2024, designating the United States of America, which is based on and claims priority of Japanese Patent Application No. 2023-078802 filed on May 11, 2023. The entire disclosures of the above-identified applications, including the specifications, drawings, and claims are incorporated herein by reference in their entirety.

### FIELD

The present disclosure relates to an information processing method, a terminal, and a recording medium.

### BACKGROUND

Patent Literature (PTL) 1 discloses a system in which a plurality of mobile bodies are remotely controlled by a plurality of operators.

### CITATION LIST

### Patent Literature

PTL 1: Japanese Patent No. 6980609

### SUMMARY

### Technical Problem

There are cases where an operator that is remotely controlling a mobile device is substituted (relieved) while the mobile device is traveling, or the like. In such a case, it is desirable that the substitution of the operator is executed properly. However, in PTL 1, operator substitution is not taken into consideration.

In view of this, the present disclosure provides an information processing method, a terminal, and a recording medium that enable proper execution of operator substitution.

### Solution to Problem

An information processing method according to an aspect of the present disclosure is an information processing method to be executed by an information processing system for remote control of one or more mobile bodies including a first mobile body by one or more operators including a first operator. The information processing method includes: obtaining an assignment request for assigning responsibility for remote control of the first mobile body to the first operator or an autonomous travel system of the first mobile body; obtaining, from the first operator or the autonomous travel system, information on whether the assignment request obtained is acknowledged; and assigning the responsibility for the first mobile body to the first operator or the autonomous travel system, when information acknowledging the assignment request is obtained.

A terminal according to an aspect of the present disclosure is a terminal for remote control of one or more mobile bodies including a first mobile body by one or more operators including a first operator. The terminal includes: a first obtainer that obtains an assignment request for assigning responsibility for remote control of the first mobile body to the first operator; a second obtainer that obtains, from the first operator, an operation regarding whether the assignment request obtained is acknowledged; and a processing unit that assigns the responsibility for the first mobile body and a right to operate the first mobile body to the first operator, when a first operation acknowledging the assignment request is obtained from the first operator.

A recording medium according to an aspect of the present disclosure is a non-transitory computer-readable recording medium having recorded thereon a program for causing a computer to execute the information processing method described above.

### Advantageous Effects

An aspect of the present disclosure is capable of realizing an information processing method, and so on, that enables proper execution of operator substitution.

### BRIEF DESCRIPTION OF DRAWINGS

These and other advantages and features will become apparent from the following description thereof taken in conjunction with the accompanying Drawings, by way of non-limiting examples of embodiments disclosed herein.

FIG. 1 is a diagram illustrating the outline configuration of a remote control system according to an embodiment.

FIG. 2 is a block diagram illustrating the functional configuration of a terminal according to the embodiment.

FIG. 3 is a block diagram illustrating the functional configuration of a control server according to the embodiment.

FIG. 4 is a diagram illustrating information of a storage device according to an embodiment.

FIG. 5 is a block diagram illustrating the functional configuration of a mobile device according to the embodiment.

FIG. 6 is a diagram illustrating forms of remote control according to the embodiment.

FIG. 7 is a flowchart illustrating operations of a side sending an assignment request in the remote control system according to the embodiment.

FIG. 8 is a diagram illustrating screens that are displayed in a display portion of a side sending an assignment request, according to the embodiment.

FIG. 9 is a flowchart illustrating the operations of a side receiving an assignment request in the remote control system according to the embodiment.

FIG. 10 is a diagram illustrating screens that are displayed in the display portion of the side receiving the assignment request in the remote control system according to the embodiment.

FIG. 11 is a flowchart illustrating the operations of a side sending an assignment request in a remote control system according to Variation 1 of the embodiment.

FIG. 12 is a flowchart illustrating the operations of a side sending an assistance request in a remote control system according to Variation 2 of the embodiment.

FIG. 13 is a diagram illustrating screens that are displayed in the display portion of the side sending the assistance request in the remote control system according to Variation 2 of the embodiment.

FIG. 14 is a flowchart illustrating the operations of a side receiving the assistance request in the remote control system according to Variation 2 of the embodiment.

FIG. 15 is a diagram illustrating screens that are displayed in the display portion of the side receiving the assistance request in the remote control system according to Variation 2 of the embodiment.

FIG. 16 is a flowchart illustrating the operations of a side sending an assistance request in a remote control system according to Variation 3 of the embodiment.

FIG. 17 is a flowchart illustrating the operations of a side sending an acceptance request in a remote control system according to Variation 4 of the embodiment.

FIG. 18 is a diagram illustrating a first screen that is displayed in the display portion of the side sending the acceptance request in the remote control system according to Variation 4 of the embodiment.

FIG. 19 is a diagram illustrating second screens that are displayed in the display portion of the side sending the acceptance request in the remote control system according to Variation 4 of the embodiment.

FIG. 20 is a flowchart illustrating the operations of a side receiving the acceptance request in the remote control system according to Variation 4 of the embodiment.

FIG. 21 is a diagram illustrating screens that are displayed in the display portion of the side receiving the acceptance request in the remote control system according to Variation 4 of the embodiment.

FIG. 22 is a flowchart illustrating the operations of a side receiving an assignment request in the remote control system according to Variation 5 of the embodiment.

FIG. 23 is a diagram illustrating traveling task data according to Variation 5 of the embodiment.

FIG. 24 is a diagram illustrating manual data according to Variation 5 of the embodiment.

FIG. 25 is a diagram illustrating a screen that is displayed in the display portion of the side receiving the assistance request in remote control system according to Variation 5 of the embodiment.

FIG. 26 is a flowchart illustrating the operations of a side sending an assistance request in a remote control system according to Variation 6 of the embodiment.

FIG. 27 is a diagram illustrating mobile body information according to Variation 6 of the embodiment.

FIG. 28 is a diagram illustrating peripheral environment information according to Variation 6 of the embodiment.

FIG. 29 is a diagram illustrating manual data according to Variation 6 of the embodiment.

FIG. 30 is a flowchart illustrating the operations of a control server in a remote control system according to Variation 7 of the embodiment.

FIG. 31 is a diagram illustrating traveling task data according to Variation 7 of the embodiment.

FIG. 32 is a diagram illustrating ability information of an operator according to Variation 7 of the embodiment.

FIG. 33 is a diagram illustrating level information of the ability of the operator according to Variation 7 of the embodiment.

FIG. 34 is a diagram illustrating required ability information according to Variation 7 of the embodiment.

FIG. 35 is a flowchart illustrating the operations of an automated driving system in a remote control system according to Variation 8 of the embodiment.

FIG. 36 is a diagram illustrating autonomous traveling ODD information according to Variation 8 of the embodiment.

FIG. 37 is a flowchart illustrating the operations of a side receiving an assistance request in the remote control system according to Variation 8 of the embodiment.

FIG. 38 is a diagram illustrating screens that are displayed in a display portion of the side receiving the assistance request in the remote control system according to Variation 8 of the embodiment.

FIG. 39 is a flowchart illustrating the operations of a side sending a responsibility assignment request in a remote control system according to Variation 9 of the embodiment.

FIG. 40 is a diagram illustrating screens that are displayed in a display portion of the side sending the responsibility assignment request in the remote control system according to Variation 9 of the embodiment.

FIG. 41 is a flowchart illustrating the operations of an automated driving system side in the remote control system according to Variation 9 of the embodiment.

FIG. 42 is a sequence diagram illustrating a first example of operations in a case where it becomes impossible to fulfill control responsibility in the remote control system according to Variation 10 of the embodiment.

FIG. 43 is a sequence diagram illustrating a second example of operations in a case where it becomes impossible to fulfill the control responsibility in the remote control system according to Variation 10 of the embodiment.

FIG. 44 is a sequence diagram illustrating a third example of operations in a case where it becomes impossible to fulfill the control responsibility in the remote control system according to Variation 10 of the embodiment.

FIG. 45 is a flowchart illustrating the operations of a remote control system according to Variation 11 of the embodiment.

FIG. 46 is a diagram illustrating a screen that is displayed in a display portion of an administrator in the remote control system according to Variation 11 of the embodiment.

FIG. 47 is a flowchart illustrating the operations of a side sending a responsibility assignment request in the remote control system according to Variation 11 of the embodiment.

FIG. 48 is a diagram illustrating screens that are displayed in a display portion of the side sending the responsibility assignment request in the remote control system according to Variation 11 of the embodiment.

FIG. 49 is a flowchart illustrating the operations of a side receiving the responsibility assignment request in the remote control system according to Variation 11 of the embodiment.

FIG. 50 is a diagram illustrating screens that are displayed in a display portion of the side receiving the responsibility assignment request in the remote control system according to Variation 11 of the embodiment.

### DESCRIPTION OF EMBODIMENTS

### (Circumstances Leading to the Present Disclosure)

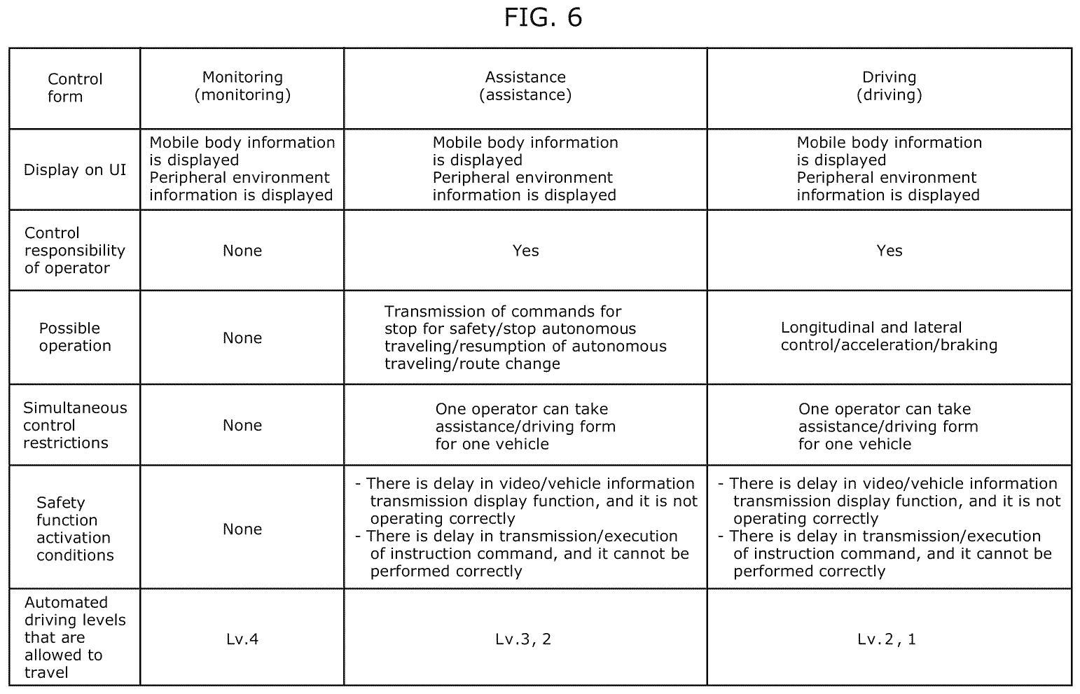

There are a plurality of control forms (refer to FIG. 6 described below) for remote control of hundreds of mobile bodies (for example, automatically traveling mobile bodies) shared among a plurality of operators, and the operators have driving duty depending on the control forms.

Furthermore, an operator who performs remote control bears the responsibility (control responsibility) for remote control. Therefore, when substituting the operator who is performing remote control on mobile bodies, it is desirable that it is clear who holds the control responsibility. That is, when substituting operators, from the perspective of clarifying who holds the control responsibility, it is desirable that the substitution of operators is executed appropriately. It should be noted that the control responsibility is the responsibility for remote assistance or remote operation of a mobile body, and the responsibility to incur legal disadvantages or sanctions when an accident or the like occurs during traveling of the mobile body. It should be noted that, hereinafter, the responsibility for remote control is also simply referred to as the responsibility or the control responsibility.

When an operator has control duty (for example, driving duty), it is assumed that a mobile body is stopped and then the operator is substituted with another operator, but this is inefficient. Therefore, for example, an information processing method is desirable that is capable of substituting an operator while a mobile body is autonomously traveling. That is, when substituting an operator, from the perspective of further improving the efficiency in substitution of the operator, it is desirable that the substitution of operators is executed appropriately. Accordingly, it is possible to perform seamless assignment of the control responsibility while a mobile body is traveling, and the time loss due to the substitution of operators can be reduced.

PTL 1 described above does not disclose a technique of appropriately executing such substitution of operators. Therefore, the present inventors conducted extensive studies on an information processing method and the like capable of appropriately executing the substitution of operators, and invented the information processing method and the like illustrated below.

An information processing method according to an aspect of the present disclosure is an information processing method to be executed by an information processing system for remote control of one or more mobile bodies including a first mobile body by one or more operators including a first operator. The information processing method includes: obtaining an assignment request for assigning responsibility for remote control of the first mobile body to the first operator or an autonomous travel system of the first mobile body; obtaining, from the first operator or the autonomous travel system, information on whether the assignment request obtained is acknowledged; and assigning the responsibility for the first mobile body to the first operator or the autonomous travel system, when information acknowledging the assignment request is obtained.

Accordingly, assignment is actually carried out when the first operator or the autonomous travel system acknowledges the assignment request. In other words, responsibility can be more reliably transferred to the first operator or the autonomous travel system. Therefore, since it is clear who holds responsibility for the mobile body during operator substitution, or the like, substitution of operators, or the like, can be appropriately executed.

Furthermore, for example, an information processing method according to a second aspect is the information processing method according to the first aspect that may further include assigning a right to operate the first mobile body to the first operator or the autonomous travel system independently of the responsibility for the first mobile body, when the information acknowledging the assignment request is obtained.

Accordingly, the right to operate the first mobile body can be assigned to the first operator or the autonomous travel system independently of the responsibility. Therefore, since it is clear who holds the responsibility for the mobile body and the right to operate the mobile body during operator substitution, or the like, substitution of operators, or the like, can be more appropriately executed.

Furthermore, for example, an information processing method according to a third aspect is the information processing method according to the second aspect in which the responsibility for the first mobile body and the right to operate the first mobile body may be assigned to the first operator or the autonomous travel system at mutually different timings.

Accordingly, even when the responsibility for the first mobile body and the right to operate the mobile body are assigned at mutually different timings, substitution of operators, or the like, can be appropriately executed.

Furthermore, for example, an information processing method according to a fourth aspect is the information processing method according to the third aspect in which the responsibility for the first mobile body may be assigned to the first operator or the autonomous travel system at an earlier timing than the right to operate the first mobile body is.

Accordingly, even when the responsibility for the first mobile body is assigned before the right to operate, substitution of operators, or the like, can be appropriately executed.

Furthermore, for example, an information processing method according to a fifth aspect is the information processing method according to the third aspect in which the right to operate the first mobile body may be assigned to the first operator or the autonomous travel system at an earlier timing than the responsibility for the first mobile body is.

Accordingly, even when the right to operate the first mobile body is assigned before the responsibility, substitution of operators, or the like, can be appropriately executed.

Furthermore, for example, an information processing method according to a sixth aspect is the information processing method according to any one of the second to fifth aspects that may further include presenting, to the first operator, that the responsibility for the first mobile body has been assigned to the first operator and that the right to operate the first mobile body has been assigned to the first operator, using mutually different modes.

Accordingly, since the fact that the responsibility has been assigned and the fact that the right to operate has been assigned are each displayed using a different mode, the assignment status can be easily checked.

Furthermore, for example, an information processing method according to a seventh aspect is the information processing method according to any one of the second to sixth aspects in which the assignment request may be a request for assigning part of the responsibility for the first mobile body, and when an operation acknowledging the assignment request is obtained, the part of the responsibility for the first mobile body and part of the right to operate the first mobile body may be assigned to the first operator or the autonomous travel system.

Accordingly, one mobile body can be remotely controlled by a plurality of operators. Mobile bodies include a special mobile body that cannot be remotely controlled without a plurality of operators. The information processing method according to the present disclosure can also be applied to such a special mobile body.

Furthermore, for example, an information processing method according to an eighth aspect is the information processing method according to any one of the first to seventh aspects that may further include presenting details of the remote control performed on the first mobile body to the first operator, when the assignment request is obtained; and after the presenting of the details, obtaining, from the first operator, an operation regarding whether the assignment request is acknowledged.

Accordingly, the first operator can determine whether or not to acknowledge the assignment request after checking reference information for determining whether or not to acknowledge the assignment request.

Furthermore, for example, an information processing method according to a ninth aspect is the information processing method according to any one of the first to eighth aspects that may further include obtaining ability information indicating an ability of each of the one or more operators relating to the remote control; and determining, based on the ability information obtained, whether the first operator has an ability suited for the remote control performed on the first mobile body. The assignment request for assigning the responsibility for the first mobile body to the first operator may be obtained when the first operator is determined to have the ability suited for the remote control performed on the first mobile body.

Accordingly, since the assignment request to the first operator is performed when the first operator has the ability suited for the first mobile body, remote control after the substitution of the operator can be appropriately performed.

Furthermore, for example, an information processing method according to a tenth aspect is the information processing method according to any one of the first to ninth aspects in which: the one or more operators may include a second operator who performs remote control on the first mobile object; the information processing method may further include obtaining, from the second operator, an operation indicating assignment of the responsibility for the first mobile body; the assignment request to the first operator may be notified through the obtaining of the operation; and the information processing method may further include presenting, to the second operator, information indicating that the assignment request for the responsibility for the first mobile body is being notified.

Accordingly, assignment of responsibility from the second operator to the first operator can be appropriately executed.

Furthermore, for example, an information processing method according to an eleventh aspect is the information processing method according to any one of the first to tenth aspects in which the assignment request to the first operator may be notified from the autonomous travel system.

Accordingly, assignment of responsibility from the autonomous travel system to the first operator can be appropriately executed.

Furthermore, for example, an information processing method according to a twelfth aspect is the information processing method according to any one of the second to eleventh aspects in which: the assignment request may be transmitted to two or more terminals of two or more operators including the first operator, the two or more operators being included among the one or more operators; and the responsibility for the first mobile body and the right to operate the first mobile body may be assigned to the first operator when, among the two or more operators, the first operator is fastest to perform an operation acknowledging the assignment request.

Accordingly, assignment of responsibility to the first operator can be executed in a shorter time. Therefore, time loss due to operator substitution can be further reduced.

Furthermore, for example, an information processing method according to a thirteenth aspect is the information processing method according to any one of the second to twelfth aspects in which: the one or more mobile bodies may include a second mobile body; the one or more operators may include a third operator who performs remote control on the second mobile body; and the information processing method may further include: obtaining, from the first operator, an operation requesting acceptance of assignment of responsibility for the remote control of the second mobile body; transmitting, to a terminal of the third operator, an acceptance request requesting acceptance of assignment of the responsibility for the second mobile body, based on the operation obtained; and transferring the responsibility for the second mobile body and a right to operate the second mobile body, from the third operator to the first operator, when an operation indicating that the third operator has acknowledged the acceptance request is obtained.

Accordingly, even when the first operator transfers responsibility, substitution of operators can be appropriately executed. Therefore, substitution from one operator to another can be appropriately executed.

Furthermore, for example, an information processing method according to a fourteenth aspect is the information processing method according to any one of the second to thirteenth aspects in which: the one or more mobile bodies may include a third mobile body that is not under remote control by the one or more operators; and the information processing method may further include: presenting, to the first operator, information for remote control of the third mobile body; obtaining, from the first operator, a fifth operation indicating that remote control of the third mobile body is to be started; and transferring responsibility for the third mobile body and a right to operate the third mobile body to the first operator, based on the fifth operation obtained.

Accordingly, the responsibility for the third mobile body that is not being remotely controlled can be appropriately transferred to the first operator.

Furthermore, for example, an information processing method according to a fifteenth aspect is the information processing method according to any one of the first to fourteenth aspects in which: the one or more mobile bodies may include a fourth mobile body; the information processing method may further include: presenting, to the first operator, an operation component for receiving an operation indicating that remote control of the fourth mobile body is to be started; the operation component may be enabled when an ability of the first operator relating to the remote control satisfies an ability relating to remote control required to continue autonomous travel of the fourth mobile body.

Accordingly, remote control of the fourth mobile body can be performed by the first operator having the ability required to remotely control the fourth mobile body.

Furthermore, for example, an information processing method according to a sixteenth aspect is the information processing method according to any one of the second to fifteenth aspects in which, when the responsibility for the first mobile body and the right to operate the first mobile body are assigned to the first operator, another operator other than the first operator among the one or more operators need not be permitted to bear the responsibility for the first mobile body without permission of the first operator.

Accordingly, it is possible to prevent the responsibility for the first mobile body from being assigned against the will of the first operator who currently holds the responsibility.

Furthermore, for example, an information processing method according to a seventeenth aspect is the information processing method according to any one of the first to sixteenth aspects that may further include causing the first mobile body to execute a Minimal Risk Maneuver (MRM) that causes the first mobile body to take evasive action, when an operation refusing the assignment request is obtained from the first operator.

Accordingly, when the assignment request is refused, the first mobile body can be safely stopped.

Furthermore, for example, an information processing method according to an eighteenth aspect is the information processing method according to any one of the second to seventeenth aspects that may further include causing the first mobile body to execute a Minimal Risk Maneuver (MRM) that causes the first mobile body to take evasive action, when an anomaly relating to communication between a terminal of the first operator and the first mobile body or an anomaly in a system including the terminal and the first mobile body is detected after the responsibility for the first mobile body and the right to operate the first mobile body are assigned to the first operator.

Accordingly, when a communication anomaly or a system anomaly occurs, the first mobile body can be safely stopped.

Furthermore, a terminal according to a nineteenth aspect of the present disclosure is a terminal for remote control of one or more mobile bodies including a first mobile body by one or more operators including a first operator. The terminal includes: a first obtainer that obtains an assignment request for assigning responsibility for remote control of the first mobile body to the first operator or an autonomous travel system of the first mobile body; a second obtainer that obtains, from the first operator or the autonomous travel system, information on whether the assignment request obtained is acknowledged; and a processing unit that assigns the responsibility for the first mobile body to the first operator or the autonomous travel system, when information acknowledging the assignment request is obtained from the first operator or the autonomous travel system. Furthermore, a recording medium according to a twentieth aspect of the present disclosure is a non-transitory computer-readable recording medium having recorded thereon a program for causing a computer to execute the information processing method according to any one of the first to eighteenth aspects.

Accordingly, the same advantageous effect as that of the information processing method is produced.

It is to be noted that these general or specific aspects may be implemented as a system, a method, an integrated circuit, a computer program, or a non-transitory computer-readable recording medium such as a CD-ROM, or may be implemented as any combination of a system, a method, an integrated circuit, a computer program, and a recording medium. The program may be stored in advance in the recording medium or may be supplied to the recording medium via a wide area communication network such as the Internet.

Hereinafter, embodiments will be described in detail with reference to the Drawings.

It is to be noted that each of the following embodiments indicate a specific example of the present disclosure. The numerical values, shapes, constituent elements, the arrangement and connection of the constituent elements, steps, the processing order of the steps, etc., indicated in the following embodiments are mere examples, and thus are not intended to limit the present disclosure. Among the constituent elements described in the following embodiments, constituent elements not recited in any one of the independent claims will be described as optional constituent elements.

Furthermore, the respective figures are schematic diagrams and are not necessarily precise illustrations. Therefore, for example, the scaling, and so on, depicted in the drawings is not necessarily uniform. Furthermore, in the figures, elements which are substantially the same are given the same reference signs, and overlapping description is omitted or simplified.

Additionally, in the present Description, numerical values; and numerical ranges are not strictly defined and include a substantially same range which includes, for example, a margin of error of a few percent (or approximately 10%).

Furthermore, in the present Description, unless otherwise stated, ordinal numbers such as “first”, “second”, and so on, do not define the number or order of elements, and are used for the purpose of distinguishing between elements of the same type to avoid confusion.

### Embodiment

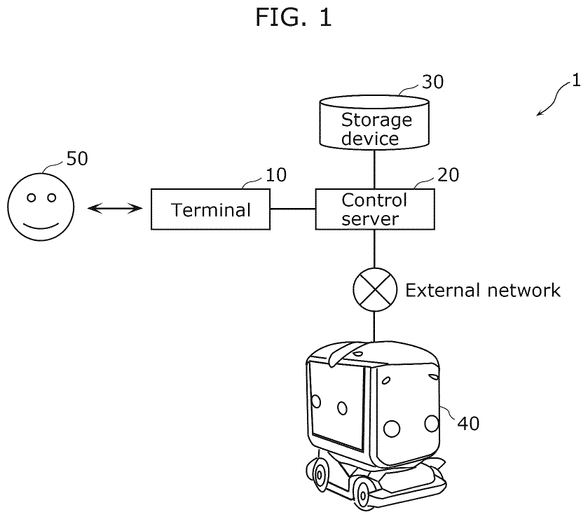

Hereinafter, a remote control system according to the present embodiment will be described with reference to FIG. 1 to FIG. 10.

### [1. Configuration of Remote Control System]

First, the configuration of a remote control system according to the present embodiment will be described with reference to FIG. 1 to FIG. 6. FIG. 1 is a diagram illustrating the outline configuration of remote control system 1 according to the present embodiment.

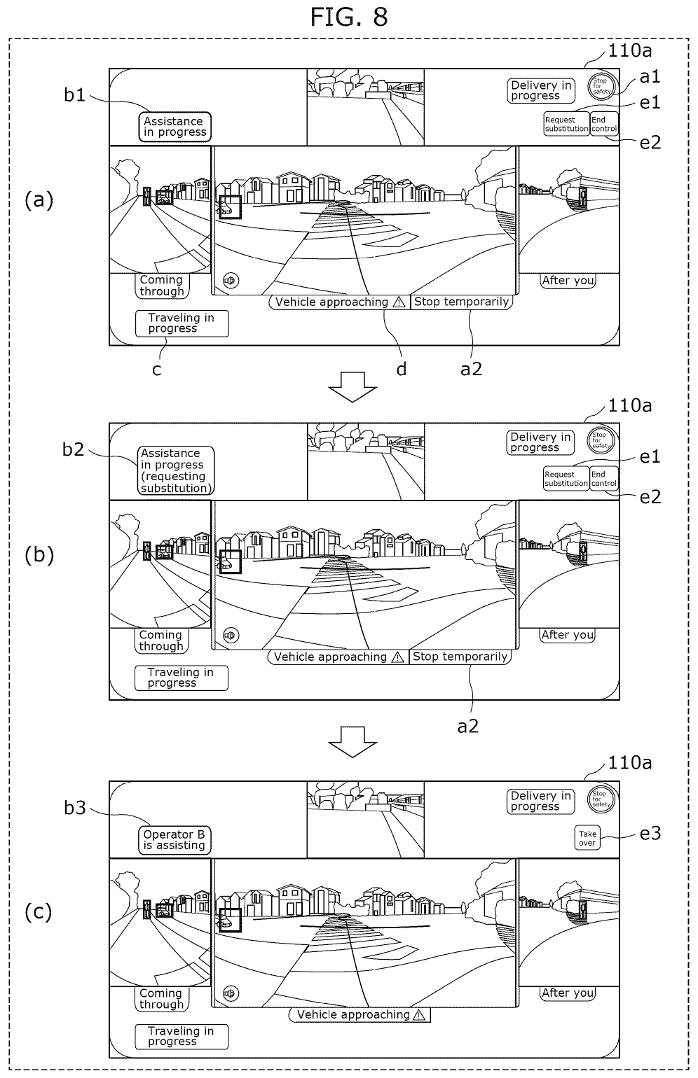

A remote control system is a system that is operated in a remote control center or a server device at which one or more operators 50 are located, and is a system for each operator 50 to perform remote monitoring, and in some cases remote assistance or remote operation, of one or more mobile bodies 40. Each operator 50 monitors the situation of each mobile body 40 displayed in display portion 110a (FIG. 8 and the like described below) by using, for example, terminal 10 such as a personal computer.

Furthermore, for example, when there is a request for remote assistance or remote operation from mobile body 40, or when each operator 50 determines that mobile body 40 is in a state to be remotely assisted or remotely operated, each operator 50 performs remote assistance or remote operation of mobile body 40. Furthermore, each operator 50 can be substituted with another operator 50 for the remote control of mobile body 40 as needed. When the remote control of mobile body 40 is substituted with another operator 50, remote control system 1 executes the processing for positively transferring the responsibility (control responsibility) for remote control to the other operator 50.

It should be noted that, hereinafter, remote assistance or remote operation is also referred to assistance/operation and remote correspondence.

As illustrated in FIG. 1, remote control system 1 includes terminal 10, control server 20, and storage device 30. Furthermore, remote control system 1 may further include one or more mobile bodies 40. Control server 20 and mobile bodies 40 are communicatively connected via an external network (for example, the Internet). Remote control system 1 is an information processing system for one or more operators to perform remote control on one or more mobile bodies 40.

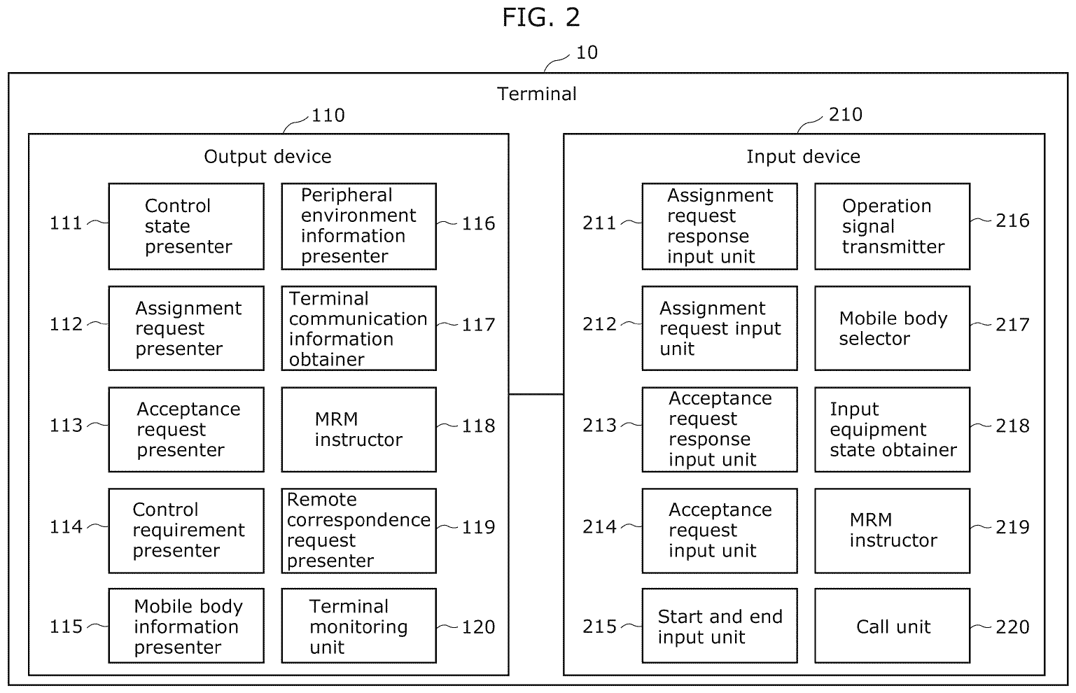

Terminal 10 is an operation terminal for operator 50 to perform operations and the like, and is arranged, for example, for each operator 50. FIG. 2 is a block diagram illustrating the functional configuration of terminal 10 according to the present embodiment. Terminal 10 includes a Central Processing Unit (CPU), a memory, and the like, and each function of terminal 10 is realized by executing, by the CPU, a program stored in the memory.

As illustrated in FIG. 2, terminal 10 includes output device 110 that presents information to operator 50, and input device 210 that receives an input (operation) from operator 50. Furthermore, terminal 10 is configured by including, for example, a display device such as a Liquid Crystal Display (LCD) device, and includes display portion 110a for displaying information to operator 50. Furthermore, terminal 10 may include a configuration unit that presents information by sound or the like.

Output device 110 includes control state presenter 111, assignment request presenter 112, acceptance request presenter 113, control requirement presenter 114, mobile body information presenter 115, peripheral environment information presenter 116, terminal communication information obtainer 117, MRM (Minimal Risk Maneuver: risk minimization control) instructor 118, remote correspondence request presenter 119, and terminal monitoring unit 120.

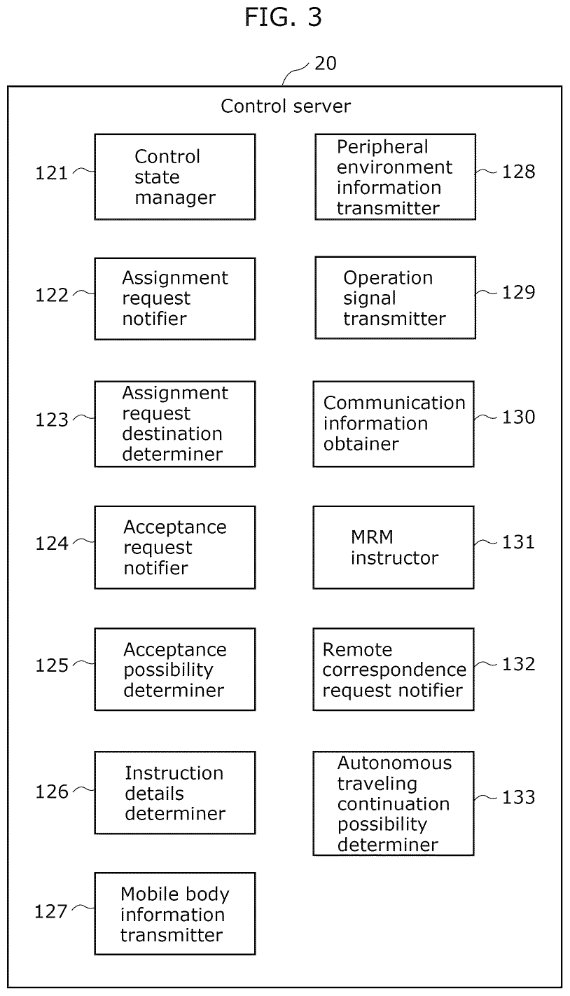

Control state presenter 111 executes the processing for presenting the state of remote control in remote control system 1. Control state presenter 111 presents, to operator 50, the information indicating which operator is 50 remotely controlling (monitoring/assisting/operating) which mobile body 40 via display portion 110a, based on, for example, the information managed by control state manager 121 (refer to FIG. 3 described below) of control server 20.

Assignment request presenter 112 executes the processing for presenting the information regarding the assignment request for control responsibility, when there is a notification from assignment request notifier 122 (refer to FIG. 3 described below) of control server 20. Assignment request presenter 112 presents, for example, the information indicating the assignment request to operator 50 via display portion 110a.

Acceptance request presenter 113 executes the processing for presenting the information regarding the acceptance request for control responsibility, when there is a notification from acceptance request notifier 124 (refer to FIG. 3 described below) of control server 20. Acceptance request presenter 113 presents, for example, the information indicating the acceptance request to operator 50 via display portion 110a.

Control requirement presenter 114 executes the processing for presenting the information regarding the control requirement, based on the information from instruction details determiner 126 (refer to FIG. 3 described below) of control server 20. Control requirement presenter 114 presents, for example, the information indicating the control requirement to operator 50 via display portion 110a. It should be noted that the control requirement includes at least one of: what should be checked by operator 50 for performing assistance/operation at the time of substitution of remote control; operation details; the information indicating required license (skills); and the like.

Mobile body information presenter 115 executes the processing for presenting the information regarding mobile body 40 to be remotely controlled, based on the information sent from mobile body information transmitter 127 (refer to FIG. 3 described below) of control server 20. Mobile body information presenter 115 presents, for example, the information regarding the state of mobile body 40, such as the vehicle speed, angular velocity, system state, and the like, of each mobile body 40 to operator 50 via display portion 110a.

Peripheral environment information presenter 116 executes the processing for presenting the peripheral environment information indicating the current peripheral environment of mobile body 40, based on the information about the surroundings of mobile body 40 sent from peripheral environment information transmitter 128 (refer to FIG. 3 described below) of control server 20. Peripheral environment information presenter 116 presents, for example, the peripheral environment information to operator 50 via display portion 110a. The peripheral environment information includes at least one of: sensing information of a camera, LiDAR, a radar, or the like mounted on mobile body 40; a target whose sensing information has been processed by machine learning, signal processing, and the like; a grid map; and the like.

Terminal communication information obtainer 117 executes the processing for obtaining the terminal communication information regarding the communication with terminal 10 and control server 20. Terminal communication information obtainer 117 obtains the communication information with control server 20, the mobile body information sent from control server 20, the End-to-End delay information of peripheral environment information, and the like. Terminal communication information obtainer 117 is configured by including, for example, a communication circuit (communication module). Furthermore, although the method of calculating the End-to-End delay information is not particularly limited, the End-to-End delay information may be calculated based on the timestamps attached to the mobile body information item and the peripheral environment information.

MRM instructor 118 transmits an MRM instruction signal as an operation signal to control server 20 or mobile body 40, when the communication state between terminal 10 and mobile body 40 becomes a predetermined state. The predetermined state may be, for example, that the communication by terminal communication information obtainer 117 has been disconnected, a delay (for example, a delay of a predetermined value or more) has been observed in the mobile body information item or the peripheral environment information, or the like. MRM instructor 118 is configured by including, for example, a communication circuit (communication module). Furthermore, MRM instructor 118 presents the display for receiving an operation for executing an MRM to operator 50 via display portion 110a.

Remote correspondence request presenter 119 executes the processing for presenting the information for notifying operator 50 that mobile body 40 requires remote assistance/operation, when there is a notification from remote correspondence request notifier 132 (refer to FIG. 3 described below) of control server 20. Remote correspondence request presenter 119 presents, for example, this information to operator 50 via display portion 110a.

Terminal monitoring unit 120 monitors whether or not an anomaly exists in terminal 10. Terminal monitoring unit 120 monitors, for example, whether or not the time in terminal 10 has been changed discontinuously. For example, terminal monitoring unit 120 monitors whether or not a time jump due to a leap second or the like has occurred.

Input device 210 includes assignment request response input unit 211, assignment request input unit 212, acceptance request response input unit 213, acceptance request input unit 214, start and end input unit 215, operation signal transmitter 216, mobile body selector 217, input equipment state obtainer 218, MRM instructor 219, and call unit 220. Input device 210 is configured by including, for example, a receiving device that receives an operation from operator 50, such as a touch panel and a button. Furthermore, input device 210 may be configured to receive an operation by sound, gesture, or the like.

Assignment request response input unit 211 executes the processing for receiving an input by operator 50 as to whether or not to request the assignment of control responsibility. For example, when there is a notification from assignment request notifier 122, assignment request response input unit 211 displays, in display portion 110a, the display (icon) for prompting an input as to whether or not to acknowledge the notification, obtains the input from operator 50 via a touch panel or the like, and notifies control state manager 121 of the obtained result. The result here includes, for example, that the assignment request has been approved or that the assignment request has been refused.

When operator 50 has control responsibility, assignment request input unit 212 executes the processing for assigning the control responsibility to another operators 50. When operator 50 has control responsibility, assignment request input unit 212 displays, for example, the display for assigning the control responsibility to another operators 50 in display portion 110a, obtains an input from operator 50 via a touch panel or the like, and notifies assignment request notifier 122 of the obtained result. The result here includes, for example, that operator 50 has performed the operation to assign the control responsibility that accrues to the operator 50 to another operator 50.

It should be noted that assignment request input unit 212 may notify assignment request notifier 122 of a result indicating whether or not to perform assignment, irrespective of an operation by operator 50. Assignment request input unit 212 may automatically transmit a notification indicating that assignment is to be performed, according to, for example, the state of at least one operator 50, remote control system 1, and mobile body 40.

Acceptance request response input unit 213 executes the processing for receiving an input by operator 50 as to whether or not to acknowledge the acceptance request for control responsibility. For example, when there is a notification from acceptance request notifier 124, acceptance request response input unit 213 displays the display for prompting an input as to whether or not to acknowledge the notification in display portion 110a, obtains the input from operator 50 via a touch panel or the like, and notifies control state manager 121 of the obtained result. The result here includes, for example, that the acceptance request has been approved or that the acceptance request has been refused.

Acceptance request input unit 214 executes the processing for receiving an input by operator 50 as to whether or not to accept the control responsibility borne by another operator 50. When acceptance request input unit 214 receives, for example, an input for accepting assignment of the control responsibility for mobile body 40 borne by another operator 50 from operator 50, acceptance request input unit 214 notifies acceptance request notifier 124 of the result.

It should be noted that acceptance request input unit 214 may notify acceptance request notifier 124 of the information indicating whether or not to accept assignment, irrespective of an operation from operator 50. Acceptance request input unit 214 may automatically notify the information indicating whether or not to accept assignment according to, for example, the state of at least one of operator 50, remote control system 1, and mobile body 40.

Start and end input unit 215 executes the processing for notifying control state manager 121 of the information indicating the start or end of assistance/operation of mobile body 40. Start and end input unit 215 displays the display for prompting operator 50 to input the start or end of assistance/operation of mobile body 40 in display portion 110a, obtains the input from operator 50 via a touch panel or the like, and notifies control state manager 121 of the obtained result.

Start and end input unit 215 determines whether a start or end condition is satisfied, based on at least one of Operational Design Domain (ODD) information and operator qualification information, and when start and end input unit 215 determines that the condition is not satisfied, start and end input unit 215 may transition to an inactive state. The inactive state is a state where a start or end operation from operator 50 is not received. For example, a case can be listed where mobile body 40 is traveling an environment where mobile body 40 cannot autonomously travel, and assistance/operation cannot be ended. It should be noted that traveling is an example of movement.

Operation signal transmitter 216 is a processing unit that transmits an operation signal for operating the movement of mobile body 40. Operation signal transmitter 216 transmits, to operation signal transmitter 129 of control server 20 or mobile body 40, remote operation information, and operation signals such as an autonomous traveling start/end instruction, an MRM instruction, a remote operation switching/cancellation instruction, and an error cancellation instruction from operation equipment (input equipment) such as a steering wheel.

Mobile body selector 217 receives the selection of mobile body 40 to be remotely controlled from operator 50. Mobile body selector 217 receives the selection when, for example, operator 50 desires to control specific mobile body 40. Mobile body selector 217 may be realized by, for example, a button or the like.

Input equipment state obtainer 218 obtains the state of operation equipment (for example, input device 60 illustrated in FIG. 43) such as a steering wheel. The state here includes the state relating to a malfunction such as a breakdown. It should be noted that operation equipment and terminal 10 are communicatively connected.

MRM instructor 219 executes the processing for transmitting an MRM instruction signal as an operation signal to mobile body 40. For example, when operation equipment such as a steering wheel is abnormal, MRM instructor 219 transmits the MRM instruction signal as the operation signal to mobile body 40.

Call unit 220 is a processing unit that realizes the function of making a call between operators 50. For example, when simultaneously controlling the same mobile body 40 by a plurality of persons, call unit 220 enables a call between operators 50.

With reference to FIG. 1 again, control server 20 is an information processing device for executing the processing for operator 50 to remotely control mobile body 40. Control server 20 may be set, for example, in a remote place different from a building in which terminal 10 is installed. Control server 20 is communicatively connected to, for example, a plurality of terminals 10. FIG. 3 is a block diagram illustrating the functional configuration of control server 20 according to the present embodiment.

As illustrated in FIG. 3, control server 20 includes control state manager 121, assignment request notifier 122, assignment request destination determiner 123, acceptance request notifier 124, acceptance possibility determiner 125, instruction details determiner 126, mobile body transmitter information 127, peripheral environment information transmitter 128, operation signal transmitter 129, communication information obtainer 130, MRM instructor 131, remote correspondence request notifier 132, and autonomous traveling continuation possibility determiner 133. Control server 20 includes a CPU, a memory, and the like, and each function of control server 20 is realized by executing, by the CPU, a program stored in the memory.

Control state manager 121 manages the control state of each of the plurality of operators 50. Control state manager 121 manages which operator 50 is monitoring/assisting/operating which mobile body 40.

Assignment request notifier 122 receives a notification from assignment request input unit 212, and issues an assignment request notification of control responsibility to operator 50.

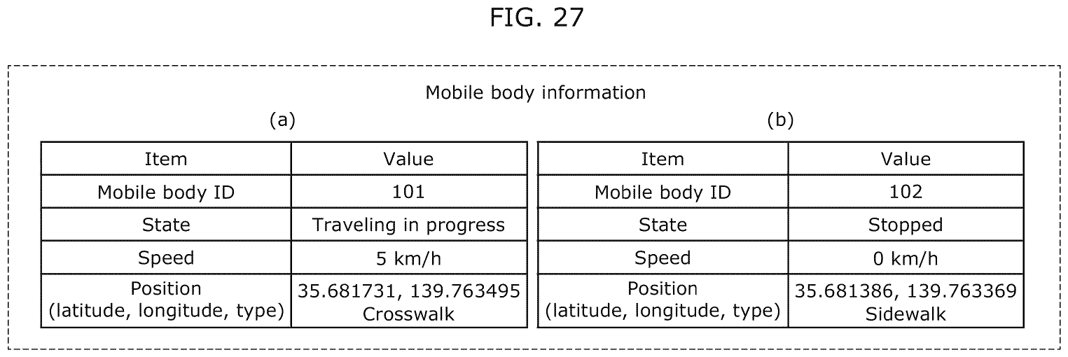

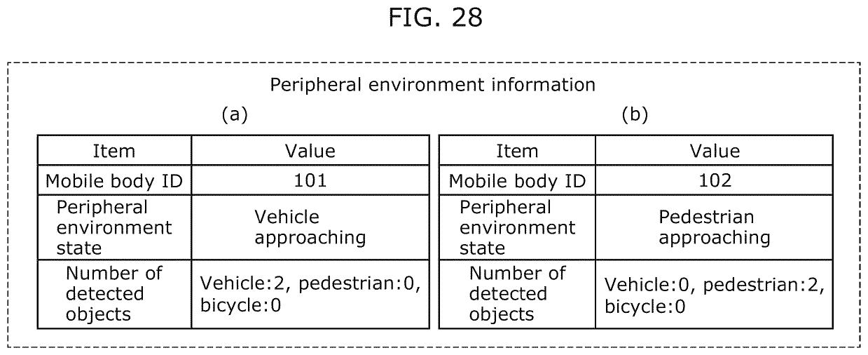

Assignment request destination determiner 123 executes the processing of narrowing down operators 50 to whom the assignment request for control responsibility is to be issued from among the plurality of operators 50, based on at least one of the information stored in storage device 30, the mobile body information (refer to FIG. 27 described below), and the peripheral environment information of mobile body 40 (refer to FIG. 28 described below).

Acceptance request notifier 124 executes the processing of receiving a notification from acceptance request input unit 214, and issuing the assignment request notification of control responsibility to terminal 10.

Acceptance possibility determiner 125 determines whether or not the operator 50 can accept the acceptance request for control responsibility, based on at least one of the information stored in storage device 30, the mobile body information, and the peripheral environment information of mobile body 40.

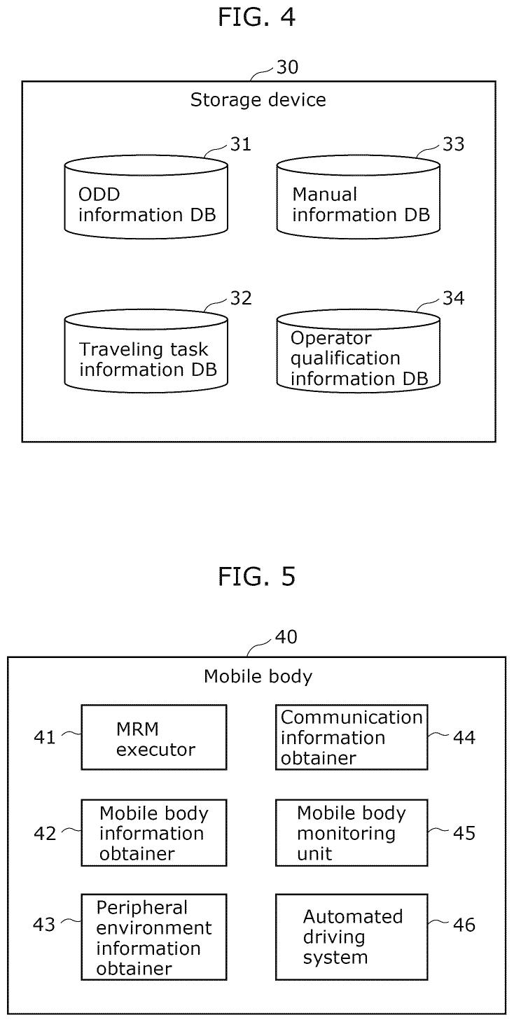

Instruction details determiner 126 determines the details of the monitoring/operation to be performed by operator 50, based on the information in traveling task information DB 32 and manual information DB 33 (refer to FIG. 4 described below). Instruction details determiner 126 determines, for example, the details of the monitoring/operation to be requested.

Mobile body information transmitter 127 executes the processing of transmitting, to terminal 10, the mobile body information transmitted from mobile body information obtainer 42 (refer to FIG. 5 described below) of mobile body 40, based on the information of control state manager 121.

Peripheral environment information transmitter 128 transmits, to terminal 10, the peripheral environment information transmitted from peripheral environment information obtainer 43 (refer to FIG. 5 described below), based on the information of control state manager 121.

Operation signal transmitter 129 executes the processing of transmitting an operation signal to mobile body 40 from terminal 10 associated with the assistance/operation, based on the information of control state manager 121.

Communication information obtainer 130 obtains the communication information between terminal 10 and control server 20 and between control server 20 and mobile body 40. The communication information includes the operation status of communication equipment, the information on communication delay, and the like.

MRM instructor 131 executes the processing of transmitting an MRM instruction as an operation signal to mobile body 40, when a communication anomaly between terminal 10 and control server 20 occurs, or an anomaly occurs in control server 20.

Remote correspondence request notifier 132 issues, to terminal 10, a notification indicating that remote assistance/operation is required, when remote assistance/operation is required based on at least one of the information stored in storage device 30, the mobile body information item, and the peripheral environment information of mobile body 40. The information stored in storage device 30 includes at least one information of ODD information DB 31, traveling task information DB 32, and operator qualification information DB 34.

Autonomous traveling continuation possibility determiner 133 determines whether or not autonomous traveling of mobile body 40 can be continued, based on the information in ODD information DB 31, and executes the processing of issuing a responsibility assignment request through assignment request presenter 112, when autonomous traveling continuation possibility determiner 133 determines that traveling cannot be continued without an operation/assistance.

With reference to FIG. 1 again, storage device 30 stores various kinds of information for control server 20 to execute various kinds of processing. Storage device 30 is realized by a hard disk, a semiconductor memory, or the like. FIG. 4 is a diagram illustrating the information stored in storage device 30 according to the present embodiment.

As illustrated in FIG. 4, storage device 30 includes ODD information DB 31, traveling task information DB 32, manual information DB 33, and operator qualification information DB 34.

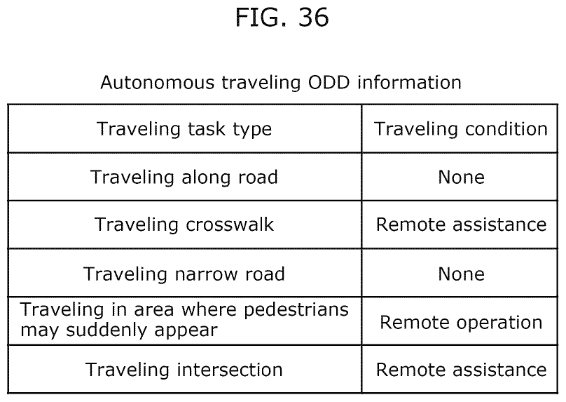

ODD information DB 31 includes the information indicating under what conditions automated driving system 46 (refer to FIG. 5 described below) mounted on mobile body 40 can operate (that is, the conditions under which mobile body 40 can travel autonomously). For example, the road context conditions under which autonomous traveling/autonomous traveling with remote assistance/remote operation can be performed, communication state conditions, the ability information of operator 50, and the like are stored in ODD information DB 31. Specific examples of ODD information will be described below with reference to FIG. 36.

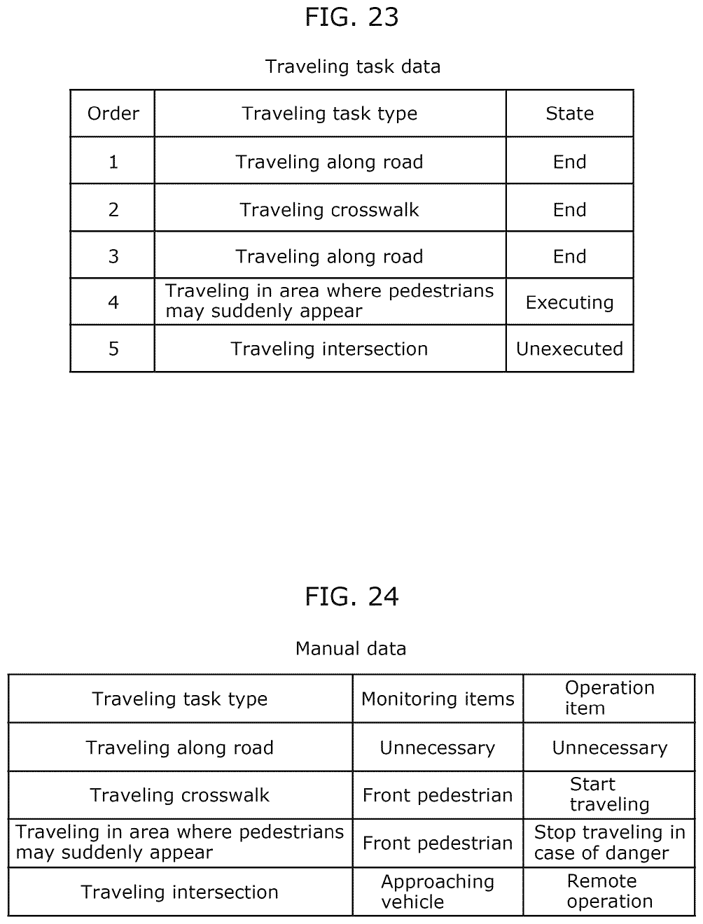

Traveling task information DB 32 stores the schedule of traveling tasks to be executed by each mobile body 40, such as traveling along the road and turning right at the intersection. Specific examples of traveling task information will be described below with reference to FIG. 23 and the like.

Manual information DB 33 stores the manual information indicating monitoring items, operation items, and the like for operator 50. Manual information DB 33 stores, for each road context, the information on what to check and what to operate by operator 50 at the time of remote assistance/operation (at the time of remote correspondence). Specific examples of the manual information will be described below with reference to FIG. 24 and the like.

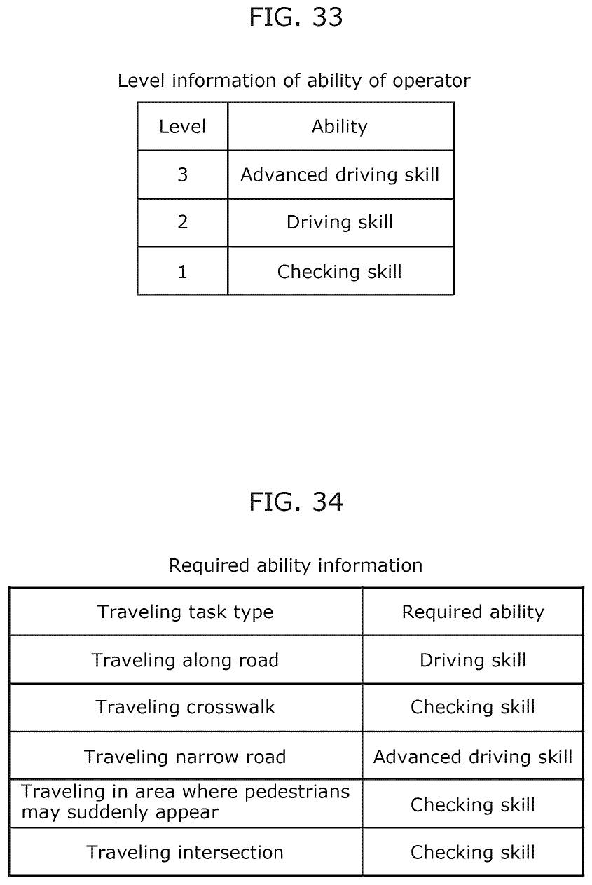

Operator qualification information DB 34 stores, for each operator 50, traveling tasks that can be remotely assisted/operated. Specific examples of operator qualification information will be described below with reference to FIG. 33.

With reference to FIG. 1 again, mobile body 40 includes, for example, an autonomous mobile robot such as an automatic delivery robot. Mobile body 40 can include, for example, an autonomous mobile vehicle such as an automobile or a motorcycle, in addition to the autonomous mobile robot. Furthermore, in the embodiment, mobile body 40 is not of a completely autonomous mobile type, but is remotely monitored by operator 50 via a remote control system. Furthermore, in some cases, mobile body 40 can move with remote assistance or remote monitoring by operator 50 via remote control system 1 depending on the case. Hereinafter, a description will be given by assuming that mobile body 40 is an automatic delivery robot, particularly, an automatic monitoring robot that patrols and monitors a facility or a site.

It should be noted that mobile body 40 is not limited to be of the above-described autonomous mobile type, and may be of, for example, a manual driving type that can be manually driven by a driver on board. Furthermore, the services to be carried out by mobile body 40 are not limited to the above-described monitoring, and may be other services such as cleaning, delivery, sales, or advertisement. Furthermore, mobile body 40 may be a flying body (for example, an autonomous flying drone) or the like that has a flying function.

FIG. 5 is a block diagram illustrating the functional configuration of mobile body 40 according to the present embodiment.

As illustrated in FIG. 5, mobile body 40 includes MRM executor 41, mobile body information obtainer 42, peripheral environment information obtainer 43, communication information obtainer 44, mobile body monitoring unit 45, and automated driving system 46.

MRM executor 41 executes an MRM when there is an MRM instruction from terminal 10 or control server 20, when a communication anomaly between control server 20 and mobile body 40 occurs, or when an anomaly occurs in mobile body 40.

Mobile body information obtainer 42 obtains, from various sensors or the like mounted on mobile body 40, the information regarding the state of mobile body 40, such as the vehicle speed, the angular velocity, and the system state.

Peripheral environment information obtainer 43 obtains the peripheral environment information, such as sensing information of a camera, a LiDAR, a radar, or the like mounted on mobile body 40, a target whose sensing information has been processed by machine learning, signal processing, and the like, and a grid map.

Communication information obtainer 44 obtains the communication state between control server 20 and mobile body 40, and the delay information of an operation command that is transmitted. Communication information obtainer 44 may obtain the delay information based on, for example, the timestamp or the like attached to the operation command.

Mobile body monitoring unit 45 monitors whether or not an anomaly exists in mobile body 40. Mobile body monitoring unit 45 monitors, for example, whether or not the time in mobile body 40 has been changed discontinuously. For example, mobile body monitoring unit 45 monitors whether or not a time jump due to a leap second or the like has occurred.

Automated driving system 46 is a system that executes control for mobile body 40 to travel autonomously. Automated driving system 46 automatically executes operations such as acceleration and deceleration, steering, and braking of mobile body 40. Automated driving system 46 is an example of an autonomous travel system.

Here, the forms of remote control in remote control system 1 according to the present embodiment will be described with reference to FIG. 6. FIG. 6 is a diagram illustrating the forms of remote control according to the present embodiment.

As illustrated in FIG. 6, there are three forms, i.e., “monitoring”, “assistance”, and “driving” as the control forms. Monitoring means remote monitoring, assistance means remote assistance, and operation means remote operation.

As the display on a UI (for example, display portion 110a), mobile body information and peripheral environment information are displayed in all of the three forms.

The control responsibility of operator 50 is “none” for monitoring, and “yes” for assistance and driving. For example, even if remotely monitored mobile body 40 causes an accident or the like, operator 50 who is performing remote monitoring does not have the responsibility for the accident.

Possible operation indicates possible operations that operator 50 can perform on mobile body 40: “none” for monitoring; “transmission of commands for stop for safety/stop autonomous traveling/resumption of autonomous traveling/route change” for assistance; and “longitudinal and lateral control/acceleration/braking” for driving. Operator 50 can execute simple operations in assistance, such as a stop operation and a traveling start operation, and can execute more complicated operations in driving. Stop autonomous traveling also includes stop temporarily.

Simultaneous control restrictions indicate restrictions in the case of simultaneously performing remote control on one mobile body 40 by a plurality of operators 50: “none” for monitoring; and “one operator 50 can take the assistance/driving form for one vehicle (mobile body)” for assistance and driving. It should be noted that, as for remote assistance, one operator 50 may be able to simultaneously assist a plurality of vehicles.

Safety function activation conditions indicate conditions for not to activate the safety function of mobile body 40: “none” for monitoring; “there is a delay in a video/vehicle information transmission display function, and it is not operating correctly”, and “there is a delay in transmission/execution of an instruction command, and it cannot be performed correctly” for assistance; and “there is a delay in a video/vehicle information transmission display function, and it is not operating correctly”, and “there is a delay in transmission/execution of an operation command, and it cannot be performed correctly” for driving. In assistance and driving, when the conditions are no longer satisfied, the safety function of mobile body 40 can be activated.

The automated driving levels that are allowed to travel is “Lv.4” for monitoring, “Lv.3, 2” for assistance, and “Lv.2, 1” for driving. Lv.4 is also called advanced driving automation, Lv.3 is also called conditional driving automation, Lv.2 is also called partial driving automation, and Lv.1 is also called driving assistance.

As described above, there are a plurality of forms for remote control, and operators 50 have driving duty depending on the control forms.

### [2. Operation of Remote Control System]

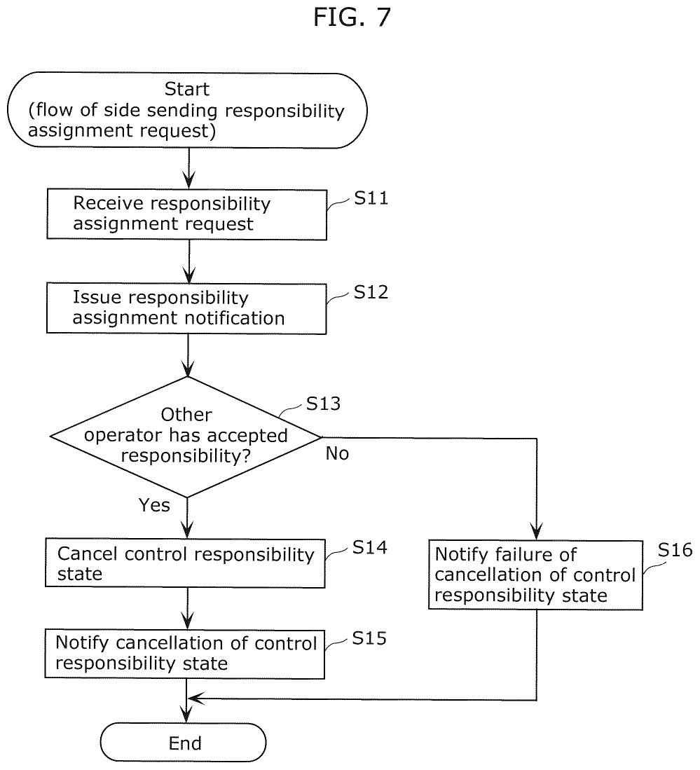

Subsequently, with reference to FIG. 7 to FIG. 10, a description will be given of the operations in remote control system 1 configured as described above. Hereinafter, a description will be given of the processing in a case of substituting operator 50 who are performing control while mobile body 40 is traveling autonomously.

FIG. 7 is a flowchart illustrating the operations (information processing method) of a side sending an assignment request in remote control system 1 according to the present embodiment. FIG. 7 illustrates the operations to be executed by terminal 10 of operator 50 in a case where the operator 50 who is currently remotely assisting mobile body 40 assigns control responsibility. FIG. 8 is a diagram illustrating screens that are displayed in display portion 110a of a side sending an assignment request, according to the present embodiment. Hereinafter, operator 50 of the side sending the assignment request is also simply referred to as operator 50 or operator A, and operator 50 of a side receiving the assignment request is also simply referred to as the other operators 50 or operator B.

As illustrated in FIG. 7, assignment request input unit 212 receives a responsibility assignment request from operator A (S11). As illustrated in (a) in FIG. 8, for example, assignment request input unit 212 displays button display e1 for receiving an assignment request from operator A, and when it is detected that button display e1 has been pressed, assignment request input unit 212 determines that the responsibility assignment request has been received.

It should be noted that, in display portion 110a, “assistance in progress”, which is status display b1 indicating that operator 50 has control responsibility, is displayed by control state presenter 111, button display e2 for ending the control is displayed by start and end input unit 215, “traveling in progress”, which is status display c indicating that mobile body 40 is traveling, is displayed by mobile body information presenter 115, “vehicle approaching”, which is situation display d indicating a video obtained by capturing the surroundings of mobile body 40, sensing information, and the fact that a vehicle is approaching mobile body 40, is displayed by peripheral environment information presenter 116, and operation display a2 for temporarily stopping mobile body 40 is displayed by operation signal transmitter 216. It should be noted that, since mobile body 40 is traveling, button display e2 is inactive (in an inoperable state). Furthermore, operation display a1 for stopping mobile body 40 for safety by input device 210 is displayed. Furthermore, currently, since remote assistance is in progress, operator A can temporarily stop mobile body 40 via operation display a2.

As illustrated in FIG. 7, next, when assignment request input unit 212 receives the responsibility assignment request in step S11, assignment request input unit 212 issues a responsibility assignment notification to terminal 10 of the other operators 50 (operator B) (S12). Issuing means transmitting the responsibility assignment notification to terminal 10 of operator B. That is, when an operation indicating that the duty for mobile body 40 is to be assigned is obtained from operator A, the responsibility assignment notification is notified. The responsibility assignment notification is the notification indicating that operator A is requesting assignment of the control responsibility for mobile body 40 that is remotely assisted by operator A.

As illustrated in (b) in FIG. 8, control state presenter 111 switches the display from status display b1 to “assistance in progress (requesting substitution)”, which is status display b2 indicating that the assignment request for the control responsibility is being made. That is, status display b2 is presented to operator A. Accordingly, it is possible to report, to operator A, that the assignment request for the control responsibility is in progress.

As illustrated in FIG. 7, next, assignment request input unit 212 determines whether or not operator B has accepted the control responsibility (S13). When assignment request input unit 212 obtains (for example, receives) the notification indicating that the assignment request has been accepted from terminal 10 of operator B, assignment request input unit 212 determines that operator B has accepted the control responsibility. The notification is an example of the information regarding whether or not the assignment request is acknowledged.

Next, when assignment request input unit 212 determines that operator B has accepted the control responsibility (Yes in S13), assignment request input unit 212 cancels the control responsibility state of operator A (S14), and notifies operator A that the control responsibility state is canceled (S15). Furthermore, when it is determined that operator B has accepted the control responsibility, terminal 10 of operator A transmits, to terminal 10 of operator B, the information indicating (who has) the control responsibility for mobile body 40 and the information indicating (the grant of) the right to operate mobile body 40. The information indicating (who has) the control responsibility includes the information indicating that the control responsibility is transferred from operator A to operator B, and the information indicating (the grant of) the right to operate includes the information indicating that the right to operate is transferred from operator A to operator B.

As illustrated in (c) in FIG. 8, control state presenter 111 switches the display from status display b2 to “operator B is assisting”, which is status display b3 indicating that the transition to the control responsibility state (the state with control responsibility) is completed. Accordingly, it is possible to report, to operator A, that the control responsibility state is canceled, and the control responsibility is transferred to operator B. At this time, operation display a2 is switched to the inactive (for example, undisplayed) state. Accordingly, it becomes impossible for operator A to operate mobile body 40. That is, the right to operate mobile body 40 is assigned. For example, for operator A, the form of remote control is switched from remote assistance to remote monitoring. Furthermore, assignment request input unit 212 switches the display from button displays e1 and e2 to button display e3 as a response button in the case where an assignment request is received from operator B. The right to operate is the right to permit execution of the operation on mobile body 40 according to the control form. The right to operate is a concept different from the control responsibility, and may be assigned at a different timing from the control responsibility. That is, the right to operate and the control responsibility can be assigned (and the assignment of which can be accepted) independently. Here, independently means that the right to operate and the control responsibility can be separately assigned.

As described above, it is presented to operator A that the responsibility for mobile body 40 has been assigned to operator B, and that the right to operate mobile body 40 has assigned to operator B, using mutually different modes. For example, when the responsibility for mobile body 40 is assigned to operator B, status display b3 indicating that operator B is remotely controlling mobile body 40 is presented to operator A, and when the right to operate mobile body 40 is assigned to operator B, operation display a2 (operation component) for remotely controlling mobile body 40 is disabled (for example, undisplayed).

Furthermore, when control state presenter 111 obtains (for example, receives), from terminal 10 of operator B, the notification indicating refusal of acceptance of the assignment request, control state presenter 111 determines that operator B has refused the control responsibility (No in S13), and notifies operator A that cancellation of the control responsibility state has failed (S16). In this case, for example, operator A continues to remotely assist mobile body 40.

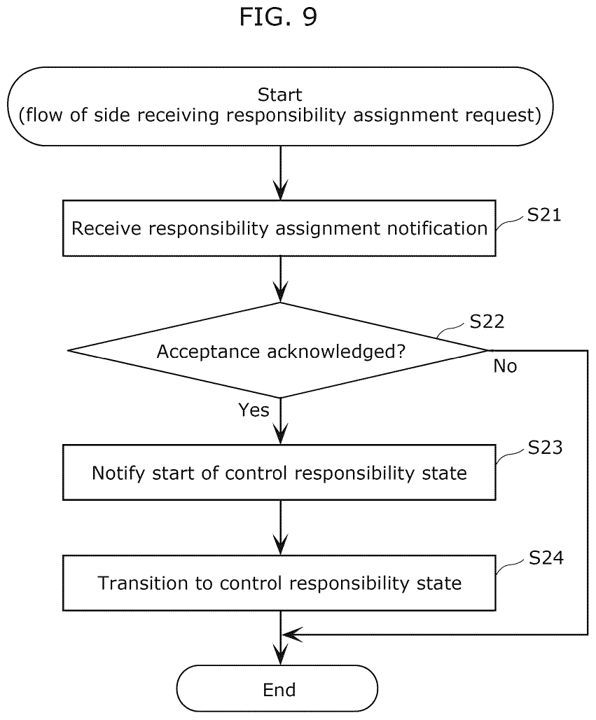

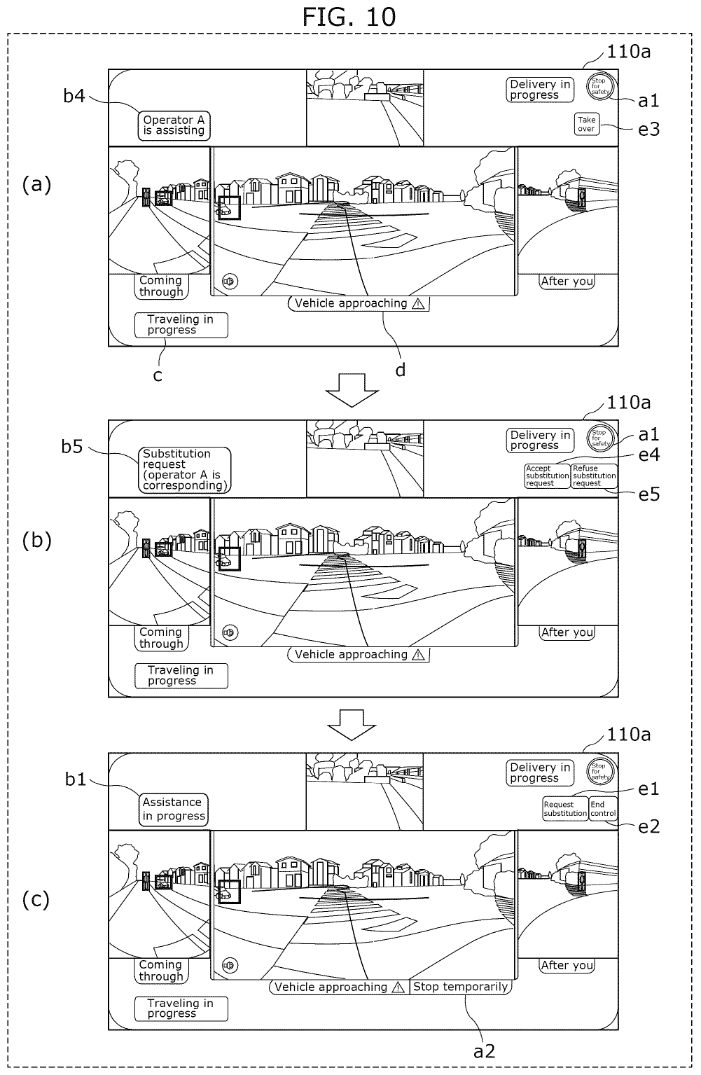

Subsequently, the operations of terminal 10 of the side receiving an assignment request will be described with reference to FIG. 9 and FIG. 10. FIG. 9 is a flowchart illustrating the operations (information processing method) of the side receiving an assignment request in remote control system 1 according to the present embodiment. FIG. 9 illustrates the operations to be executed by terminal 10 of the other operator 50 (operator B) in a case where the operator B who is currently remotely monitoring mobile body 40 receives an assignment request for the control responsibility. FIG. 10 is a diagram illustrating screens that are displayed in display portion 110a of the side receiving the assignment request in remote control system 1 according to the present embodiment. It should be noted that the other operator 50 is assumed to be remotely monitoring mobile body 40 that is remotely assisted by operator 50 (operator A). It should be noted that the responsibility assignment notification may be issued to at least one of the other operator 50 who is remotely monitoring mobile body 40 and the other operator 50 who is not remotely monitoring mobile body 40.

As illustrated in (a) in FIG. 10, during remote monitoring, “operator A is assisting”, which is status display b4 indicating that operator A has the control responsibility, is displayed in display portion 110a by control state presenter 111. Furthermore, operation display a1, button display e3, status display c, and situation display d are further displayed in display portion 110a. It should be noted that, at this point, operation display a2 for temporarily stopping mobile body 40 is not displayed in display portion 110a.

As illustrated in FIG. 9, terminal 10 of operator B receives the responsibility assignment notification issued from terminal 10 of operator A in step S12 (S21). For example, assignment request presenter 112 may function as a first obtainer that obtains the responsibility assignment notification.

As illustrated in (b) in FIG. 10, when the responsibility assignment notification is received, assignment request presenter 112 switches the display from status display b4 to “substitution request (operator A is corresponding)”, which is status display b5 indicating that the assignment request (substitution request) is notified. Furthermore, assignment request response input unit 211 displays “accept substitution request”, which is button display e4 indicating acceptance of the assignment request, and “refuse substitution request”, which is button display e5 indicating refusal of the assignment request. For example, assignment request response input unit 211 may display button displays e4 and e5 using mutually different modes. For example, assignment request response input unit 211 may display button displays e4 and e5 in different colors.

As illustrated in FIG. 9, next, assignment request response input unit 211 determines whether or not the acceptance of the assignment request for the control responsibility has been acknowledged (S22). When button display e4 is operated by operator B, assignment request response input unit 211 determines that the acceptance has been acknowledged, and when button display e5 is operated by operator B, or when there is no button operation for a predetermined period of time, assignment request response input unit 211 determines that the acceptance has been refused. Assignment request response input unit 211 functions as a second obtainer that obtains, from operator A, the operation regarding whether the assignment request is acknowledged. Furthermore, assignment request response input unit 211 transmits, to terminal 10 of operator A, the determination result of whether or not the acceptance of the assignment request for the control responsibility has been acknowledged.

Next, when assignment request response input unit 211 determines that the acceptance has been acknowledged (Yes in S22), assignment request response input unit 211 notifies the start of the control responsibility state (S23), and transition to the control responsibility state is made (S24). For example, when terminal 10 of operator B receives, from terminal 10 of operator A, the information indicating (who has) the control responsibility for mobile body 40 and the information indicating (the grant of) the right to operate mobile body 40, terminal 10 of operator B executes step S24. Assignment request response input unit 211 functions as a processing unit that executes the processing for assigning the responsibility for mobile body 40 and the right to operate mobile body 40 to operator B.

As illustrated in (c) in FIG. 10, when the responsibility assignment notification is accepted, control state presenter 111 switches the display from status display b5 to “assistance in progress”, which is status display b1 indicating that remote assistance is in progress and operator B has the control responsibility. Furthermore, operation signal transmitter 216 displays operation display a2 for temporarily stopping mobile body 40 for which the control responsibility has been accepted. That is, operation display a2 becomes active. Accordingly, it is reported to operator B that transition to the control responsibility state has been made, and the right to operate mobile body 40 (operation display a2) is transferred. Furthermore, assignment request input unit 212 switches button displays e4 and e5 to button displays e1 and e2.

It should be noted that, for example, step S14 illustrated in FIG. 7 and step S24 illustrated in FIG. 9 may be executed simultaneously.

As described above, it is presented to operator B that the responsibility for mobile body 40 has been assigned to operator B, and that the right to operate mobile body 40 has been assigned to operator B in different manners. For example, when the responsibility for mobile body 40 is assigned to operator B, status display b3 indicating that operator B is remotely controlling mobile body 40 is presented to operator B, and when the right to operate mobile body 40 is assigned to operator B, the display indicating that operation display a2 (operation component) for remotely operating mobile body 40 is enabled is presented to operator B. For example, operation display a2, which has been undisplayed, is displayed. For example, status display b3 and operation display a2 are simultaneously displayed in display portion 110a. For example, status display b3 and operation display a2 are arranged spaced apart in display portion 110a. Furthermore, status display b3 and operation display a2 are the displays including character information, but may be the displays including illustrations.

Accordingly, the control responsibility of operator A can be positively assigned to operator B in the three steps, i.e., requesting the responsibility assignment, approving the acceptance of responsibility assignment, and assigning the responsibility. Furthermore, since the approval of acceptance of the responsibility assignment is explicitly performed, it is clear who has the responsibility at the time of substitution of operators 50, and therefore, for example, the control responsibility can be clearly handed over from operator A to operator B. Furthermore, according to the above-described method, even if mobile body 40 is traveling, it is possible to perform seamless assignment of the control responsibility, and the time loss due to the substitution of operators 50 can be reduced.

It should be noted that when the responsibility for mobile body 40 and the right to operate mobile body 40 are assigned from operator A to operator B, unless there is a permission by operator B, it need not be permitted for the other operators 50 except for operator B of one or more operators 50 to bear the responsibility for mobile body 40. That is, the responsibility for mobile body 40 that operator B has need not be assigned to the other operators 50 except for operator B, unless operator B gives a permission (for example, unless button display e1 is operated).

### Variation 1 of the Embodiment

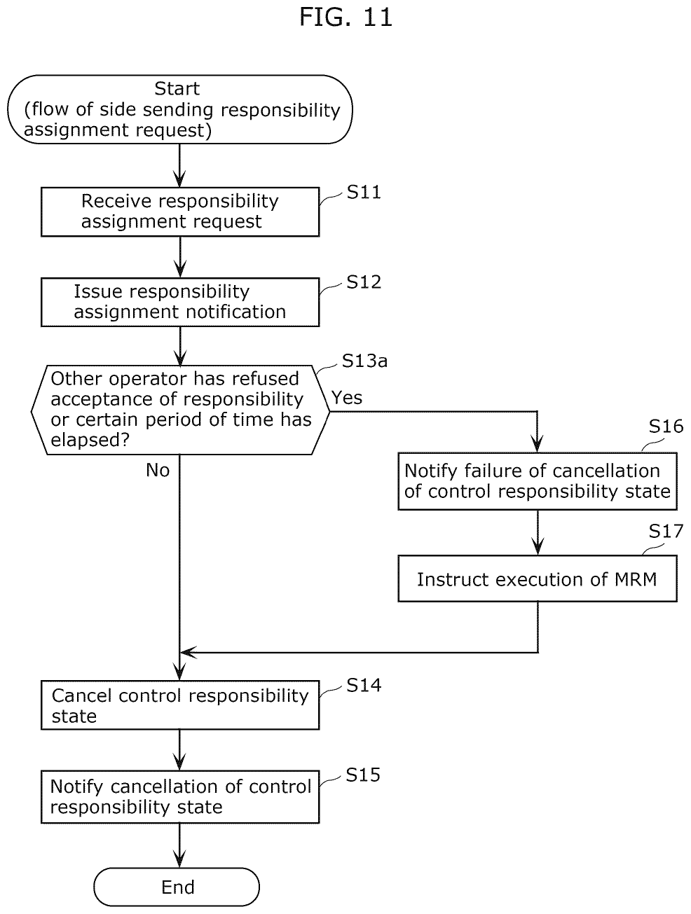

Hereinafter, remote control system 1 according to the present variation will be described with reference to FIG. 11. It should be noted that, hereinafter, differences from the embodiment will be mainly described, and a description of contents that are the same as or similar to the embodiment will be omitted or simplified. FIG. 11 is a flowchart illustrating the operations (information processing method) of the side sending an assignment request in remote control system 1 according to the present variation. FIG. 11 illustrates an example in which, when the control responsibility cannot be assigned, mobile body 40 is caused to automatically take evasive action (MRM).

As illustrated in FIG. 11, when control state presenter 111 receives, from terminal 10 of the other operator 50 (operator B), the notification indicating that operator B has refused to accept the responsibility, or when a certain period of time has elapsed without receiving the notification (Yes in S13a), control state presenter 111 notifies operator 50 (operator A) that cancellation of the control responsibility state has failed (S16). Furthermore, MRM instructor 219 instructs execution of an MRM (S17). For example, MRM instructor 219 transmits a signal for executing an MRM to mobile body 40. Accordingly, since mobile body 40 can be stopped forcibly, it becomes possible to cancel the control responsibility state of operator A (S14)

### Variation 2 of the Embodiment

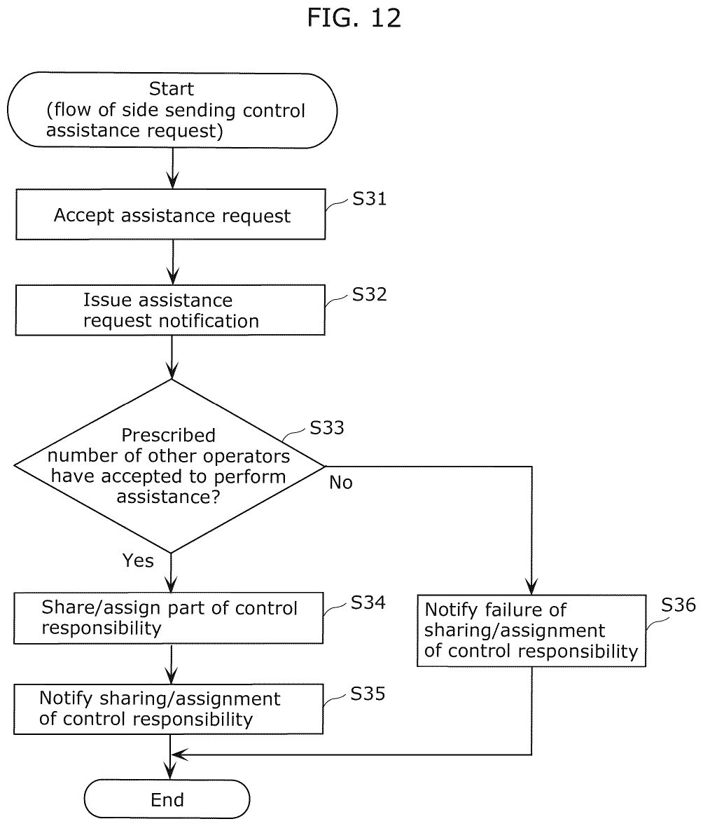

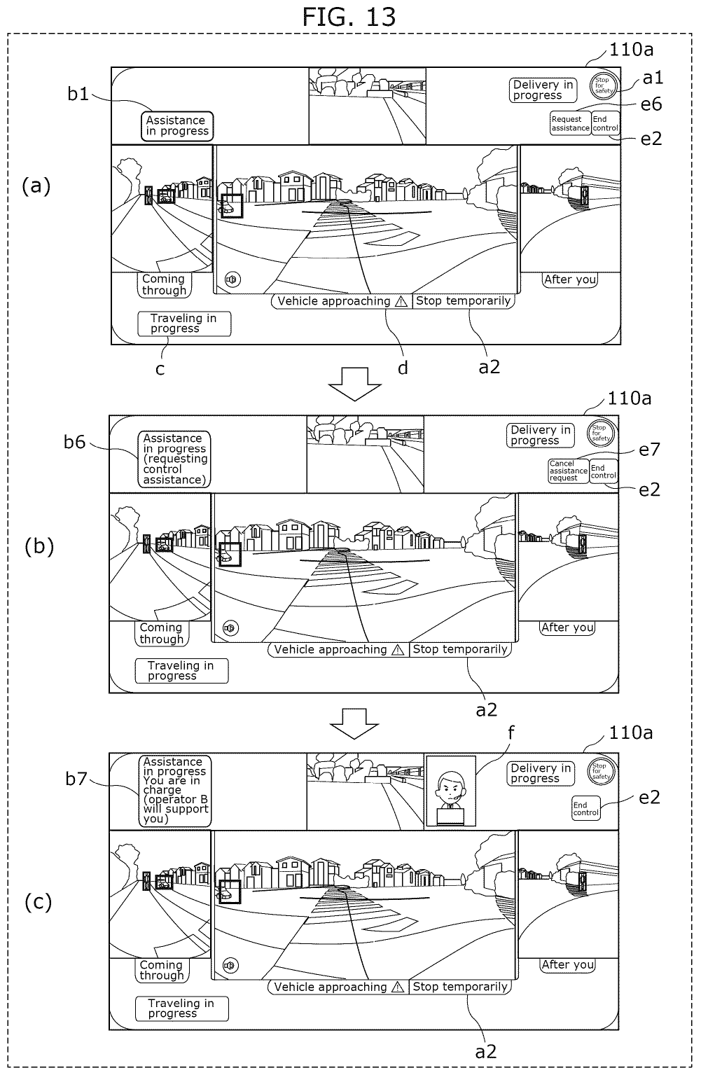

Hereinafter, remote control system 1 according to the present variation will be described with reference to FIG. 12 to FIG. 15. It should be noted that, hereinafter, differences from the embodiment will be mainly described, and a description of contents that are the same as or similar to the embodiment will be omitted or simplified. FIG. 12 is a flowchart illustrating the operations (information processing method) of the side sending an assistance request in remote control system 1 according to the present variation. With reference to FIG. 12, a description will be given of the operations to be executed by terminal 10 when adding a control assistant (cooperator). In the example of FIG. 12, when remote assistance (or remote operation) of mobile body 40 cannot be handled by one operator 50, simultaneous control is executed by a plurality of operators 50. FIG. 13 is a diagram illustrating screens that are displayed in display portion 110a of the side sending the assistance request in remote control system 1 according to the present variation. Hereinafter, operator 50 of the side sending the assistance request is also simply referred to as operator 50 or operator A, and operator 50 of a side receiving the assistance request is also simply referred to as the other operators 50 or operator B.

As illustrated in FIG. 12, assignment request input unit 212 accepts an assistance request from operator A (S31). As illustrated in (a) in FIG. 13, for example, assignment request input unit 212 displays button display e6 for accepting the assistance request from operator A, and when it is detected that button display e6 has been pressed, assignment request input unit 212 determines that the assistance request has been accepted.

As illustrated in FIG. 12, next, when assignment request input unit 212 accepts the assistance request in step S31, assignment request input unit 212 issues an assistance request notification to terminal 10 of operator B (S32). Issuing the assistance request notification means transmitting the assistance request notification to terminal 10 of operator B. The assistance request notification is the notification for requesting operator B to join as an assistant (or operator) of mobile body 40.

As illustrated in (b) in FIG. 13, control state presenter 111 switches status display b1 to “assistance in progress (requesting control assistance)”, which is status display b6 indicating that the control assistance is being requested. Accordingly, it is possible to report, to operator A, that assistance is being requested. Furthermore, assignment request input unit 212 displays “cancel assistance request”, which is button display e7 for canceling the assistance request.

As illustrated in FIG. 12, next, assignment request input unit 212 determines whether or not a prescribed number of operators B have accepted assistance (S33). The prescribed number of assistants may be determined according to mobile body 40, the state of mobile body 40, or the like, and operator 50 may determine the number of assistants.

Assignment request input unit 212 may perform the determination in step S33 by counting the number of operators B who have accepted to perform assistance.

Next, when assignment request input unit 212 determines that the prescribed number of operators B have accepted to perform assistance (Yes in S33), assignment request input unit 212 shares part of the control responsibility with operators B who have accepted to perform assistance or assigns part of the control responsibility to operators B (S34), and notifies operator A that the part of the control responsibility has been shared or the part of the control responsibility has been assigned (S35). For example, when it is determined that the prescribed number of operators B have accepted to perform assistance, terminal 10 of operator A transmits, to terminals 10 of operators B who have accepted to perform assistance, the information indicating (who has) the part of the control responsibility for mobile body 40 and the information indicating (the grant of) the part of the right to operate mobile body 40.

As illustrated in (c) in FIG. 13, control state presenter 111 switches the display from status display b6 to “assistance in progress, you are in charge (operator B will support you)”, which is status display b7 indicating that the part of the control responsibility has been shared or assigned. Accordingly, it is possible to report, to operator A, that operator B, who is the other operator 50, has joined as a control assistant. At this time, display f for making a call to operator B, who is a control assistant, is displayed in display portion 110a by call unit 220.

When control state presenter 111 determined that the prescribed number of operators B have not accepted to perform assistance (No in S33), control state presenter 111 notifies operator A of failure of sharing/assignment of the control responsibility (S36). In this case, operator A continues to perform, for example, remote assistance for mobile body 40.

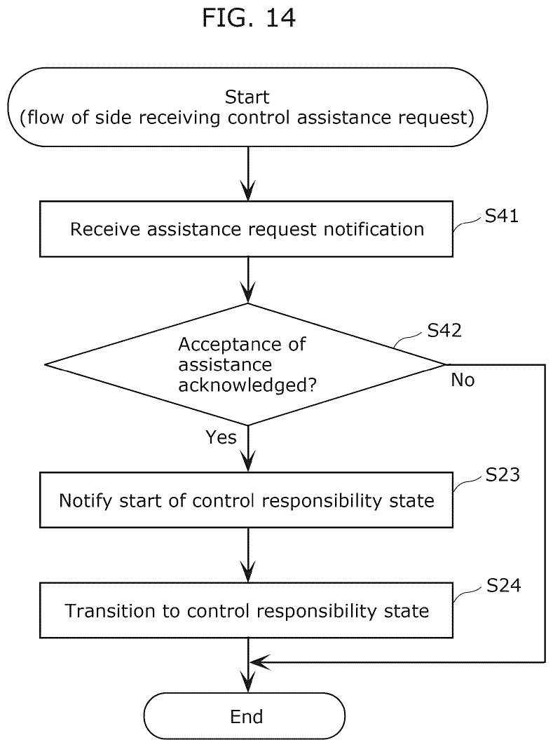

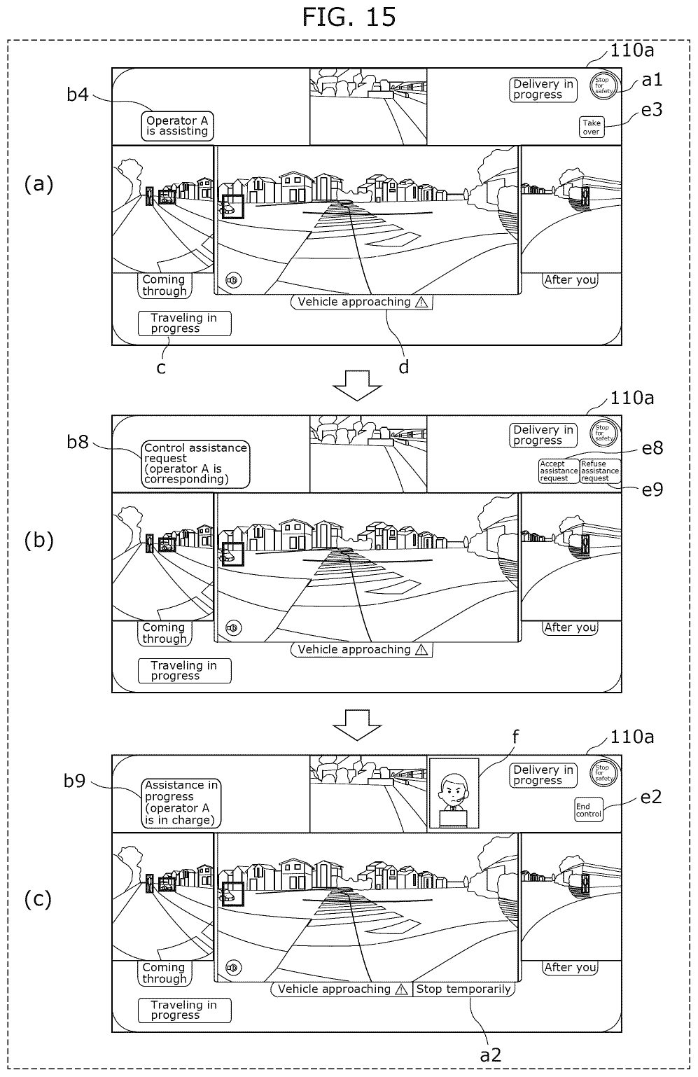

Subsequently, the operations of terminal 10 of the side receiving the assistance request will be described with reference to FIG. 14 and FIG. 15. FIG. 14 is a flowchart illustrating the operations (information processing method) of the side receiving the assistance request in remote control system 1 according to the present variation. FIG. 14 illustrates the operations to be executed by terminal 10 of the other operator 50 when the other operator 50 who is currently remotely monitoring mobile body 40 receives an assistance request. FIG. 15 is a diagram illustrating screens that are displayed in display portion 110a of the side receiving the assistance request in remote control system 1 according to the present variation.

As illustrated in (a) in FIG. 15, during remote monitoring, “operator A is assisting”, which is status display b4 indicating that operator A has the control responsibility, is displayed in display portion 110a by control state presenter 111.

As illustrated in FIG. 14, terminal 10 of the other operator 50 receives the assistance request notification issued from terminal 10 of operator A in step S32 (S41).

As illustrated in (b) in FIG. 15, when the assistance request notification is received, assignment request presenter 112 switches the display from status display b4 to “control assistance request (operator A is corresponding)”, which is status display b8 indicating that the assistance request is notified. Furthermore, assignment request response input unit 211 displays “accept assistance request”, which is button display e8 indicating acceptance of the assistance request, and “refuse assistance request”, which is button display e9 indicating refusal of the assistance request. For example, assignment request response input unit 211 may display button displays e8 and e9 using mutually different display modes. For example, assignment request response input unit 211 may display button displays e8 and e9 in different display colors.

As illustrated in FIG. 14, next, assignment request response input unit 211 determines whether or not acceptance of the assistance request has been acknowledged (S42). When button display e8 is operated by operator B, assignment request response input unit 211 determines that acceptance has been acknowledged, and when button display e9 is operated by operator B, or when there is no button operation for a predetermined period of time, assignment request response input unit 211 determines that acceptance has been refused.

Next, when assignment request response input unit 211 determines that acceptance has been acknowledged (Yes in S42), assignment request response input unit 211 notifies the start of the control responsibility state (S23), and transition to the control responsibility state is made (S24).

As illustrated in (c) in FIG. 15, when the assistance request is accepted, control state presenter 111 switches the display from status display b8 to “assistance in progress (operator A is in charge)”, which is status display b9 indicating that operator B is performing control assistance. It can be said that status display b9 notifies that transition to a state in which part of the control responsibility has been taken over is completed. Furthermore, operation signal transmitter 216 displays operation display a2 for temporarily stopping mobile body 40 for which the assistance request has been accepted. That is, operation display a2 becomes active. Accordingly, it is reported to operator B that transition to the control responsibility state (for example, control assistance state) has been made, and the right to operate mobile body 40 (operation display a2) is shared. Furthermore, assignment request input unit 212 switches button displays e8 and e9 to button display e2.

As described above, the assignment request is the request for assigning part of the responsibility for mobile body 40, and part of the responsibility for mobile body 40 and part of the right to operate mobile body 40 may be transferred from operator A to operator B. It should be noted that, in the examples of FIG. 13 and FIG. 15, although a description has been given of the examples in which both operators A and B can perform temporarily stop, this is not a limitation, and operators A and B may be able to perform different operations. That is, the details of assistance or operation may be shared by operators A and B.

It should be noted that operator A who is in charge may have the control responsibility, or the control responsibility may be distributed to operators A and B according to the right to operate. For example, the control responsibility may be distributed by using a table in which the right to operate is associated with how to distribute the control responsibility.

Accordingly, even in a case where simultaneous control of mobile body 40 is performed by a plurality of persons in three steps, i.e., starting control, requesting assistance, and approving the acceptance of the assistance request, it becomes more positively clear who holds the control responsibility, and the right to operate can be distributed.

### Variation 3 of the Embodiment

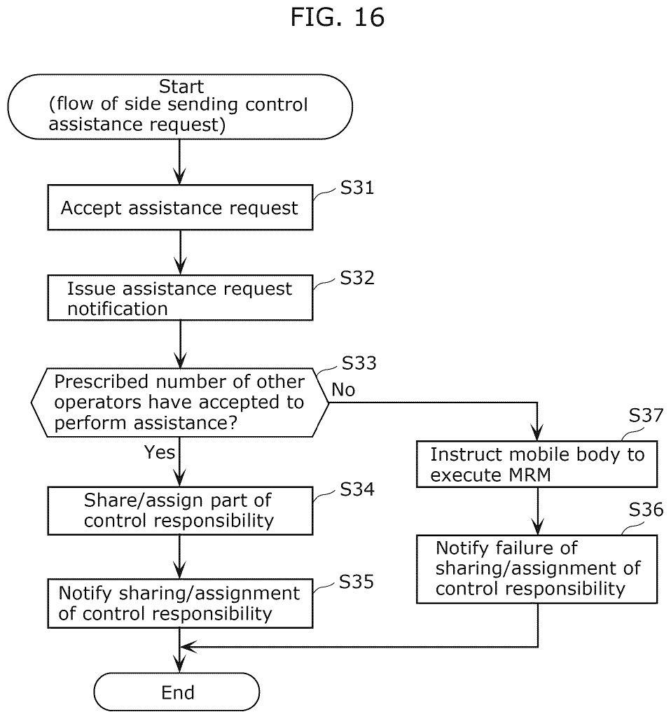

Hereinafter, remote control system 1 according to the present variation will be described with reference to FIG. 16. It should be noted that, hereinafter, differences from Variation 2 of the embodiment will be mainly described, and a description of contents that are the same as or similar to Variation 2 of the embodiment will be omitted or simplified. FIG. 16 is a flowchart illustrating the operations (information processing method) of the side sending the assistance request in remote control system 1 according to the present variation. With reference to FIG. 16, an example will be described in which it is required to add an assistant (the other operator 50) who assists operator 50 (operator A) who performs remote assistance or remote operation, and an MRM is to be executed when the prescribed number of assistants are not available.

As illustrated in FIG. 16, when it is determined that the prescribed number of other operators 50 (operators B) have not accepted to perform assistance (No in S33), MRM instructor 219 instructs mobile body 40 to execute an MRM (S37), and proceeds to step S36. For example, MRM instructor 219 transmits a signal for executing an MRM to mobile body 40.

### Variation 4 of the Embodiment

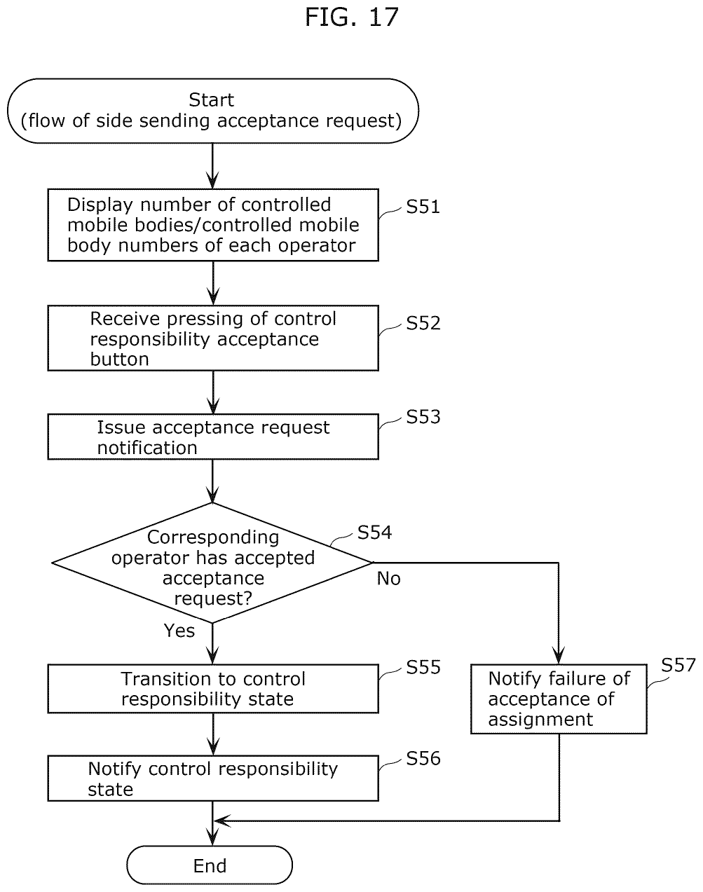

Hereinafter, remote control system 1 according to the present variation will be described with reference to FIG. 17 to FIG. 21. It should be noted that, hereinafter, differences from the embodiment will be mainly described, and a description of contents that are the same as or similar to the embodiment will be omitted or simplified.

FIG. 17 is a flowchart illustrating the operations (information processing method) of the side sending the acceptance request in remote control system 1 according to the present variation. With reference to FIG. 17, an example will be described in which available operator 50 takes over mobile body 40 for which the other operator 50 has the control responsibility. Being available means that currently not performing assistance/operation, for example, not having responsibility.

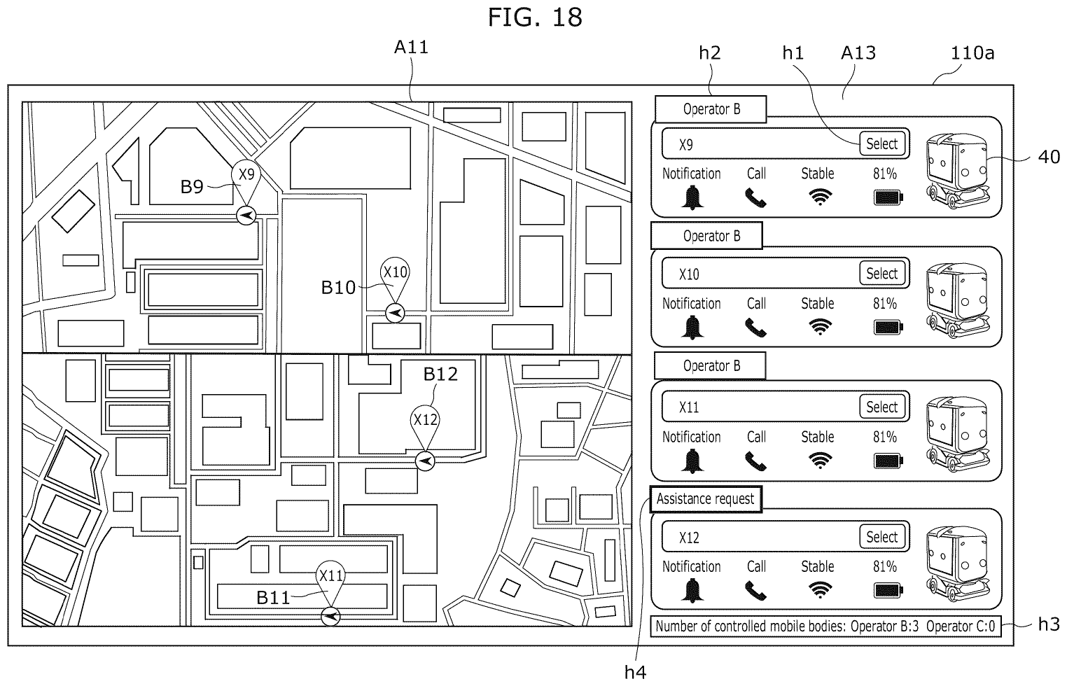

FIG. 18 is a diagram illustrating a first screen that is displayed in display portion 110a of the side sending the acceptance request in remote control system 1 according to the present variation. FIG. 18 illustrates a display example of the number of controlled mobile bodies/the controlled mobile body numbers in a case where operator B is remotely controlling three mobile bodies 40, and one mobile body 40 is requesting assistance. It is assumed that there is no operator 50 who is remotely controlling mobile body 40 that is requesting assistance.

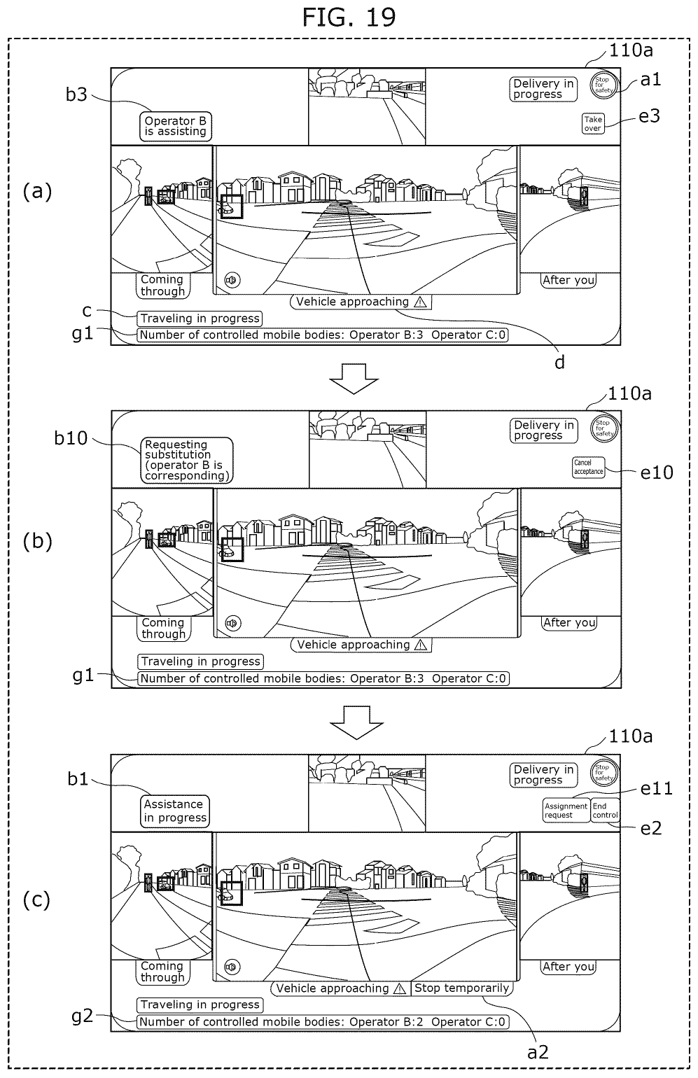

FIG. 19 is a diagram illustrating second screens that are displayed in display portion 110a of the side sending the acceptance request in remote control system 1 according to the present variation.

As illustrated in FIG. 17, terminal 10 of available operator 50 (operator A) displays the number of controlled mobile bodies/the controlled mobile body numbers of each operator 50 in display portion 110a (S51).

As illustrated in FIG. 18, map display portion A11 showing the current positions of a plurality of mobile bodies 40, and list display portion A13 showing the relationship between mobile bodies 40 and operators 50 and the like are displayed in display portion 110a.

Mark B9 indicating the position of mobile body 40 having an mobile body ID of “X9”, mark B10 indicating the position of mobile body 40 having an mobile body ID of “X10”, mark B11 indicating the position of mobile body 40 having an mobile body ID of “X11”, and mark B12 indicating the position of mobile body 40 having an mobile body ID of “X12” are displayed in map display portion A11. Furthermore, the movement route of each mobile body 40 may be further displayed in map display portion A11.

The mobile body IDs, the image pictures of mobile bodies 40, first displays h1 displayed by mobile body selector 217, second displays h2 and third display h3 displayed by control state presenter 111, and fourth display h4 displayed by remote correspondence request presenter 119 are displayed in list display portion A13.

First display h1 is displayed for each of a plurality of mobile bodies 40, and is the display for transitioning, when first display h1 is pressed by operator 50, to a control screen (for example, a screen illustrated in (a) in FIG. 19 described below) for mobile body 40 corresponding to first display h1 that is pressed. When two or more mobile bodies 40 are selected by operator 50, it may be possible to perform simultaneous control of the plurality of mobile bodies 40.

Second display h2 indicates which operator 50 has the control responsibility of which mobile body 40. FIG. 18 illustrates an example in which operator B has the control responsibility for three mobile bodies 40 having mobile body IDs of “X9” to “X11.”

Third display h3 indicates how many mobile bodies 40 are assisted/operated by each operator 50. FIG. 18 illustrates the example in which operator B is assisting/operating three mobile bodies 40, and operator C is not assisting/operating any of mobile bodies 40.

Fourth display h4 indicates that no operator 50 is performing remote control, and mobile body 40 requires remote control. In FIG. 18, it is illustrated that mobile body 40 having a mobile body ID of “X12” requires assistance. An assistance request here may be, for example, a request from mobile body 40 having a mobile body ID of “X12”.

Furthermore, the images indicating the state of mobile body 40 are displayed in list display portion A13 for each mobile body 40. The images illustrating the state of mobile body 40 include, from left to right, the image indicating that there is a notification from mobile body 40, the image indicating whether or not a call can be made to mobile body 40, the image indicating the communication state with mobile body 40, and the image indicating the remaining capacity of a battery of mobile body 40.

Since the screen as illustrated in FIG. 18 is displayed, available operator 50 can check the screen, and determine for which mobile body 40 available operator 50 is to bear the control responsibility. That is, terminal 10 can assist operator 50 in determining for which mobile body 40 operator 50 is to bear the control responsibility.

For example, when the selection by operator 50 for any of first displays h1 in FIG. 18 is received, transition is made to the screen illustrated in (a) in FIG. 19, which is the control screen of corresponding mobile body 40. In (a) in FIG. 19, an example is displayed in which mobile body 40 for which operator B has the control responsibility is selected, and “operator B is assisting” is displayed as status display b3. Furthermore, at this time, acceptance request input unit 214 displays button display e3 for requesting, from operator B, acceptance of assignment of the control responsibility for mobile body 40 borne by operator B. It can be said that button display e3 is the display for taking over assistance/operation. Furthermore, control state presenter 111 displays number-of-mobile-bodies display g1 indicating the number of controlled mobile bodies of each operator 50.

With reference to FIG. 17 again, next, acceptance request input unit 214 receives pressing of a control responsibility acceptance button (button display e3 illustrated in (a) in FIG. 19) from operator 50 (S52). Assume that, for example, acceptance request input unit 214 receives pressing of first display h1 corresponding to mobile body 40 having a mobile body ID of “X9.”

Next, acceptance request input unit 214 issues an acceptance request notification to terminal 10 of operator B (S53). When an operation for requesting acceptance of assignment of the responsibility for mobile body 40 is obtained from operator A, the acceptance request notification is transmitted to operator B based on the operation. The acceptance request notification is, for example, the notification indicating that operator A is requesting taking over of the control responsibility for mobile body 40 having a mobile body ID of “X9.”

As illustrated in (b) in FIG. 19, control state presenter 111 switches the display from status display b3 to “requesting substitution (operator B is corresponding)”, which is status display b10 indicating that acceptance of assignment of the control responsibility is being requested. Accordingly, it is possible to report, to operator A, that operator B is requested to accept assignment of the control responsibility for mobile body 40 having a mobile body ID of “X9”. Acceptance request input unit 214 displays “cancel taking over”, which is button display e10 indicating cancellation of the acceptance request. When operator 50 presses button display e10, acceptance request input unit 214 executes the processing of canceling the acceptance request to operator B. For example, acceptance request input unit 214 may notify terminal 10 of operator B that the acceptance request has been canceled.

As illustrated in FIG. 17, next, acceptance request input unit 214 determines whether or not corresponding operator 50 (here, operator B) has accepted the acceptance request (S54). When acceptance request input unit 214 obtains the notification indicating acceptance of the acceptance request from terminal 10 of operator B, acceptance request input unit 214 determines that the acceptance request has been accepted.

Next, when it is determined that operator B has accepted the acceptance request (Yes in S54), transition is made to the control responsibility state (S55), and control state presenter 111 notifies operator A that operator A is in the control responsibility state (S56). Accordingly, the control responsibility for mobile body 40 and the right to operate mobile body 40 are transferred from operator B to operator A.

As illustrated in (c) in FIG. 19, control state presenter 111 switches the display from status display b10 to “assistance in progress”, which is status display b1 indicating that operator A is in the control responsibility state. Accordingly, it is possible to report, to operator A that assignment of the control responsibility for mobile body 40 having a mobile body ID of “X9” has been accepted, and it is necessary to perform remote assistance (operator A himself/herself is corresponding). Furthermore, at this time, operation signal transmitter 216 displays operation display a2 for temporarily stopping mobile body 40 the control responsibility of which has been accepted. Furthermore, control state presenter 111 displays updated number-of-mobile-bodies display g2 after the acceptance of assignment. The number of controlled mobile bodies by operator B is updated from three to two.

When it is determined that operator B has not accepted the acceptance request (No in S54), control state presenter 111 notifies operator A of the failure of the acceptance of assignment (S57). In this case, for example, the first screen illustrated in FIG. 18 may be displayed again.

It should be noted that it may be remote assistance or may be remote operation for which assignment is accepted.

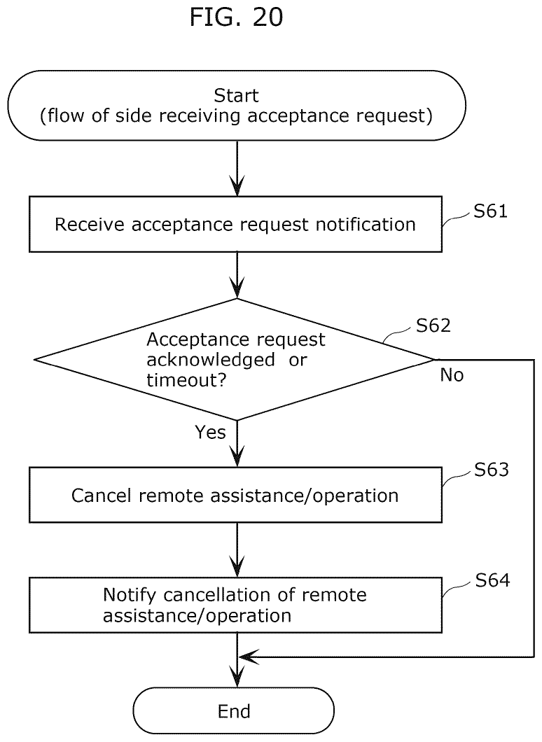

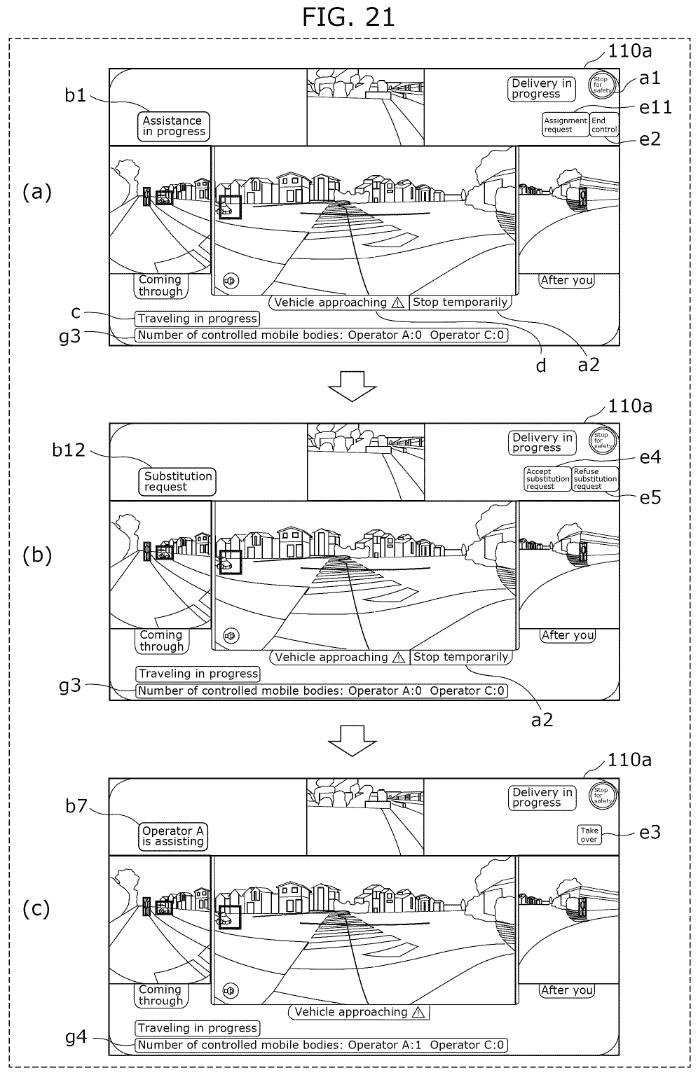

Subsequently, the operations of terminal 10 of the side receiving the acceptance request will be described with reference to FIG. 20 and FIG. 21. FIG. 20 is a flowchart illustrating the operations (information processing method) of the side receiving the acceptance request in remote control system 1 according to the present variation. FIG. 20 illustrates the operations to be executed by terminal 10 of operator B when receiving the acceptance request for the control responsibility from available operator 50 (operator A). FIG. 21 is a diagram illustrating screens that are displayed in display portion 110a of the side receiving the acceptance request in remote control system 1 according to the present variation.

As illustrated in (a) in FIG. 21, “assistance in progress”, which is status display b1 indicating that operator B himself/herself has the control responsibility, is displayed in display portion 110a before receiving the acceptance request. Furthermore, number-of-controlled-mobile-bodies display 93 indicating the numbers of controlled mobile bodies by the other operators 50 other than operator B is displayed. The number of controlled mobile bodies by available operator 50 (operator A who has sent the acceptance request in FIG. 17) is 0. Furthermore, assignment request input unit 212 displays “assignment request”, which is button display e11 for sending the assignment request.

As illustrated in FIG. 20, terminal 10 of operator B receives the acceptance request notification from terminal 10 of operator A (S61).

As illustrated in (b) in FIG. 21, when the acceptance request notification is received, control state presenter 111 switches the display from status display b1 to “substitution request”, which is status display b12 indicating that the acceptance request (substitution request) is notified. Furthermore, acceptance request response input unit 213 displays “accept substitution request”, which is button display e4 indicating acceptance of the acceptance request, and “refuse substitution request”, which is button display e5 indicating refusal of the assignment request.

As illustrated in FIG. 20, next, acceptance request response input unit 213 determines whether or not acceptance of the acceptance request for the control responsibility has been acknowledged, and whether a timeout has occurred (S62). When button display e4 is operated by operator B, or when a timeout has occurred (when button display e4 or e5 has not been operated by operator B for a predetermined period of time or more), acceptance request response input unit 213 determines that acceptance has been acknowledged, and when button display e5 is operated by operator B, acceptance request response input unit 213 determines that acceptance has been refused. By determining that acceptance has been acknowledged when a timeout has occurred, even in a situation where, for example, operator B cannot respond due to poor physical condition or the like, it becomes possible to cause operator A to accept assignment of the responsibility for mobile body 40.

Next, when acceptance request response input unit 213 determines that acceptance has been acknowledged (Yes in S62), acceptance request response input unit 213 cancels remote assistance/operation (S63), and notifies operator B of the cancellation of remote assistance/operation (S64). Furthermore, for example, when it is determined that acceptance has been acknowledged, terminal 10 of operator A transmits, to terminal 10 of operator B, the information indicating (who has) the control responsibility for mobile body 40 and the information indicating (the grant of) the right to operate mobile body 40. The information indicating (who has) the control responsibility includes the information indicating that the control responsibility is to be transferred from operator B to operator A, and the information indicating (the grant of) the right to operate includes the information indicating that the right to operate is to be transferred from operator B to operator A.

As illustrated in (c) in FIG. 21, when the acceptance request notification is accepted, control state presenter 111 switches the display from status display b12 to “operator A is assisting”, which is status display b7 indicating that operator A is corresponding. Displaying status display b7 corresponds to notifying operator B of cancellation of remote assistance/operation. Furthermore, at this time, operation signal transmitter 216 undisplays (disables) operation display a2. Furthermore, control state presenter 111 displays updated number-of-mobile-bodies display g4 after the acceptance of assignment.

Accordingly, it is possible to positively cause operator A to accept assignment of the control responsibility that operator B has in the three steps, i.e., starting control, the acceptance request, and approving the acceptance of the acceptance request. Furthermore, since approval of the acceptance of the acceptance request is explicitly performed, it is clear who has the responsibility at the time of substitution to operator A, and therefore, for example, the control responsibility can be clearly handed over from operator B to operator A.

### Variation 5 of the Embodiment

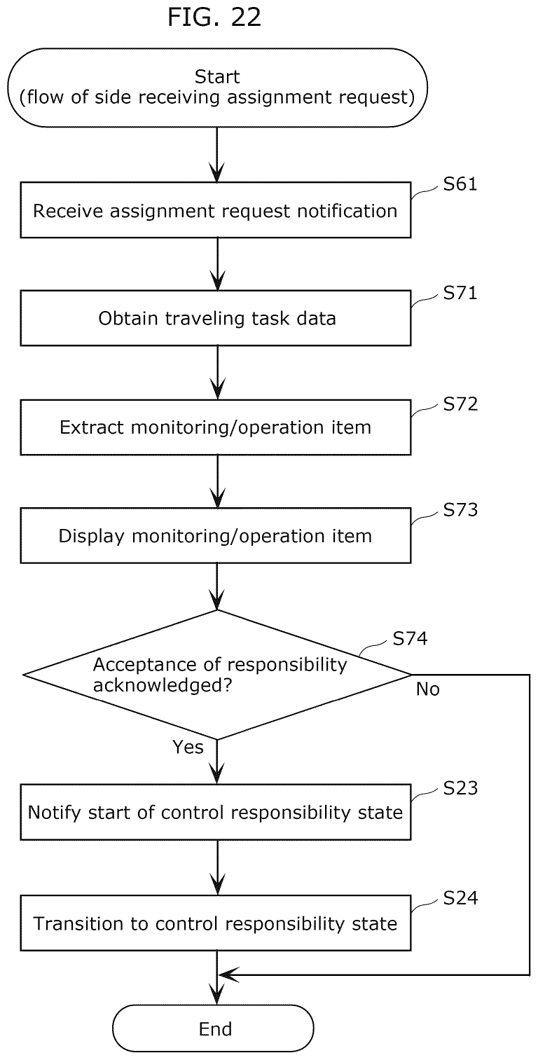

Hereinafter, remote control system 1 according to the present variation will be described with reference to FIG. 22 to FIG. 25. It should be noted that, hereinafter, differences from the embodiment will be mainly described, and a description of contents that are the same as or similar to the embodiment will be omitted or simplified. In the present variation, a description will be given of terminal 10 that presents, when the traveling route of mobile body 40 is set in advance, the information capable of assisting operator 50 who has received an assignment request in determining whether or not to accept the assignment request.

FIG. 22 is a flowchart illustrating the operations (information processing method) of the side receiving the assignment request in remote control system 1 according to the present variation. In the present variation, an example will be described in which the supplementary information for determining whether or not to accept the assignment request is presented to operator 50 who receives the assignment request. It should be noted that each processing illustrated in FIG. 22 may be executed by any processing unit of terminal 10.

As illustrated in FIG. 22, terminal 10 of operator A receives an assignment request notification from the other operator 50 or automated driving system 46 (that is, mobile body 40) (S61). The assignment request notification may include, for example, the mobile body ID of mobile body 40 for which the assignment request is sent.

Next, terminal 10 obtains, from traveling task information DB 32 in storage device 30, traveling task data for mobile body 40 for which the assignment request has been received (S71). The traveling task data here indicates, in the case where the traveling route of mobile body 40 is set in advance, the current state of a plurality of traveling tasks in the traveling route.

FIG. 23 is a diagram illustrating traveling task data according to the present variation.

As illustrated in FIG. 23, the traveling task data includes the order, the traveling task type, and the state.

The order indicates the order in which a traveling task occurs, and traveling tasks occur in the order of 1 to 5.

The traveling task type indicates what traveling task occurs. Traveling task types include traveling along a road, traveling a crosswalk, traveling in an area where pedestrians may rush out, traveling an intersection, and the like, but are not limited to these.

The state indicates the state of each traveling task at present, and includes end, executing, unexecuted, and the like.

The example in FIG. 23 illustrates that mobile body 40 is currently executing (traveling) the traveling in an area where pedestrians may rush out, which is order 4, the traveling an intersection, which is order 5, is unexecuted, and the traveling an intersection is to be executed after the traveling in an area where pedestrians may rush out.

With reference to FIG. 22 again, next, terminal 10 extracts a monitoring/operation item that is generated when an assignment request is received, based on the traveling task data obtained in step S71, and manual data obtained from manual information DB 33 (S72).

FIG. 24 is a diagram illustrating the manual data according to the present variation.

As illustrated in FIG. 24, the manual data is a table in which the traveling task type, the monitoring item, and the operation item are associated with each other. The monitoring item indicates a subject that requires monitoring by operator 50 for each traveling task type, and includes, for example, unnecessary (no subject to be monitored), a front pedestrian, an approaching vehicle, and the like, but is not limited to these. The operation item indicates the details of an operation to be handled by operator 50 for each traveling task type, and includes, for example, unnecessary (no operation required), start traveling, stop traveling in case of danger, remote operation, and the like, but is not limited to these.

Terminal 10 extracts a traveling task that is included in the traveling task data and that is being executed, and extracts the monitoring item and operation item corresponding to the extracted traveling task from the manual data. In the example of FIG. 23 and FIG. 24, the traveling in an area where pedestrians may rush out is extracted as the traveling task that is being executed, the front pedestrian is extracted as the monitoring item corresponding to the extracted traveling task, and stop traveling in case of danger is extracted as the operation item.

It should be noted that, instead of the traveling task that is being executed, or in addition to the traveling task that is being executed, terminal 10 may extract an unexecuted traveling task, and extract the monitoring item and operation item corresponding to the unexecuted traveling task.

Next, terminal 10 displays, in display portion 110a, the information based on the monitoring/operation item extracted in step S72 (S73).

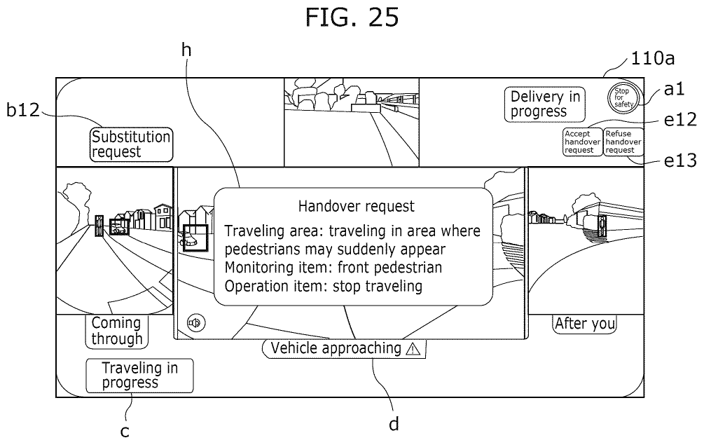

FIG. 25 is a diagram illustrating a screen that is displayed in display portion 110a of the side receiving the assistance request in remote control system 1 according to the present variation.

As illustrated in FIG. 25, assistance display h including the items extracted in step S72 is displayed as a handover request that is overlapped with the area in which the video obtained by capturing the surroundings of mobile body 40 is displayed. It should be noted that assistance display h may be displayed in, for example, an area that does not overlap with the area in which the video is displayed. Furthermore, assignment request response input unit 211 displays button displays e12 and e13 as responding buttons in a case where the handover request is received from the other operator 50. For example, “accept handover request” indicating acceptance of the assignment request (handover request) is displayed as button display e12, and “refuse handover request” indicating that the assignment request is not accepted is displayed as button display e13.

Since operator 50 can determine whether or not to accept the assignment request with reference to assistance display h displayed as auxiliary information, operator 50 can more correctly perform the determination.

As described above, in the present variation, when an assignment request is obtained, the details of the remote control (remote assistance or remote operation) of mobile body 40 are presented to the other operator 50, and after the details are presented, an operation regarding whether the assignment request is acknowledged is obtained from the other operator 50.

It should be noted that, in the above, although the example has been described in which terminal 10 extracts both the monitoring item and the operation item by using the traveling task data and the manual data, this is not a limitation, and at least one of the monitoring item and the operation item may be extracted and presented.

Next, assignment request response input unit 211 determines whether or not acceptance of the assignment request for the control responsibility has been acknowledged (S74). When a notification indicating that button display e12 has been operated by operator 50 is received from terminal 10 of the other operator 50, assignment request response input unit 211 determines that acceptance has been acknowledged, and when a notification indicating that button display e13 has been operated by the other operator 50 is received from terminal 10 of the other operator 50, or when there is no button operation for a predetermined period of time, assignment request response input unit 211 determines that acceptance has been refused. When the determination in step S74 is Yes, the processing proceeds to step S23, and when the determination in step S74 is No, the processing ends.

### Variation 6 of the Embodiment

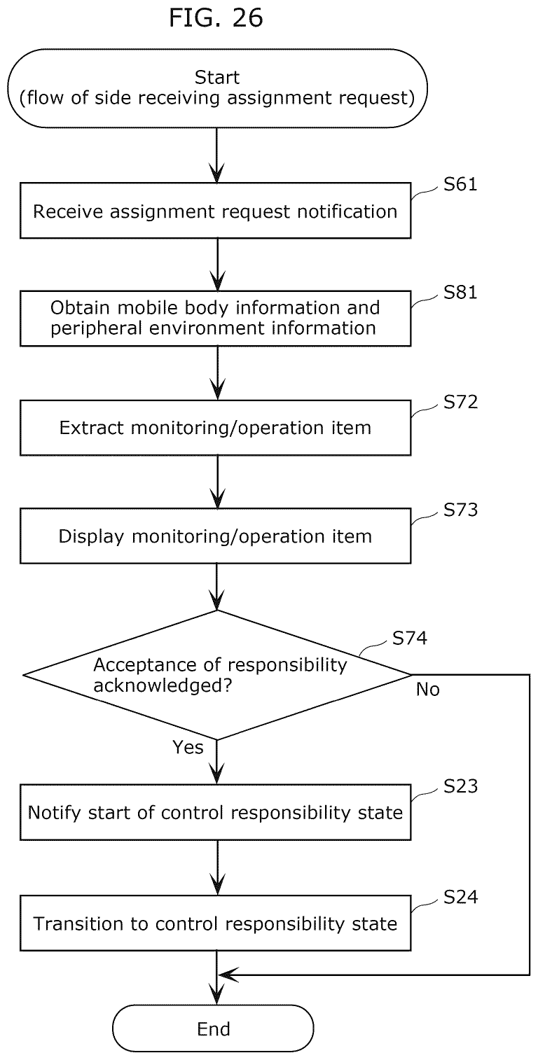

Hereinafter, remote control system 1 according to the present variation will be described with reference to FIG. 26 to FIG. 29. It should be noted that, hereinafter, differences from the embodiment will be mainly described, and a description of contents that are the same as or similar to the embodiment will be omitted or simplified. In the present variation, a description will be given of terminal 10 that can present, when the traveling route of mobile body 40 is not set in advance, the information capable of assisting operator 50 who has received an assignment request in determining whether or not to accept the assignment request.

FIG. 26 is a flowchart illustrating the operations (information processing method) of the side sending an assistance request in remote control system 1 according to the present variation.

As illustrated in FIG. 26, when terminal 10 of operator B receives an assignment request notification from terminal 10 of operator A (S61), terminal 10 of operator B obtains the mobile body information from mobile body information transmitter 127 of control server 20, and obtains the peripheral environment information from peripheral environment information transmitter 128 of control server 20 (S81).

FIG. 27 is a diagram illustrating the mobile body information according to the present variation. In FIG. 27, the mobile body information items of two mobile bodies 40 are illustrated in (a) and (b) in FIG. 27.

As illustrated in FIG. 27, the mobile body information includes, as the items, the mobile body ID, the state, the speed, and the position. (a) in FIG. 27 illustrates an example in which mobile body 40 having a mobile body ID of “101” is traveling a crosswalk (latitude of 35.681731 degrees, longitude of 139.763495 degrees) at a speed of 5 km/h. (b) in FIG. 27 illustrates an example in which mobile body 40 having a mobile body ID of “102” has a speed of 0 km/h, and is stopped on a sidewalk (latitude of 35.681386 degrees, longitude of 139.763369 degrees).

FIG. 28 is a diagram illustrating the peripheral environment information according to the present variation. In FIG. 28, the peripheral environment information items of two mobile bodies 40 are illustrated in (a) and (b) of FIG. 28.

As illustrated in FIG. 28, the peripheral environment information includes, as the items, the mobile body ID, the peripheral environment state, and the number of detected objects. (a) in FIG. 28 illustrates an example in which two vehicles are approaching mobile body 40 having a mobile body ID of “101”. (b) in FIG. 28 illustrates an example in which two pedestrians are approaching mobile body 40 having a mobile body ID of “102.”

With reference to FIG. 26 again, next, terminal 10 extracts the monitoring/operation item that is generated when an assignment request is received, based on the mobile body information and the peripheral environment information obtained in step S81, and the manual data obtained from manual information DB 33 (S72).

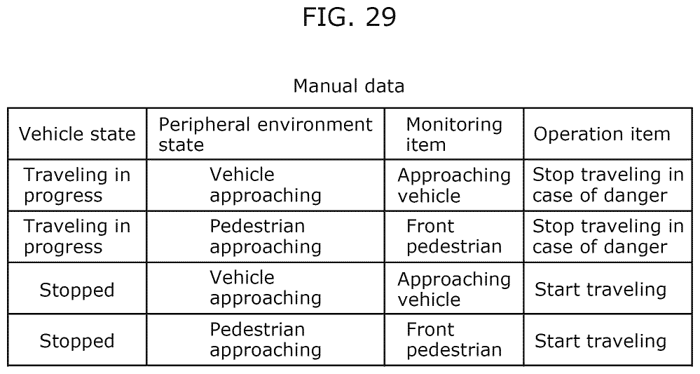

FIG. 29 is a diagram illustrating the manual data according to the present variation.

As illustrated in FIG. 29, the manual data is a table in which the vehicle state, the peripheral environment state, the monitoring item, and the operation item are associated with each other.

In the example of FIG. 29, when mobile body 40 is traveling and a vehicle is approaching, the monitoring item is “approaching vehicle”, which is associated with the operation item “stop traveling in case of danger” operation.

In step S72, terminal 10 extracts the state of mobile body 40 included in the mobile body information, and the monitoring item and operation item corresponding to the peripheral environment state of mobile body 40 included in the peripheral environment information. Terminal 10 extracts, for example, for mobile body 40 having a mobile body ID of “101”, that the monitoring item is the approaching vehicle, and the operation item is stop traveling in case of danger, and for mobile body 40 having a mobile body ID of “102”, terminal 10 extracts that the monitoring item is the front pedestrian, and the operation item is start traveling.

Accordingly, even in the case where the traveling route is not set in advance to mobile body 40, terminal 10 can present the information that assists operator 50 who has received the assignment request in determining whether or not to accept the assignment request, based on the current information on mobile body 40 or the surroundings of mobile body 40.

It should be noted that, in the above, although the example has been described in which terminal 10 extracts both the monitoring item and the operation item by using both the mobile body information and the peripheral environment information, this is not a limitation, and at least one of the monitoring item and the operation item may be extracted and presented, based on at least one of the mobile body information and the peripheral environment information.

### Variation 7 of the Embodiment

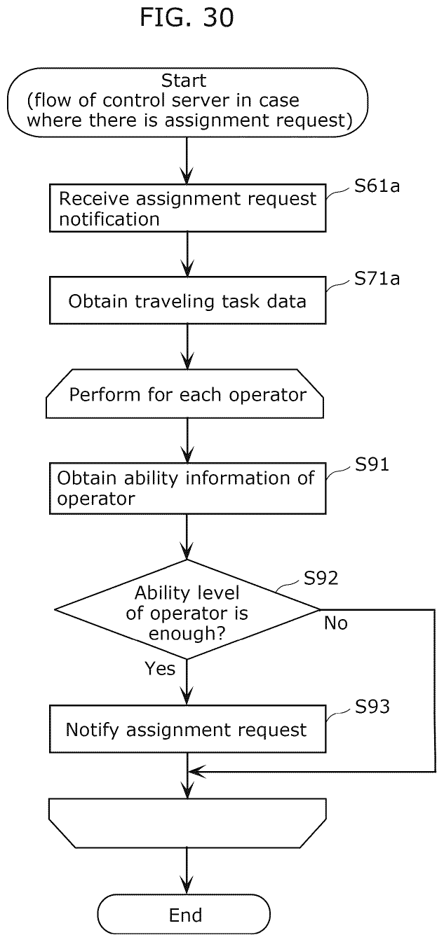

Hereinafter, remote control system 1 according to the present variation will be described with reference to FIG. 30 to FIG. 34. It should be noted that, hereinafter, differences from the embodiment will be mainly described, and a description of contents that are the same as or similar to the embodiment will be omitted or simplified. In the present variation, a description will be given of a case where control server 20 narrows down operator 50 who sends an assignment request.

FIG. 30 is a flowchart illustrating the operations (information processing method) of control server 20 in remote control system 1 according to the present variation. It should be noted that each processing illustrated in FIG. 30 may be executed by any processing unit of control server 20.

As illustrated in FIG. 30, control server 20 receives an assignment request notification from terminal 10 (S61a).

Next, control server 20 obtains the traveling task data for mobile body 40 for which the assignment request has been received from traveling task information DB 32 in storage device 30 (S71a). The traveling task data here indicates, when the traveling route of mobile body 40 is set in advance, the current state of a plurality of traveling tasks in the traveling route.

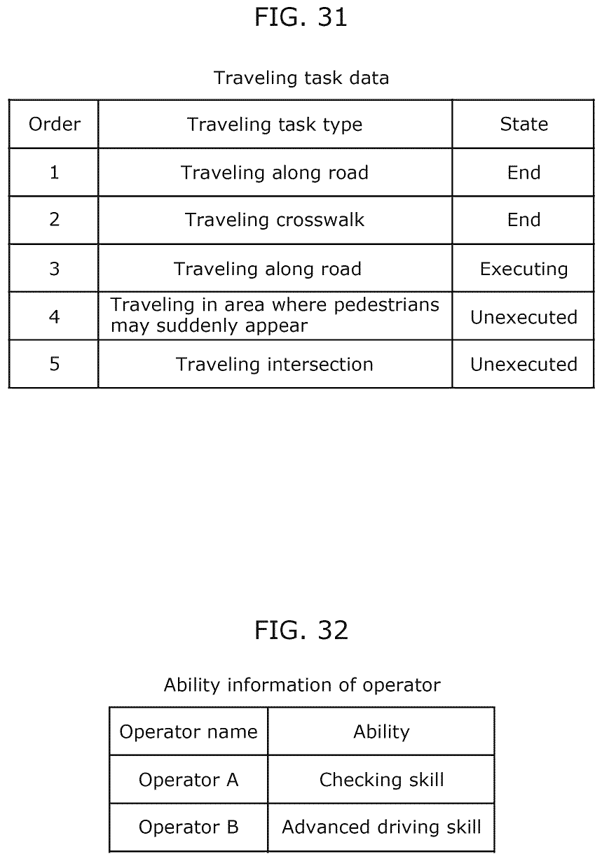

FIG. 31 is a diagram illustrating the traveling task data according to the present variation.

As illustrated in FIG. 31, similar to FIG. 23, the traveling task data includes the order, the traveling task type, and the state. In the example of FIG. 31, it is illustrated that mobile body 40 is currently performing traveling along a road, which is order 3.

With reference to FIG. 30 again, next, assignment request destination determiner 123 executes the processing in steps S91 to S93 for each of operators 50 who are assignment targets. Operators 50 who are assignment targets may be all the other operators 50 except for operator 50 of terminal 10 that has transmitted the assignment request notification.

Assignment request destination determiner 123 obtains the ability information indicating the ability of operator 50 relating to the remote control from operator qualification information DB 34 in storage device 30 (S91).

FIG. 32 is a diagram illustrating the ability information of operator 50 according to the present variation. FIG. 33 is a diagram illustrating the level information of the ability of operator 50 according to the present variation.

As illustrated in FIG. 32, the ability information of operator 50 indicates the ability for each operator 50. In the example of FIG. 32, the ability (qualification) of operator A is “checking skill”, and the ability of operator B is “advanced driving skill.”

As illustrated in FIG. 33, the level information of the ability of operator 50 includes the level and the ability. In the example of FIG. 33, the ability corresponding to level “3” is the advanced driving skill, the ability corresponding to level “2” is the driving skill, and the ability corresponding to level “1” is the checking skill. It is obtained in advance which level (which skill) of each of the levels (each of the skills) illustrated in FIG. 33 each of a plurality of operators 50 is at, and the ability information illustrated in FIG. 32 is generated.

With reference to FIG. 30 again, next, assignment request destination determiner 123 determines whether or not the ability level of operator 50 is enough (S92). Whether or not the ability level of operator 50 is enough means, for example, whether or not operator 50 has the ability corresponding to the remote control (remote assistance or remote operation) of mobile body 40 for which an assignment request is sent.

FIG. 34 is a diagram illustrating the required ability information according to the present variation.

As illustrated in FIG. 34, the required ability information is a table in which the traveling task is associated with the required ability. In the example of FIG. 34, the required ability in the case where the traveling task type is traveling along a road is the driving skill (Level 2), the required ability in the case where the traveling task type is traveling a narrow road is the advanced driving skill (Level 3), and the required ability in the cases of the other traveling task types is the checking skill (Level 1).

Assignment request destination determiner 123 extracts at least one of the traveling task that is being executed and the unexecuted traveling task based on the traveling task data, and identifies the required ability for executing the traveling task based on the extracted traveling task and the required ability information. For example, when traveling along a road is extracted, which is the traveling task that is being executed, based on the traveling task data, the required ability is identified as the driving skill based on required ability information.

Assignment request destination determiner 123 executes the determination in step S92 by determining whether or not the ability of the operator 50 based on the ability information includes an ability equal to or more than the identified ability. In the case where the identified ability is the driving skill, when the ability of the operator 50 based on the ability information is equal to or more than the driving skill (for example, Level 2 or higher), assignment request destination determiner 123 determines that the ability level of the operator 50 is enough, and when the ability of operator 50 based on the ability information is less than the driving skill (for example, Level 1), assignment request destination determiner 123 determines that the ability level of the operator 50 is not enough.

Next, when assignment request destination determiner 123 determines that the ability level of operator 50 is enough (Yes in S92), assignment request destination determiner 123 notifies (for example, forwards) an assignment request to terminal 10 of operator 50 whose ability level has been determined to be enough (S93). That is, when it is determined that operator 50 has the ability corresponding to the remote control of mobile body 40 to be assigned, the assignment request for assigning the responsibility for the mobile body 40 is notified to the operator 50 (for example, the operator 50 obtains the assignment request).

Furthermore, when assignment request destination determiner 123 determines that the ability level of operator 50 is not enough (No in S92), the assignment request is not notified to terminal 10 of operator 50 whose ability level has been determined to be not enough.

Accordingly, the assignment request can be notified to operator 50 who can execute the traveling task. For example, when there is an operation that requires an advanced ability, it is possible to prevent the remote control from being handed over to operator 50 with a low ability.

### Variation 8 of the Embodiment

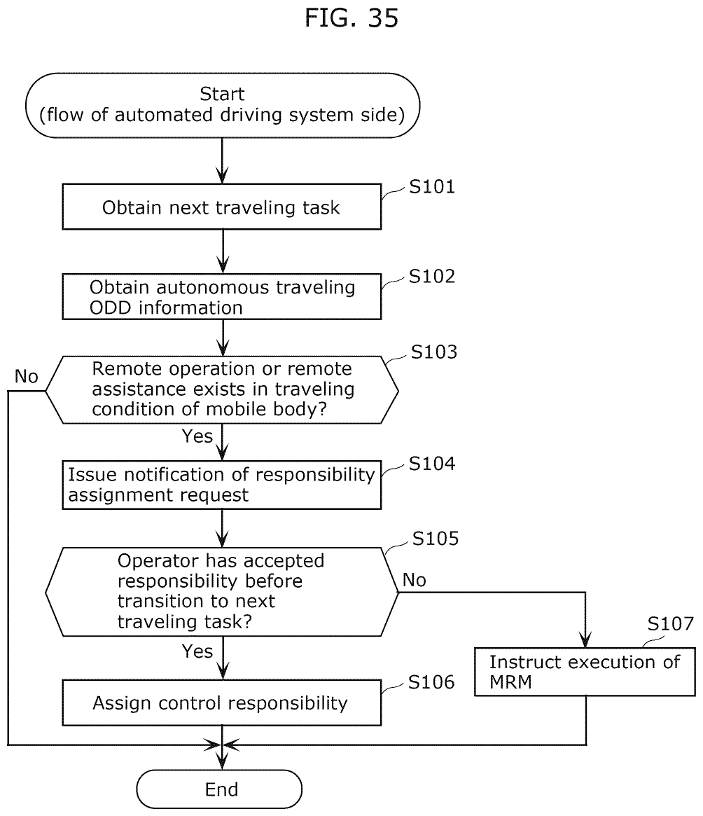

Hereinafter, remote control system 1 according to the present variation will be described with reference to FIG. 35 to FIG. 38. It should be noted that, hereinafter, differences from the embodiment will be mainly described, and a description of contents that are the same as or similar to the embodiment will be omitted or simplified. In the present variation, a description will be given of a case where the control responsibility is assigned to operator 50 from automated driving system 46 mounted on mobile body 40.

FIG. 35 is a flowchart illustrating the operations (information processing method) of automated driving system 46 in remote control system 1 according to the present variation.

As illustrated in FIG. 35, automated driving system 46 obtains the next traveling task (S101). When the traveling task data is stored in mobile body 40, automated driving system 46 obtains the next traveling task from the traveling task data. For example, in the traveling task data illustrated in FIG. 31, traveling in an area where pedestrians may rush out is obtained as the next traveling task. It should be noted that in step S101, in addition to the next traveling task, or instead of the next traveling task, all the remaining traveling tasks (in the case of FIG. 31, traveling in an area where pedestrians may rush out and traveling an intersection) may be obtained.

Next, automated driving system 46 obtains autonomous traveling ODD information from storage device 30 (S102). The autonomous traveling ODD information may be created, for example, for each type of mobile body 40.

FIG. 36 is a diagram illustrating the autonomous traveling ODD information according to the present variation.

As illustrated in FIG. 36, the autonomous traveling ODD information is a table in which the traveling task type is associated with the traveling condition. The traveling condition indicates the condition that is required for operation by remote control in order for mobile body 40 to travel autonomously. Since traveling along a road and traveling a narrow road have no traveling condition, mobile body 40 can travel autonomously without operations for remote control. For example, autonomous traveling is possible merely by having operator 50 perform remote monitoring. Since the traveling condition for traveling a crosswalk and traveling an intersection is remote assistance, autonomous traveling is possible when there is remote assistance by operator 50. Since the traveling condition for traveling in an area where pedestrians may rush out is remote operation, autonomous traveling is possible when there is remote operation by operator 50.

Next, automated driving system 46 determines whether or not remote operation or remote assistance exists in the traveling condition of mobile body 40 (S103). Automated driving system 46 identifies, for example, the traveling condition corresponding to the next traveling task from the autonomous traveling ODD information, and determines whether or not remote operation or remote assistance is included in the identified traveling condition.

Next, when automated driving system 46 determines that remote operation or remote assistance exists (Yes in S103), automated driving system 46 issues a notification of responsibility assignment request (S104). Automated driving system 46 requests control server 20 to assign the control responsibility. In this manner, the assignment request to operator 50 is notified from automated driving system 46. It should be noted that when remote assistance is required, a notification of remote assistance request is issued as a responsibility assignment request, and when remote operation is required, a notification of remote operation request is issued as the responsibility assignment request.

Next, automated driving system 46 determines whether or not operator 50 has accepted the responsibility (has accepted the responsibility assignment request) before transition to the next traveling task (S105). When automated driving system 46 obtains, from terminal 10 or control server 20, a response that acknowledges the responsibility assignment request, automated driving system 46 determines Yes in step S105.

When automated driving system 46 determines that operator 50 has accepted the responsibility before the transition to the next traveling task (Yes in S105), automated driving system 46 assigns the control responsibility to operator 50 who has accepted the responsibility (S106). When automated driving system 46 determines, for example, that operator 50 has accepted the responsibility, automated driving system 46 transmits, to terminal 10 of operator 50 who has accepted the responsibility, the information indicating (who has) the control responsibility for the mobile body 40 and the information indicating (the grant of) the right to operate mobile body 40. Furthermore, when it is determined that operator 50 has not accepted the responsibility before the transition to the next traveling task (No in S105), MRM executor 41 executes an MRM (S107).

Furthermore, when automated driving system 46 determines that remote operation or remote assistance does not existing (No in S103), autonomous traveling is continued.

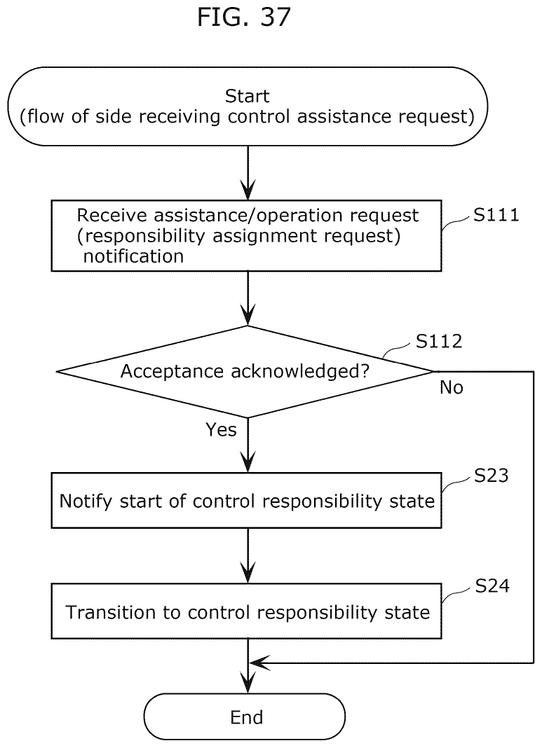

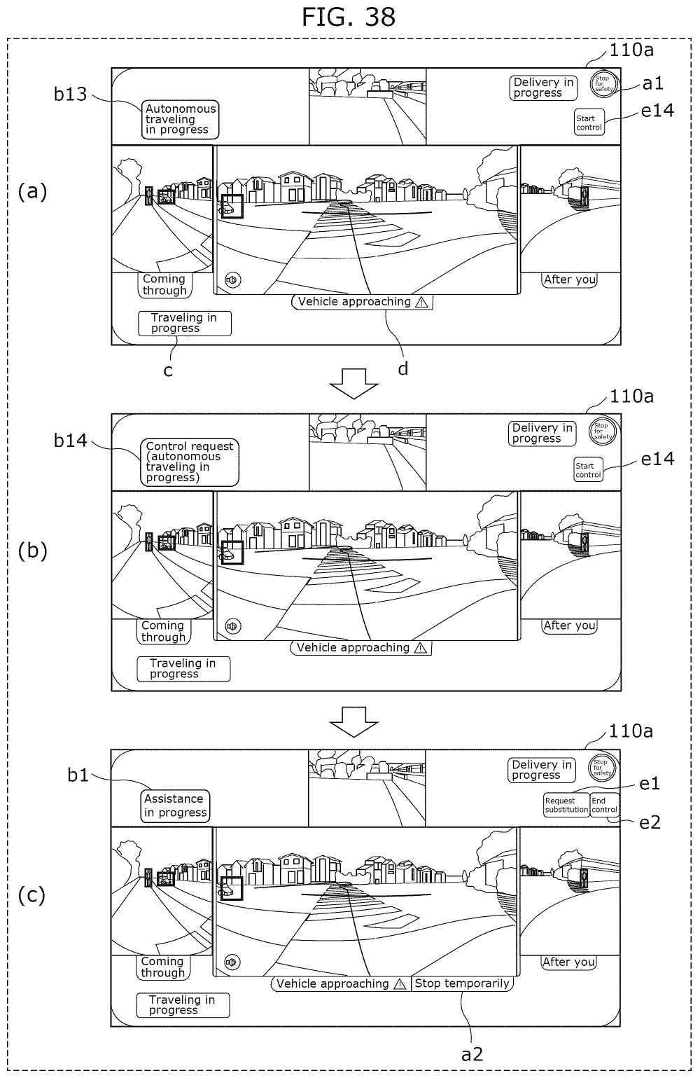

Subsequently, the operations of terminal 10 of the side receiving the assistance request (control assistance request) will be described with reference to FIG. 37 and FIG. 38. FIG. 37 is a flowchart illustrating the operations (information processing method) of the side receiving the assistance request in remote control system 1 according to the present variation. FIG. 38 is a diagram illustrating screens that are displayed in display portion 110a of the side receiving the assistance request in remote control system 1 according to the present variation. It is assumed that operator 50 who receives an assistance request is remotely monitoring mobile body 40 that issues the assistance request (issues the notification of responsibility assignment request in step S104). Therefore, as illustrated in (a) in FIG. 38, control state presenter 111 displays “autonomous traveling in progress”, which is status display b13 indicating that mobile body 40 is traveling autonomously. Furthermore, start and end input unit 215 displays “start control”, which is button display e14 (operation component) for starting the control. Button display e14 is an example of the information (display) indicating the start of remote control.

It should be noted that button display e14 may be set so that button display e14 cannot be operated unless a predetermined condition is satisfied. For example, button display e14 may be enabled when the ability of operator 50 relating to the remote control satisfies the ability relating to the remote control required to continue autonomous travel of mobile body 40 for which the remote control is to be started. Here, being enabled is that the function of button display e14 is enabled, and may be, for example, that the operation of button display e14 is enabled.

As illustrated in FIG. 37, terminal 10 receives an assistance/operation request notification (for example, the notification of responsibility assignment request in step S104) (S111).

As notification in (b) in FIG. 38, when the assistance/operation request notification is received, assignment request presenter 112 switches the display from status display b13 to “control request (autonomous traveling in progress)”, which is status display b14 indicating that the assignment request is notified.

As illustrated in FIG. 37, terminal 10 determines whether or not acceptance has been acknowledged (S112). When it is detected that button display e14 has been pressed, start and end input unit 215 determines that operator 50 has acknowledged the acceptance.

Next, when it is determined that operator 50 has acknowledged the acceptance (Yes in S112), start and end input unit 215 notifies the start of the control responsibility state (S23), and transition to the control responsibility state is made (S24). In this manner, based on button display e14, which indicates the start of the remote control, having been operated, the responsibility for mobile body 40 and the right to operate mobile body 40 are transferred to operator 50 who has operated button display e14.

As illustrated in (c) in FIG. 38, when operator 50 accepts the assistance request, control state presenter 111 switches the display from status display b14 to “assistance in progress”, which is status display b1 indicating that operator 50 has the control responsibility. Accordingly, it is possible to report that the control responsibility is assigned to operator 50, and operator 50 himself/herself has the control responsibility.

Furthermore, assignment request input unit 212 displays button display e1, and start and end input unit 215 displays button display e2. Furthermore, operation signal transmitter 216 displays operation display a2 corresponding to control assistance.

Furthermore, when it is determined that acceptance has not been acknowledged (No in S112), start and end input unit 215 ends the processing.

### Variation 9 of the Embodiment

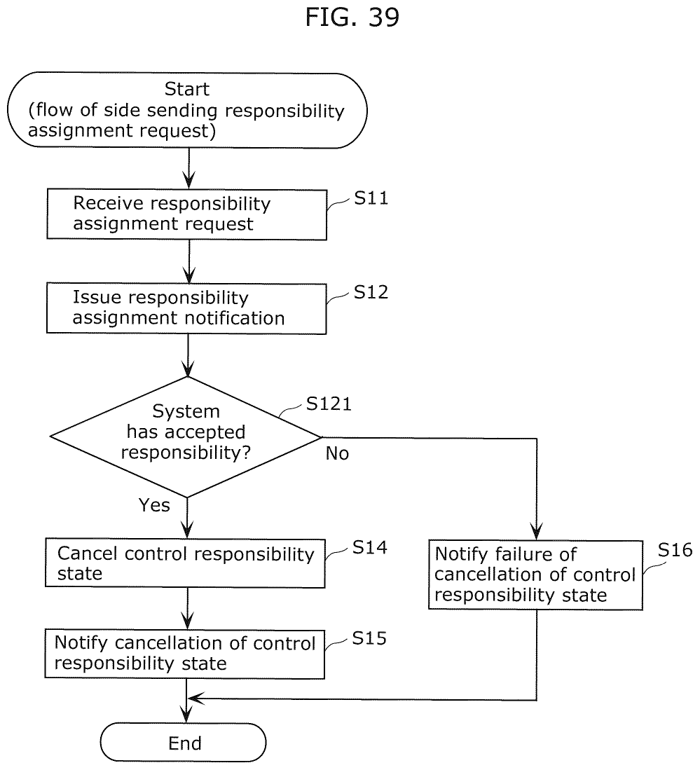

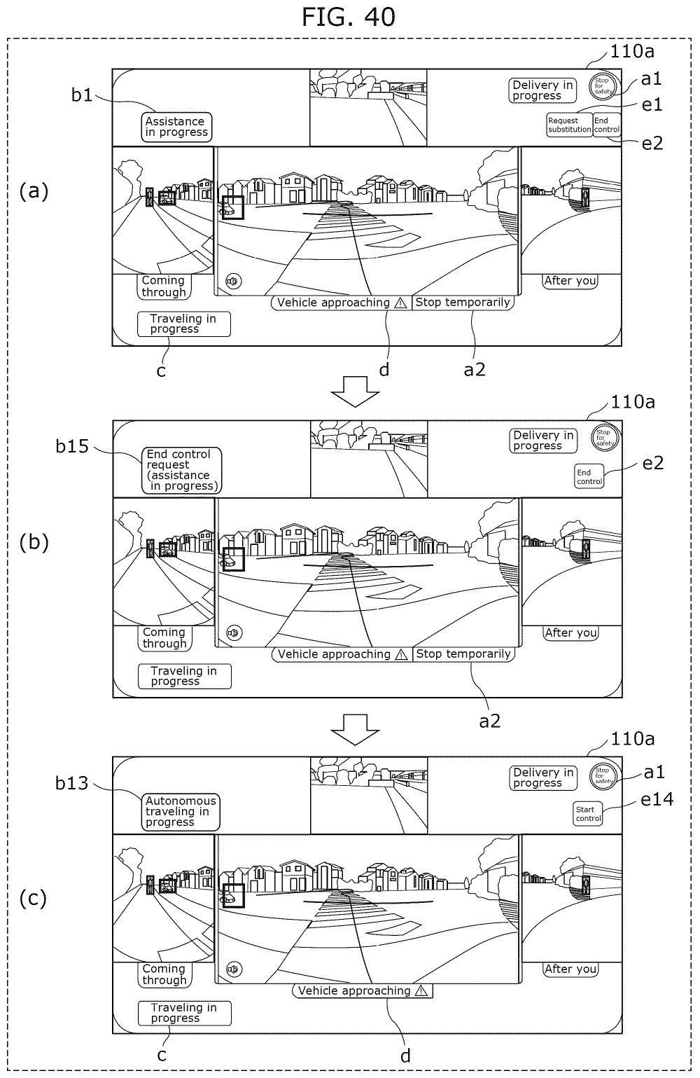

Hereinafter, remote control system 1 according to the present variation will be described with reference to FIG. 39 to FIG. 41. It should be noted that, hereinafter, differences from the embodiment will be mainly described, and a description of contents that are the same as or similar to the embodiment will be omitted or simplified. In the present variation, a description will be given of a case where the control responsibility is assigned from operator 50 to automated driving system 46 mounted on mobile body 40. FIG. 40 is a diagram illustrating screens that are displayed in display portion 110a of the side sending a responsibility assignment request in remote control system 1 according to the present variation.

FIG. 39 is a flowchart illustrating the operations (information processing method) of the side sending the responsibility assignment request in remote control system 1 according to the present variation.

As illustrated in FIG. 39, when assignment request input unit 212 receives the responsibility assignment request in step S11, assignment request input unit 212 issues a responsibility assignment notification to mobile body 40 (for example, automated driving system 46) (S12). Issuing means transmitting the responsibility assignment notification to mobile body 40.

As illustrated in (b) in FIG. 40, control state presenter 111 switches the display from status display b1 to “end control request (assistance in progress)”, which is status display b15 indicating that the assignment request for the control responsibility is being made. That is, status display b15 is presented to operator A. Accordingly, it is possible to report, to operator A, that the assignment request for the control responsibility is being made. It should be noted that status display b15 may include the information indicating that the assignment request is being made to automated driving system 46.

As illustrated in FIG. 39, next, assignment request input unit 212 determines whether or not mobile body 40 (for example, automated driving system 46) has accepted the control responsibility (S121). When assignment request input unit 212 obtains (for example, receives), from mobile body 40, the notification indicating that the assignment request has been accepted, assignment request input unit 212 determines that mobile body 40 has accepted the control responsibility. The notification is an example of the information regarding whether or not the assignment request is acknowledged.

Next, when assignment request input unit 212 determines that mobile body 40 has accepted the control responsibility (Yes in S121), assignment request input unit 212 cancels the control responsibility state of operator A (S14), and notifies operator A of the cancellation of the control responsibility state (S15). Furthermore, when it is determined that mobile body 40 has accepted the control responsibility, terminal 10 of operator A transmits, to mobile body 40, the information indicating (who has) the control responsibility for mobile body 40 and the information indicating (the grant of) the right to operate mobile body 40. The formation indicating (who has) the control responsibility includes the information indicating that the control responsibility is transferred from operator A to automated driving system 46, and the information indicating (the grant of) the right to operate includes the information indicating that the right to operate is transferred from operator A to automated driving system 46.

As illustrated in (c) in FIG. 40, control state presenter 111 switches the display from status display b15 to “autonomous traveling in progress”, which is status display b13 indicating that mobile body 40 is traveling autonomously. Accordingly, it is possible to report, to operator A, that the control responsibility state is canceled, and the control responsibility is transferred to automated driving system 46. At this time, operation display a2 is switched to the inactive (for example, undisplayed) state. Accordingly, it becomes impossible for operator A to operate mobile body 40. That is, the right to operate mobile body 40 is assigned. For example, for operator A, the form of remote control is switched from remote assistance to remote monitoring. Furthermore, assignment request input unit 212 switches the display from button display e2 to button display e14 as a response button in the case where an assignment request is received from mobile body 40 (for example, automated driving system 46).

As described above, it is presented to operator A that the responsibility for mobile body 40 has been assigned to automated driving system 46 of the mobile body 40, and that the right to operate mobile body 40 has assigned to automated driving system 46 of the mobile body 40, using mutually different modes.

Furthermore, when control state presenter 111 obtains (for example, receives), from mobile body 40, the notification indicating refusal of acceptance of the assignment request, control state presenter 111 determines that mobile body 40 has refused the control responsibility (No in S121), and notifies operator A that cancellation of the control responsibility state has failed (S16). In this case, for example, operator A continues to remotely assist mobile body 40.

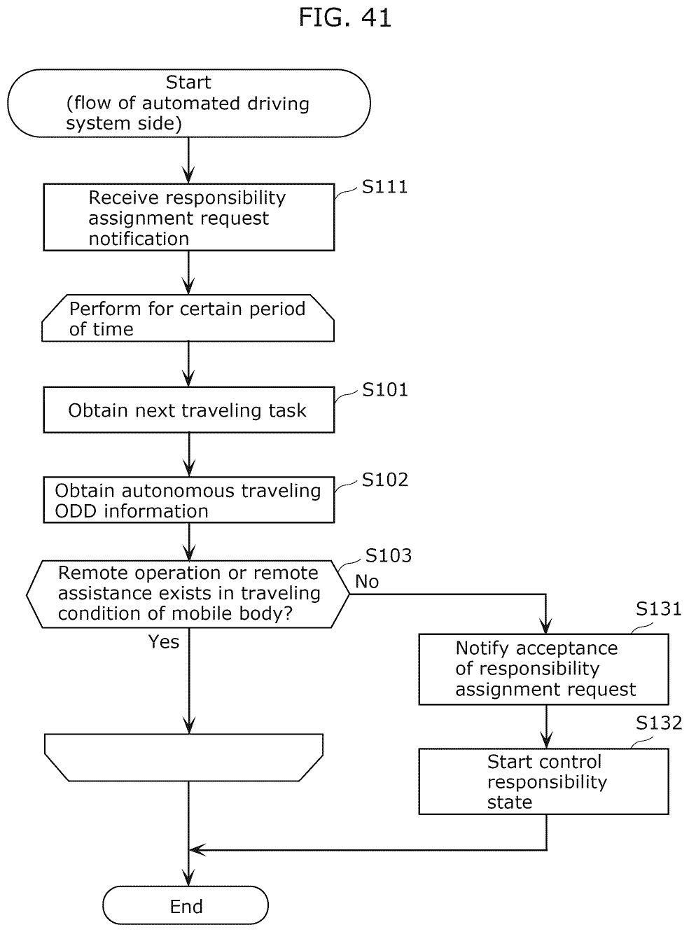

Subsequently, the operations of mobile body 40 (automated driving system 46) of the side receiving the assignment request will be described with reference to FIG. 41. FIG. 41 is a flowchart illustrating the operations of the automated driving system 46 side in remote control system 1 according to the present variation.

As illustrated in FIG. 41, automated driving system 46 receives a responsibility assignment request notification from terminal 10 of operator A (S111).

Next, automated driving system 46 performs the processing in steps S101 to S103 for a certain period of time.

Automated driving system 46 obtains the next traveling task (S101). When the traveling task data (refer to, for example, FIG. 31) is stored in mobile body 40, automated driving system 46 receives the traveling task data, and identifies the next traveling task from the received traveling task data.

Next, automated driving system 46 obtains the autonomous traveling ODD information from storage device 30 (S102). The autonomous traveling ODD information may be created, for example, for each type of mobile body 40. Automated driving system 46 receives, for example, the autonomous traveling ODD information illustrated in FIG. 36.

Automated driving system 46 determines whether or not remote operation or remote assistance exists in the traveling condition of mobile body 40 (S103). Automated driving system 46 identifies, for example, the traveling condition corresponding to the next traveling task from the autonomous traveling ODD information, and determines whether or not remote operation or remote assistance is included in the identified traveling condition.

Next, when automated driving system 46 determines that remote operation or remote assistance exists (Yes in S103), automated driving system 46 ends the processing. In this case, for example, automated driving system 46 may transmit, to terminal 10 of operator A, a notification indicating refusal of acceptance of the responsibility assignment request. Furthermore, when automated driving system 46 determines that remote operation or remote assistance does not exist (No in S103), automated driving system 46 notifies acceptance of the responsibility assignment request (S131), and starts the control responsibility state (S132). When automated driving system 46 transmits, to terminal 10 of operator A, a notification indicating acceptance of the responsibility assignment request, and receives the information indicating (who has) the control responsibility for mobile body 40 and the information indicating (the grant of) the right to operate mobile body 40 from terminal 10 of operator A, automated driving system 46 may execute step S132.

### Variation 10 of the Embodiment

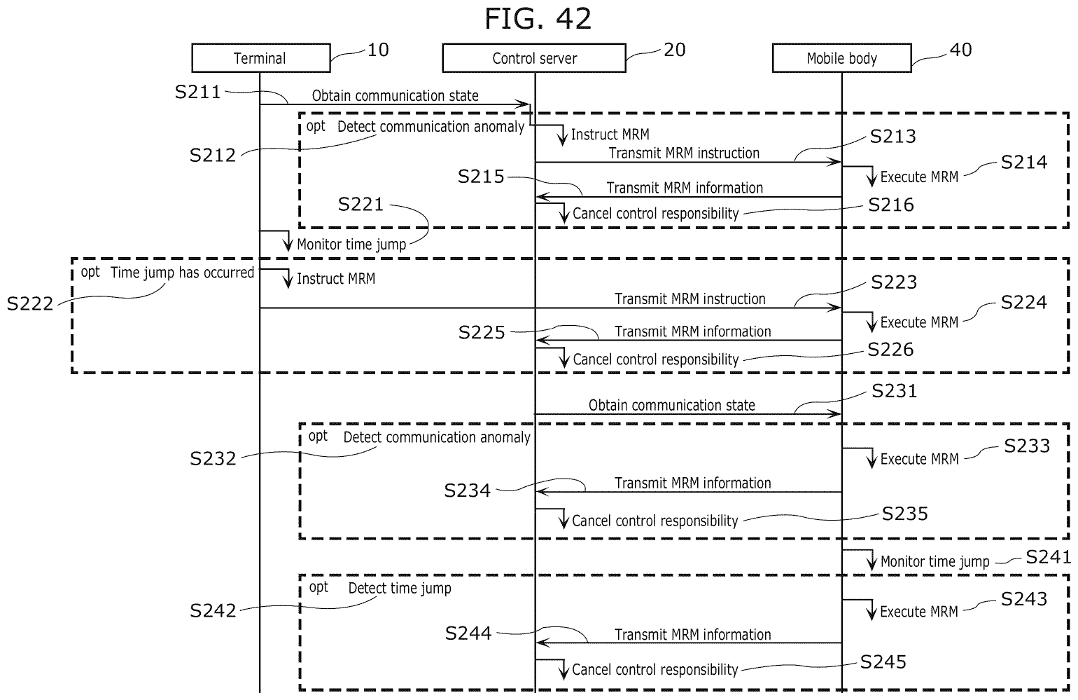

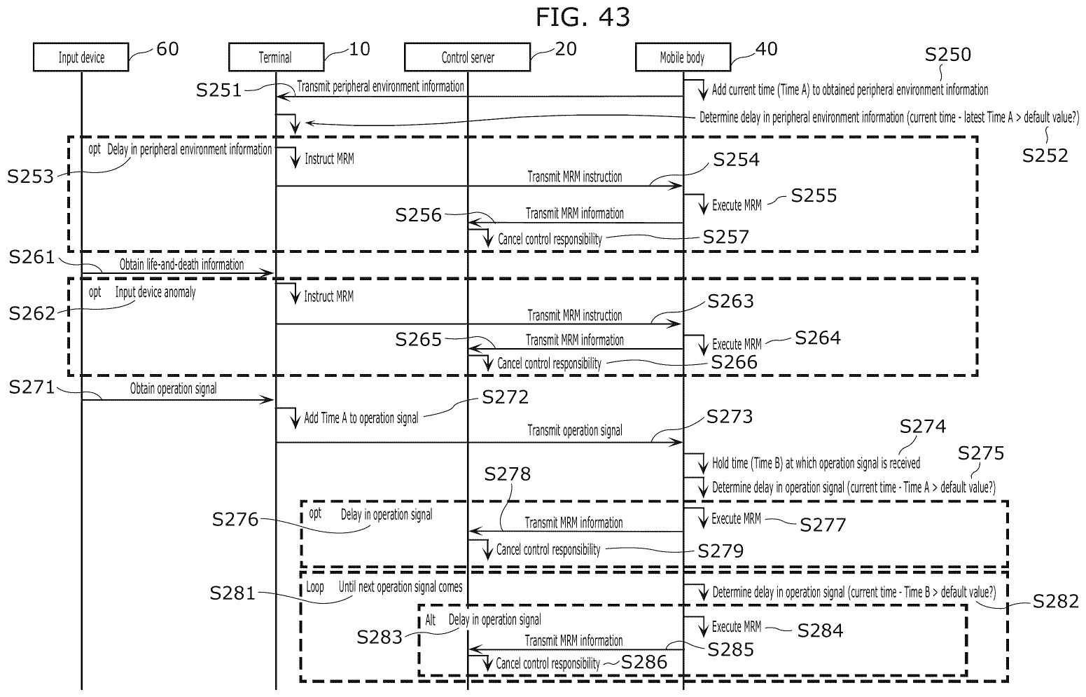

Hereinafter, remote control system 1 according to the present variation will be described with reference to FIG. 42 to FIG. 44. It should be noted that, hereinafter, differences from the embodiment will be mainly described, and a description of contents that are the same as or similar to the embodiment will be omitted or simplified. In the present variation, a description will be given of various operation examples for transitioning mobile body 40 to a safety state in a case where operator 50 is no longer able to bear the control responsibility (for example, unable to perform monitoring/operation, the control quality is degraded) in remote control system 1.

FIG. 42 is a sequence diagram illustrating a first example of operations in a case where it becomes impossible to fulfill the control responsibility in remote control system 1 according to the present variation. In FIG. 42, each pattern for executing an MRM is surrounded by a dashed line box. In FIG. 42, for convenience, four patterns for executing an MRM are illustrated. It is assumed that there is no temporal context for the four patterns.

As illustrated in FIG. 42, in a first pattern, first, communication information obtainer 130 of control server 20 obtains a communication state from terminal 10 (S211). Communication information obtainer 130 may obtain, for example, malfunction of a communication device of terminal 10, the communication delay in the communication between terminal 10 and control server 20, and the like as the communication state.

Next, when a communication anomaly is detected based on the communication state (S212), MRM instructor 131 generates an MRM instruction for causing mobile body 40 to execute an MRM, and operation signal transmitter 129 transmits the generated MRM instruction to mobile body 40 (S213).

When MRM executor 41 of mobile body 40 obtains the MRM instruction from MRM instructor 131, MRM executor 41 executes an MRM (S214), and transmits, to control server 20, the MRM information indicating that the MRM has been executed (S215). Mobile body information transmitter 127 of control server 20 obtains the MRM information.

When the MRM information from mobile body 40 is obtained, control state manager 121 of control server 20 cancels the control responsibility of operator 50 who has the control responsibility for the mobile body 40 (S216). Control state manager 121 may provide, for example, a notification indicating that the control responsibility has been canceled to terminal 10 of the operator 50.

As described above, in the first pattern, when a communication anomaly occurs between terminal 10 and control server 20, it is possible to cause mobile body 40 to execute an MRM, and the control responsibility for the mobile body 40 can be canceled.

Subsequently, in a second pattern, first, terminal monitoring unit 120 of terminal 10 is monitoring whether or not a time jump has occurred in terminal 10 (S221).

Next, when it is detected that a time jump has occurred by terminal monitoring unit 120 (S222), MRM instructor 118 generates an MRM instruction for mobile body 40, and operation signal transmitter 216 transmits the generated MRM instruction to mobile body 40 (S223).

When MRM executor 41 of mobile body 40 obtains the MRM instruction from operation signal transmitter 216, MRM executor 41 executes an MRM (S224), and transmits the MRM information indicating that the MRM has been executed to control server 20 (S225). Mobile body information transmitter 127 of control server 20 obtains the MRM information.

When the MRM information from mobile body 40 is obtained, control state manager 121 of control server 20 cancels the control responsibility of operator 50 who has the control responsibility for the mobile body 40 (S226).

As described above, in the second pattern, when a time jump occurs in terminal 10, it is possible to cause mobile body 40 to execute an MRM, and cause the control responsibility for the mobile body 40 to be canceled.

Subsequently, in a third pattern, first, communication information obtainer 44 of mobile body 40 obtains the communication state from control server 20 (S231). Communication information obtainer 44 may obtain, for example, the communication delay in the communication between control server 20 and mobile body 40 as the communication state.

Next, when a communication anomaly is detected based on the communication state (S232), MRM executor 41 executes an MRM (S233), and transmits, to control server 20, the MRM information indicating that the MRM has been executed (S234). Mobile body information transmitter 127 of control server 20 obtains the MRM information.

When the MRM information from mobile body 40 is obtained, control state manager 121 of control server 20 cancels the control responsibility of operator 50 who has the control responsibility for the mobile body 40 (S235).

As described above, in the third pattern, when a communication anomaly occurs between control server 20 and mobile body 40, mobile body 40 can execute an MRM, and the control responsibility for the mobile body 40 can be canceled.

Subsequently, in a fourth pattern, first, mobile body monitoring unit 45 is monitoring whether a time jump has occurred in mobile body 40 (S241).

Next, when it is detected that a time jump has occurred by mobile body monitoring unit 45 (S242), MRM executor 41 executes an MRM (S243), and transmits, to control server 20, the MRM information indicating that the MRM has been executed (S244). Mobile body information transmitter 127 of control server 20 obtains the MRM information.

When the MRM information from mobile body 40 is obtained, control state manager 121 of control server 20 cancels the control responsibility of operator 50 who has the control responsibility for the mobile body 40 (S245).

As described above, in the fourth pattern, when a time jump occurs in mobile body 40, mobile body 40 can execute an MRM, and the control responsibility for the mobile body 40 can be canceled.

FIG. 43 is a sequence diagram illustrating a second example of operations in a case where it becomes impossible to fulfill the control responsibility in remote control system 1 according to the present variation. Also in FIG. 43, for convenience, four patterns for executing an MRM are illustrated. It is assumed that there is no temporal context for the four patterns.

Furthermore, remote control system 1 further includes input device 60. Input device 60 is equipment that is used by operator 50 to remotely operate mobile body 40, and that is for operating, for example, a steering wheel, a brake, and the like.

As illustrated in FIG. 43, in a fifth pattern, first, mobile body 40 obtains the peripheral environment information, and adds the current time (Time A) to the obtained peripheral environment information (S250). For example, the peripheral environment information may be obtained via peripheral environment information transmitter 128 of control server 20. Then, mobile body 40 transmits, to terminal 10, the peripheral environment information to which current time has been added.

Next, terminal 10 obtains the peripheral environment information from mobile body 40 (S251).

Next, terminal communication information obtainer 117 of terminal 10 determines whether or not a delay has occurred in the peripheral environment information based on the obtained peripheral environment information (S252). Terminal communication information obtainer 117 may perform the determination in step S252 based on, for example, whether or not the following Math. 1 is satisfied.

Current time−latest time>default value (Math. 1)

The latest time is the time at which the latest peripheral environment information is obtained. Terminal communication information obtainer 117 determines that a delay has occurred when Math. 1 is satisfied, and determines that a delay has not occurred when Math. 1 is not satisfied.

When a delay is detected in the peripheral environment information by terminal communication information obtainer 117 (S253), MRM instructor 118 generates an MRM instruction to mobile body 40, and operation signal transmitter 216 transmits the generated MRM instruction to mobile body 40 (S254).

When the MRM instruction from operation signal transmitter 216 is obtained, MRM executor 41 of mobile body 40 executes an MRM (S255), and transmits, to control server 20, the MRM information indicating that the MRM has been executed (S256). Mobile body information transmitter 127 of control server 20 obtains the MRM information.

When the MRM information from mobile body 40 is obtained, control state manager 121 of control server 20 cancels the control responsibility of operator 50 who has the control responsibility for the mobile body 40 (S257).

As described above, in the fifth pattern, when a delay has occurred in the peripheral environment information obtained by terminal 10, it is possible to cause mobile body 40 to execute an MRM, and the control responsibility for the mobile body 40 can be canceled.

Subsequently, in a sixth pattern, first, input equipment state obtainer 218 of terminal 10 obtains life-and-death information from input device 60 (S261). The life-and-death information is the information indicating the state of input device 60, and includes, when an anomaly occurs in input device 60, the information indicating the occurrence of the anomaly.

When an anomaly in input device 60 is detected by input equipment state obtainer 218 (S262), MRM instructor 219 generates an MRM instruction to mobile body 40, and operation signal transmitter 216 transmits the generated MRM instruction to mobile body 40 (S263).

When the MRM instruction is obtained from operation signal transmitter 216, MRM executor 41 of mobile body 40 executes an MRM (S264), and transmits, to control server 20, the MRM information indicating that the MRM has been executed (S265). Mobile body information transmitter 127 of control server 20 obtains the MRM information.

When the MRM information from mobile body 40 is obtained, control state manager 121 of control server 20 cancels the control responsibility of operator 50 who has the control responsibility for the mobile body 40 (S266).

As described above, in the sixth pattern, when an anomaly occurs in input device 60, it is possible to cause mobile body 40 to execute an MRM, and the control responsibility for the mobile body 40 can be canceled.

Subsequently, in a seventh pattern, first, when operation signal transmitter 216 of terminal 10 obtains an operation signal from input device 60 (S271), operation signal transmitter 216 adds Time A (a timestamp) to the operation signal (S272), and transmits, to mobile body 40, the operation signal to which Time A has been added (S273).

When communication information obtainer 44 of mobile body 40 obtains the operation signal, communication information obtainer 44 holds the reception time (Time B) that is the time at which the operation signal is obtained (S274), and determines whether or not a delay has occurred in the operation signal (S275). Communication information obtainer 44 may perform the determination in step S275 based on, for example, whether or not the following Math. 2 is satisfied.

Current time−Time A>default value (Math. 2)

When a delay in the operation signal is detected by communication information obtainer 44 (S276), MRM executor 41 executes an MRM (S277), and transmits, to control server 20, the MRM information indicating that the MRM has been executed (S278). Mobile body information transmitter 127 of control server 20 obtains the MRM information.

When the MRM information from mobile body 40 is obtained, control state manager 121 of control server 20 cancels the control responsibility of operator 50 who has the control responsibility for the mobile body 40 (S279).

As described above, in the seventh pattern, when a delay in transmitting the operation signal from terminal 10 to mobile body 40 is longer than the default value, it is possible to cause mobile body 40 to execute an MRM, and the control responsibility for the mobile body 40 can be canceled.

Subsequently, in an eighth pattern, after Time B is held in step S274, waiting is performed until the next operation signal comes (S281). While waiting, communication information obtainer 44 determines whether or not a delay has occurred in the operation signal (S282). Communication information obtainer 44 may perform the determination in step S282 based on, for example, whether or not the following Math. 3 is satisfied.

Current time−Time B>default value (Math. 3)

That is, communication information obtainer 44 determines whether or not a time longer than the default value has elapsed since the previous obtaining of the operation signal. When the left side is larger than the default value in Math. 3, communication information obtainer 44 determines that a delay has occurred in the operation signal.

When a delay in the operation signal is detected by communication information obtainer 44 (S283), MRM executor 41 executes an MRM (S284), and transmits, to control server 20, the MRM information indicating that the MRM has been executed (S285). Mobile body information transmitter 127 of control server 20 obtains the MRM information.

When the MRM information from mobile body 40 is obtained, control state manager 121 of control server 20 cancels the control responsibility of operator 50 who has the control responsibility for the mobile body 40 (S286).

As described above, in the eighth pattern, when the time interval for obtaining the operation signal becomes longer than the default value in mobile body 40, it is possible to cause mobile body 40 to execute an MRM, and the control responsibility for the mobile body 40 can be canceled.

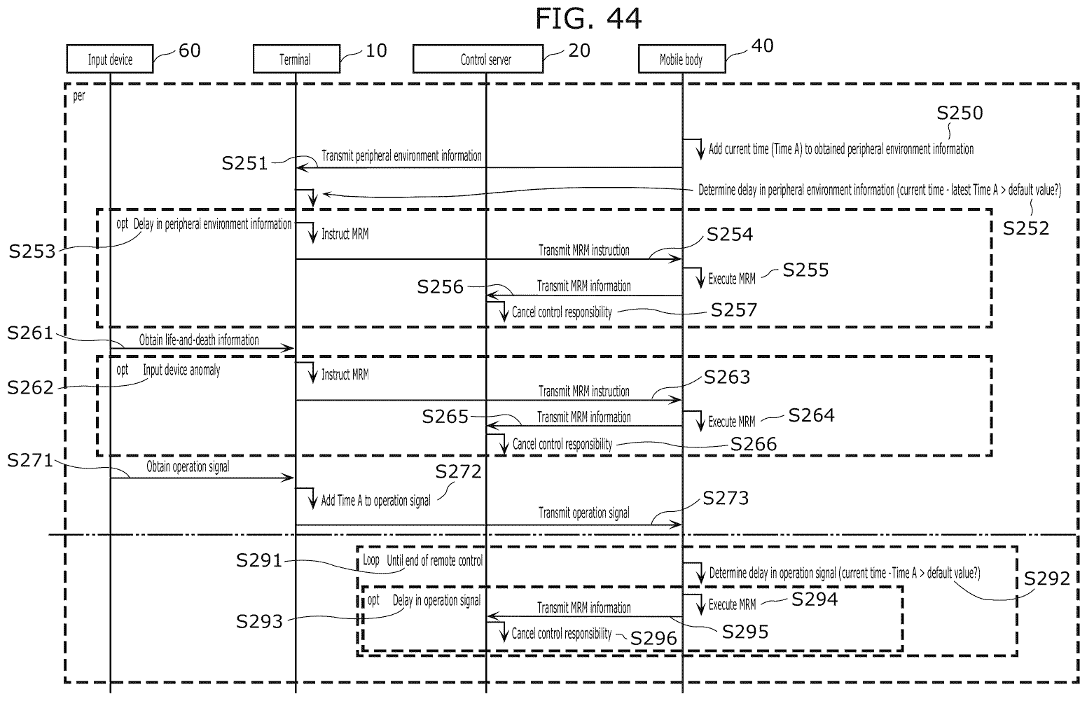

FIG. 44 is a sequence diagram illustrating a third example of operations in a case where it becomes impossible to fulfill the control responsibility in remote control system 1 according to the present variation. Since the operations in steps S250 to S273 are similar to those in FIG. 43, a description thereof is omitted. Furthermore, it is assumed that the operation signal in step S273 is transmitted to mobile body 40 from terminal 10 continuously (for example, at predetermined time intervals). Furthermore, the operations in steps S250 to S273 and the operations in steps S291 to S296 are executed in parallel, for example (refer to “per” in FIG. 44).

As illustrated in FIG. 44, in a ninth pattern, the following processing is repeatedly executed in remote control system 1 until the end of the remote operation (S291).

Communication information obtainer 44 determines whether or not a delay has occurred in the operation signal (S292). Communication information obtainer 44 may perform the determination in step S292 based on, for example, whether or not Math. 2 described above is satisfied.

When a delay in the operation signal is detected by communication information obtainer 44 (S293), MRM executor 41 executes an MRM (S294), and transmits, to control server 20, the MRM information indicating that the MRM has been executed (S295). Mobile body information transmitter 127 of control server 20 obtains the MRM information.

When the MRM information from mobile body 40 is obtained, control state manager 121 of control server 20 cancels the control responsibility of operator 50 who has the control responsibility for the mobile body 40 (S296).

As described above, in the ninth pattern, when the operation signal is transmitted continuously, a delay in the operation signal can be determined by one determination processing, and the processing amount for the determination processing can be reduced.

As described above, when a communication anomaly occurs between terminal 10, control server 20, and mobile body 40, or a delay cannot be correctly measured, an MRM may be executed. Furthermore, when the time for obtaining the information from mobile body 40 and presenting, to operator 50, the peripheral environment information and the mobile body information of mobile body 40, and the time from when operator 50 performs an operation until the operation is reflected in mobile body 40 cannot be made less than a certain period of time, an MRM may be executed. Furthermore, as described above, when an anomaly in remote control system 1 including terminal 10, control server 20, and mobile body 40 is detected, an MRM may be executed.

### Variation 11 of the Embodiment

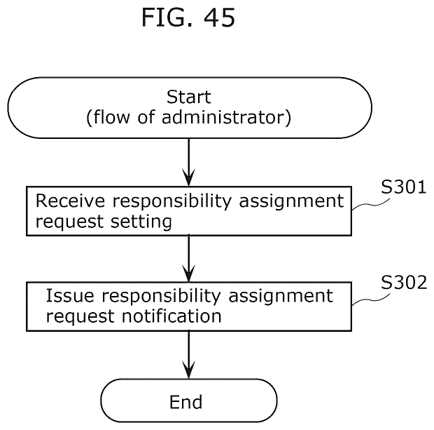

Hereinafter, remote control system 1 according to the present variation will be described with reference to FIG. 45 to FIG. 50. It should be noted that, hereinafter, differences from the embodiment will be mainly described, and a description of contents that are the same as or similar to the embodiment will be omitted or simplified. In the present variation, a description will be given of a case of setting, by an administrator (system administrator) of remote control system 1, an operator who sends an assignment request, and an operator who accepts the assignment request.

It should be noted that the administrator is the person who manage a plurality of operators 50. The administrator manages the remote control situations and the like of the plurality of operators 50. The administrator may be, for example, the person who does not actually perform remote control. Furthermore, the administrator may be located at, for example, a remote control center at which the plurality of operators 50 are located, or may be located at a facility distant from the remote control center.

FIG. 45 is a flowchart illustrating the operations (information processing method) of remote control system 1 according to the present variation. FIG. 45 illustrates the flowchart in a case of receiving an input from the administrator to perform an operation. The operations illustrated in FIG. 45 are executed by, for example, control server 20, but this is not a limitation. It should be noted that an information processing device, an input device, and a display device (not illustrated) that are used by the administrator are communicatively connected to control server 20. The information processing device is, for example, a PC, the input device is, for example, a keyboard, a mouse, a touch panel, a sound collection device, and the like, and is connected to the information processing device, and the display device is, for example, an LCD device or the like, and is connected to the information processing device.

As illustrated in FIG. 45, control server 20 receives a responsibility assignment request setting from the administrator (S301). Control server 20 obtains, for example, via communication, the information indicating the responsibility assignment request setting that is input to the input device by the administrator. The information includes the information indicating operator 50 of the side sending a responsibility assignment request, and the information indicating operator 50 of the side receiving the responsibility assignment request.

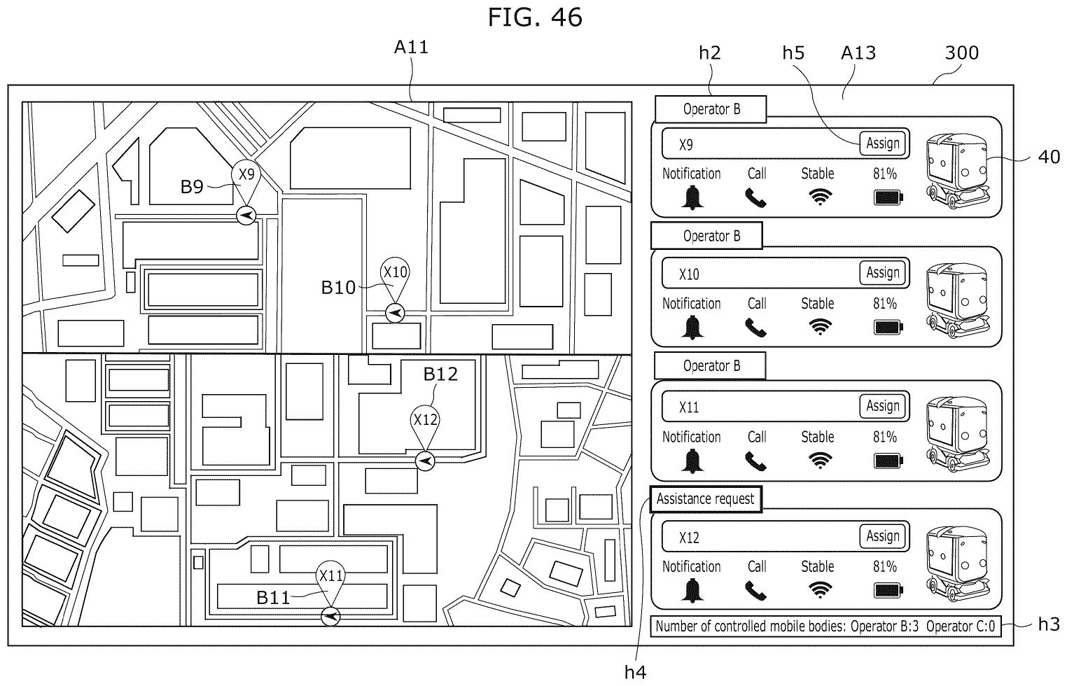

FIG. 46 is a diagram illustrating a screen that is displayed in display portion 300 of the administrator in remote control system 1 according to the present variation. FIG. 46 is the screen obtained by changing first displays h1 in the screen illustrated in FIG. 18 to fifth displays h5.

Fifth display h5 is displayed for each of a plurality of mobile bodies 40, and when fifth display h5 is pressed by the administrator, the processing for assigning the control responsibility for mobile body 40 corresponding to pressed fifth display h5 to the other operator 50 is executed. For example, when fifth display h5 of mobile body 40 having a mobile body ID of “X9” is pressed, the processing for assigning the control responsibility for the mobile body 40 from operator B to the other operator 50 is executed.

It should be noted that display portion 300 may display, when fifth display h5 is pressed, the information for selecting operator 50 to whom assignment is to be made. The information may include a list of the other operators 50, or may include the remote control situations of the other operators 50.

Hereinafter, operator 50 from whom assignment is made is also simply referred to as operator 50, and operator 50 to whom assignment is made is also referred to as the other operator 50.

With reference to FIG. 45 again, next, control server 20 issues a responsibility assignment request notification (S302). Assignment request notifier 122 of control server 20 transmits, to terminal 10 of operator 50, who has been set by the administrator, of the side sending the responsibility assignment request, the responsibility assignment request notification for assigning the control responsibility to the other operator 50. Furthermore, assignment request notifier 122 transmits, to terminal 10 of operator 50 (the other operator 50), who has been set by the administrator, of the side receiving the responsibility assignment request, the responsibility assignment request notification for accepting assignment of the control responsibility from current operator 50.

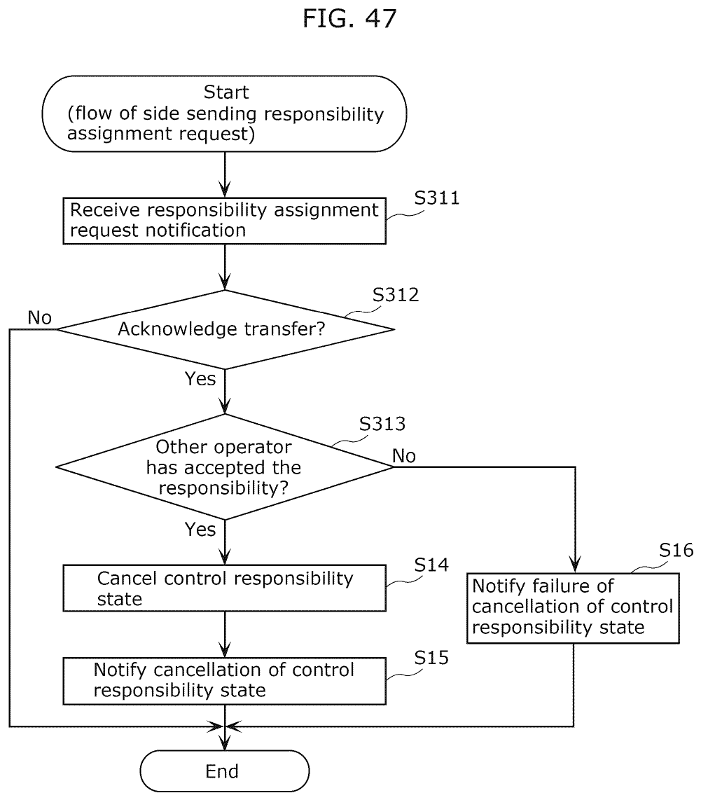

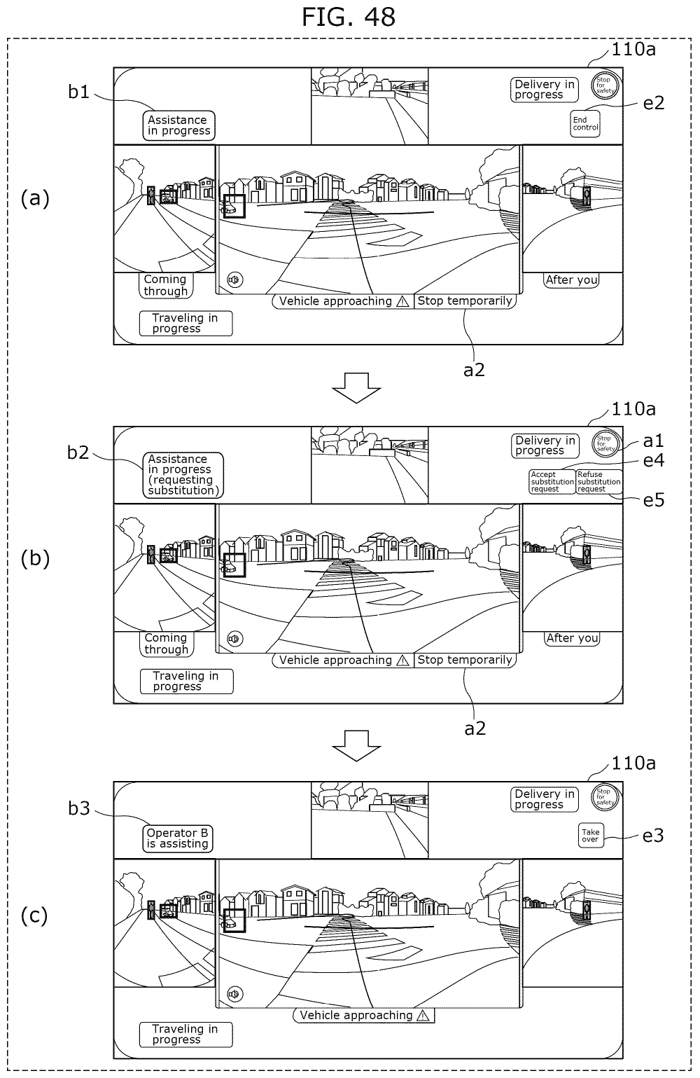

Subsequently, the operations of terminal 10 of the side sending the responsibility assignment request will be described with reference to FIG. 47 and FIG. 48. FIG. 47 is a flowchart illustrating the operations (information processing method) of the side sending the responsibility assignment request in remote control system 1 according to the present variation. FIG. 47 illustrates the operations to be executed by terminal 10 of operator 50 when assigning the control responsibility of the operator 50 who is currently remotely assisting mobile body 40. FIG. 48 is a diagram illustrating screens that are displayed in display portion 110a of the side sending the responsibility assignment request in remote control system 1 according to the present variation. FIG. 48 illustrates an example of the screens that are displayed in display portion 110a to be checked by operator 50.

As illustrated in (a) in FIG. 48, “assistance in progress”, which is status display b1 indicating that operator 50 has the control responsibility is displayed in display portion 110a by control state presenter 111, and button display e2 for ending the control is displayed by start and end input unit 215.

As illustrated in FIG. 47, terminal 10 receives a responsibility assignment request notification transmitted by assignment request notifier 122 of control server 20 (S311).

As illustrated in (b) in FIG. 48, when the responsibility assignment request notification is received, control state presenter 111 switches the display from status display b1 to “assistance in progress (requesting substitution)”, which is status display b2 indicating that the assignment request for the control responsibility is being made. That is, status display b2 is presented to operator 50. Accordingly, it is possible to report, to operator 50, that the assignment request for the control responsibility is being made by the administrator. It should be noted that the information indicating that the assignment request is being made by the administrator may be displayed in status display b2.

Furthermore, assignment request response input unit 211 of terminal 10 displays “accept substitution request”, which is button display e4 indicating acceptance of the assignment request, and “refuse substitution request”, which is button display e5 indicating refusal of the assignment request. Button display e4 here is the button for accepting the assignment of the control responsibility to the other operator 50 who is set by the administrator, and button display e5 is the button for not accepting the assignment of the control responsibility to the other operator 50.

Next, terminal 10 determines whether or not to acknowledge the transfer of the control responsibility for mobile body 40 that is set by the administrator (S312). When terminal 10 receives, from operator 50, an input indicating that the transfer is acknowledged (for example, when button display e4 is operated), terminal 10 determines that the acknowledgement has been made (Yes in S312), and the processing proceeds to step S313. Furthermore, when terminal 10 receives, from operator 50, an input indicating that the transfer is not acknowledged (for example, when button display e5 is operated), or when there is no input indicating that the transfer is acknowledged for a predetermined time period (No in S312), terminal 10 ends the processing.

It should be noted that when No in step S312, terminal 10 may transmit, to control server 20, the information indicating that the transfer has not been acknowledged. Accordingly, the administrator can be notified that the transfer has not been acknowledged. Furthermore, when No in step S312, terminal 10 may transmit, to terminal 10 of the other operator 50, the information indicating that the transfer has not been acknowledged. Accordingly, the other operator 50 can be notified that the transfer has not been acknowledged.

Next, when the determination in step S312 is Yes, terminal 10 further determines whether or not the other operator 50 has accepted the responsibility (S313). When terminal 10 obtains, from terminal 10 of the other operator 50, the information indicating that the other operator 50 has acknowledged the acceptance, terminal 10 determines that the other operator 50 has accepted the responsibility (Yes in S313), and the processing proceeds to step S14. Furthermore, when terminal 10 obtains, from terminal 10 of the other operator 50, the information indicating that the other operator 50 has not acknowledged the acceptance, terminal 10 determines that the other operator 50 has not accepted the responsibility (No in S313), and the processing proceeds to step S16.

As illustrated in (c) in FIG. 48, control state presenter 111 switches the display from status display b2 to “operator B is assisting”, which is status display b3 indicating that the transition to the control responsibility state (the state with control responsibility) is completed. Accordingly, it is possible to report, to operator 50, that the control responsibility state is canceled, and the control responsibility has been transferred to the other operator 50 (operator B). At this time, operation display a2 is switched to the inactive (for example, undisplayed) state. Accordingly, it becomes impossible for operator 50 to operate mobile body 40. That is, the right to operate mobile body 40 is assigned to the other operator 50.

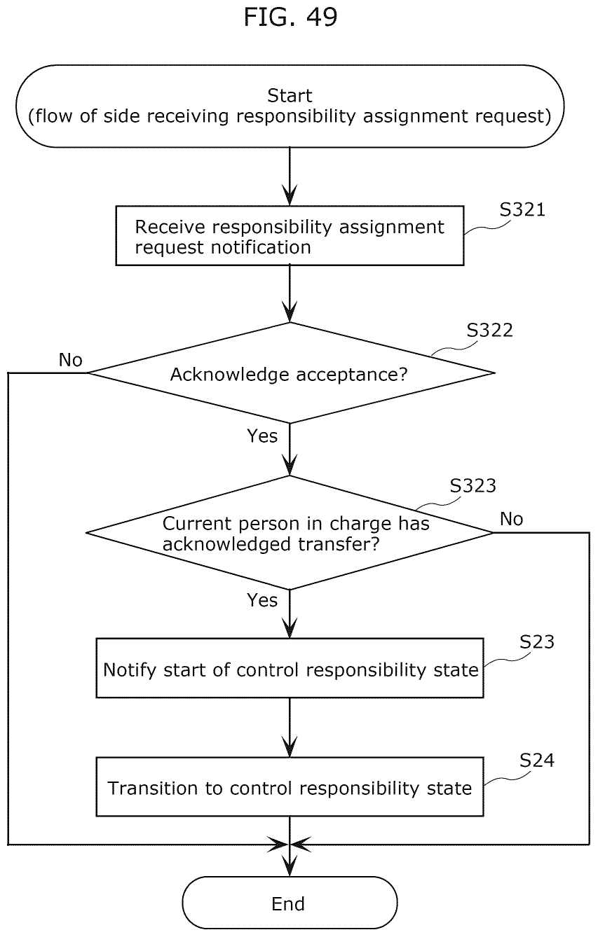

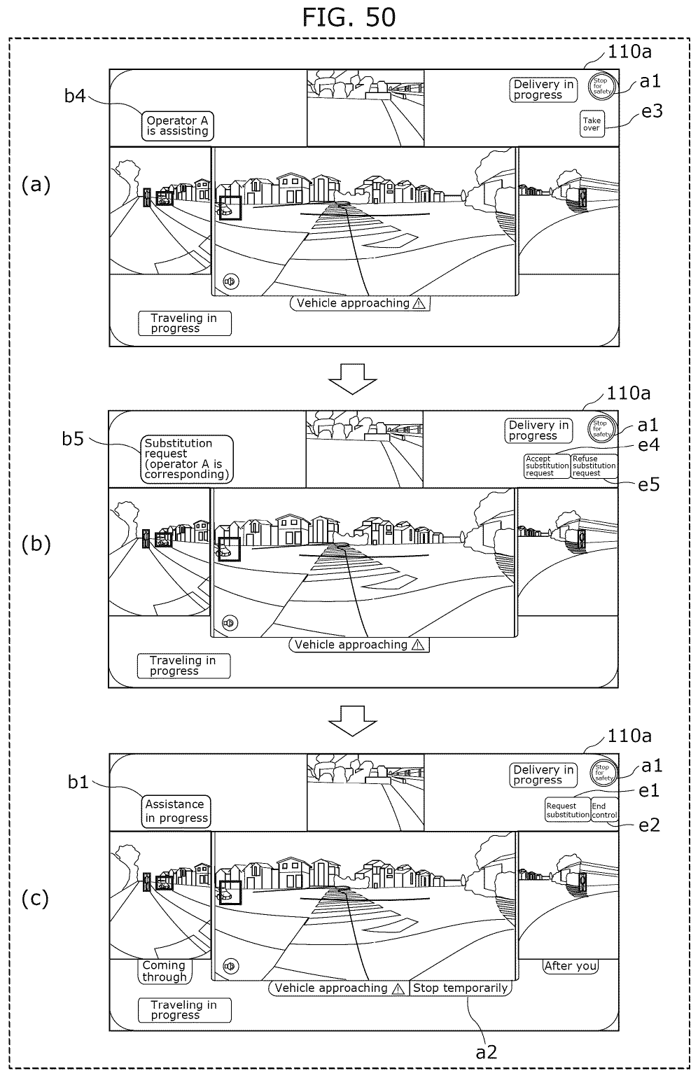

Subsequently, the operations of terminal 10 of the side receiving the responsibility assignment request will be described with reference to FIG. 49 and FIG. 50. FIG. 49 is a flowchart illustrating the operations (information processing method) of the side receiving the responsibility assignment request in remote control system 1 according to the present variation. FIG. 50 is a diagram illustrating screens that are displayed in display portion 110a of the side receiving the responsibility assignment request in remote control system 1 according to the present variation. FIG. 50 illustrates an example of the screens that are displayed in display portion 110a to be checked by the other operator 50.

As illustrated in (a) in FIG. 50, during remote monitoring, “operator A is assisting”, which is status display b4 indicating that operator 50 (operator A) has the control responsibility, is displayed in display portion 110a by control state presenter 111.

As illustrated in FIG. 49, terminal 10 receives a responsibility assignment request notification transmitted by assignment request notifier 122 of control server 20 (S321).

As illustrated in (b) in FIG. 50, when the responsibility assignment request notification is received, assignment request presenter 112 switches the display from status display b4 to “substitution request (operator A is corresponding),” which is status display b5 indicating that the assignment request (substitution request) is notified. Accordingly, it is possible to report, to the other operator 50, that the assignment request of the control responsibility is being made. It should be noted that status display b5 may display the information indicating that the assignment request is being made by the administrator.

Furthermore, assignment request response input unit 211 displays “accept substitution request”, which is button display e4 indicating acceptance of the assignment request that is set by the administrator, and “refuse substitution request”, which is button display e5 indicating refusal of the assignment request that is set by the administrator. Button display e4 here is the button for accepting the assignment of the control responsibility to the other operator 50 who is set by the administrator, and button display e5 is the button for not accepting the assignment of the control responsibility to the other operator 50.

Next, terminal 10 determines whether or not to acknowledge acceptance of the control responsibility for mobile body 40 that is set by the administrator (S322). When terminal 10 receives, from the other operator 50, an input indicating that the acceptance is acknowledged (for example, when button display e4 is operated), terminal 10 determines that the acknowledgement has been made (Yes in S322), and the processing proceeds to step S323. Furthermore, when terminal 10 receives, from the other operator 50, an input indicating that the acceptance is not acknowledged (for example, when button display e5 is operated), or when there is no input indicating that the acceptance is acknowledged for a predetermined time period (No in S322), terminal 10 ends the processing.

It should be noted that when No in step S322, terminal 10 may transmit, to control server 20, the information indicating that the acceptance has not been acknowledged. Accordingly, the administrator can be notified that the acceptance has not been acknowledged. Furthermore, when No in step S322, terminal 10 may transmit, to terminal 10 of operator 50, the information indicating that the acceptance has not been acknowledged. Accordingly, operator 50 can be notified that the acceptance has not been acknowledged.

Next, when the determination in step S322 is Yes, terminal 10 further determines whether or not the current person in charge (here, operator 50) has acknowledged the transfer (S323). When terminal 10 obtains, from terminal 10 of operator 50, the information indicating that operator 50 has acknowledged the transfer, terminal 10 determines that operator 50 has acknowledged the transfer (Yes in S323), and the processing proceeds to step S23. Furthermore, when terminal 10 obtains, from terminal 10 of operator 50, the information indicating that operator 50 has not acknowledged the transfer, terminal 10 determines that operator 50 has not acknowledged the transfer (No in S323), and ends the processing.

As illustrated in (c) in FIG. 50, when the responsibility assignment request notification is accepted, control state presenter 111 switches the display from status display b5 to “assistance in progress”, which is status display b1 indicating that remote assistance is in progress and the other operator 50 has the control responsibility. Furthermore, operation signal transmitter 216 displays operation display a2 for temporarily stopping mobile body 40 for which the control responsibility has been accepted. That is, operation display a2 becomes active. Accordingly, it is reported to operator 50 that transition to the control responsibility state has been made, and the right to operate mobile body 40 (operation display a2) is transferred. Furthermore, assignment request input unit 212 switches button displays e4 and e5 to button displays e1 and e2.

### OTHER EMBODIMENTS

Although a remote control system, and so on, according to one or more aspects has been described above based on the foregoing embodiments, and so on, the present disclosure is not limited to the foregoing embodiments, and so on. Forms realized by various modifications to the embodiments conceived by a skilled person as well as forms realized by a combination of the constituent elements in different embodiments, so long as they do not depart from the essence of the present disclosure, may be included in the present disclosure.

For example, the configuration illustrated by each variation of the above-described embodiment may be realized as, for example, an individual apparatus. For example, the remote control system illustrated in FIG. 42 to FIG. 44 need not have, for example, the configuration that executes the processing regarding assignment of the control responsibility illustrated in the embodiment. For example, in such an information processing method, when an anomaly relating to the communication between a terminal of a first operator and a first mobile body, or an anomaly in a system including the terminal and the mobile body is detected, the first mobile body is caused to execute an MRM. Furthermore, for example, such an information processing system includes an obtainer that obtains that an anomaly relating to the communication between the terminal of the first operator and the first mobile body, or an anomaly in the system including the terminal and the first mobile body is detected, and an MRM instructor (or an MRM executor) that causes the first mobile body to execute an MRM when any of the anomalies is detected.

Furthermore, in the above-described embodiment and the like, when a plurality of operators attempt to perform assistance/operation for the same mobile body, the terminal or the control server may refuse the operators who attempt to perform assistance/operation later. For example, when the plurality of operators simultaneously perform an operation of approving an assignment request, or when the plurality of operators simultaneously perform an operation of starting assistance/operation, the terminal or the control server may refuse the operation of approving or starting that is performed by the operators who have performed the operation later. For example, the terminal or the control server may refuse the operation that indicates assignment of assistance/operation is possible, and that is performed by the operators whose orders are second or later, or predetermined number or later. For example, the terminal or the control server may assign the responsibility for a mobile body and the right to operate the mobile body to the operator who has first performed the operation of acknowledging an assignment request.

Furthermore, in the above-described embodiment and the like, when a period (or an accumulated period) during which an operator has the responsibility is equal to or more than a certain period of time, the terminal or the control server may automatically send an assignment request to the other operators. Furthermore, when the terminal or the control server monitors an operator's vital signs, and detects an anomaly in the operator, the terminal or the control server may automatically send an assignment request to the other operators, or an MRM may be executed.

Furthermore, in the above-described embodiment and the like, the terminal or the control server may preferentially transmit an assignment request notification an operator whose number of controlled mobile bodies is smaller among the plurality of operators. For example, the terminal or the control server may preferentially transmit an assignment request notification to an operator whose number of controlled mobile bodies is a predetermined number or less, or a predetermined number of lower ranking operators whose numbers of controlled mobile bodies are smaller.

Furthermore, in the above-described embodiment and the like, the transmission destination of an assignment request may be determined by the system administrator of the remote control system. In this case, the remote control system includes a receptor that receives an input from the system administrator. The receptor may be a touch panel, a button, and the like, and may have a configuration that receives an input by sound, gesture, or the like.

Furthermore, in the above-described embodiment and the like, when an assignment request is acknowledged, the right to operate a mobile body may be assigned after the control responsibility is assigned, or the control responsibility may be assigned after the right to operate the mobile body is assigned. Furthermore, for example, when the control responsibility is assigned from operator A to operator B, there may be a temporary time period during which each of operators A and B has the right to operate one mobile body. It should be noted that, in this case, only one of operators A and B may have the control responsibility. Furthermore, the same applies to the timing in a case where the control responsibility for a mobile body and the right to operate the mobile body are assigned from one of the automated driving system and the operator to the other.

Furthermore, in the remote control systems according to the above-described embodiment and the like, the terminal and the mobile body may directly communicate with each other, or the terminal and the mobile body may communicate with each other via the control server. For example, when the terminal and the mobile body can directly communicate with each other, the remote control system need not include the control server. Furthermore, the terminal or the mobile body may include at least a part of the functions of the control server.

Furthermore, in the above embodiments, and so on, each the constituent elements may be implemented as dedicated hardware or may be realized by executing a software program suited to such constituent element. Alternatively, the constituent elements may be implemented by a program executor such as a CPU or a processor reading out and executing the software program recorded in a recording medium such as a hard disk or a semiconductor memory.

Furthermore, the processing order of executing the steps shown in the flowcharts is merely an illustration for specifically describing the present disclosure, and thus may be an order other than the order shown. Also, one or more of the steps may be executed simultaneously (in parallel) with another step, or one or more of the steps need not necessarily have to be executed.

Moreover, the divisions of the functional blocks shown in the block diagrams are mere examples, and thus a plurality of functional blocks may be implemented as a single functional block, or a single functional block may be divided into a plurality of functional blocks, or one or more functions may be moved to another functional block. Also, the functions of a plurality of functional blocks having similar functions may be processed by single hardware or software in a parallelized or time-divided manner.

Furthermore, the terminal or the management server according to the foregoing embodiments, and so on, may be implemented as a single device or may be implemented by a plurality of devices. When the terminal or the management server is implemented by a plurality of devices, each of the constituent elements included in the terminal or the management server may be distributed to the plurality of devices in any manner. When the terminal or the management server is implemented by a plurality of devices, the method of communication between the plurality of devices is not particularly limited, and may be wireless communication or wired communication. Furthermore, a combination of wireless and wired communication may be used between the devices.

Furthermore, each of the constituent elements described in the foregoing embodiments, and so on, may be implemented as software, and may typically be implemented as a large-scale integration (LSI) circuit, which is an integrated circuit (IC). The constituent elements may be implemented by individual chips, or some or all of the components may be implemented by a single chip. Although the integrated circuit implementing these constituent elements is referred to as an LSI here, the integrated circuit may be referred to as an IC, a system LSI, a super LSI, or an ultra LSI depending on the scale of integration. Moreover, a method of implementation of the constituent elements using an integrated circuit is not limited to application of an LSI. The elements may be implemented by a dedicated circuit (a general-general purpose circuit executing a dedicated program) or a general-purpose processor. It is also possible to use a field programmable gate array (FPGA) that can be programmed after being manufactured, or a reconfigurable processor in which connection and setting of circuit cells in an LSI can be reconfigured. Furthermore, when a circuit integration technology that replaces LSIs comes along owing to advances of the semiconductor technology or to a separate derivative technology, the constituent elements may understandably be integrated using that technology.

The system LSI is a super multifunctional LSI manufactured by integrating a plurality of processing units onto a single chip. More specifically, the system LSI is a computer system configured with a microprocessor, a read-only memory (ROM), a random access memory (RAM), and so on. The ROM stores a computer program. The microprocessor operates according to the computer program so that a function of the system LSI is achieved.

Furthermore, one aspect of the present disclosure may be a computer program for causing a computer to execute each of the characteristic steps included in the information processing method (remote control method) illustrated in any one of FIG. 7, FIG. 9, FIG. 11, FIG. 12, FIG. 14, FIG. 16, FIG. 17, FIG. 20, FIG. 22, FIG. 26, FIG. 30, FIG. 35, FIG. 37, FIG. 39, FIG. 40, FIG. 42 to FIG. 45, FIG. 47, and FIG. 49.

Moreover, for example, an aspect of the present disclosure may be a non-transitory computer-readable recording medium having recorded thereon such a program. For example, such a program may be distributed or circulated by being recorded on the recording medium. For example, by installing the distributed program into another device that includes a processor, and causing the processor to execute the program, it is possible to cause the device to perform the above-described processes.

### INDUSTRIAL APPLICABILITY

The present disclosure is useful in a remote control system for remotely controlling a mobile body.

1. An information processing method to be executed by an information processing system for remote control of one or more mobile bodies including a first mobile body by one or more operators including a first operator, the information processing method comprising:
obtaining an assignment request for assigning responsibility for remote control of the first mobile body to the first operator or an autonomous travel system of the first mobile body;
obtaining, from the first operator or the autonomous travel system, information on whether the assignment request obtained is acknowledged; and
assigning the responsibility for the first mobile body to the first operator or the autonomous travel system, when information acknowledging the assignment request is obtained.

2. The information processing method according to claim 1, further comprising:
assigning a right to operate the first mobile body to the first operator or the autonomous travel system independently of the responsibility for the first mobile body, when the information acknowledging the assignment request is obtained.

3. The information processing method according to claim 2, wherein
the responsibility for the first mobile body and the right to operate the first mobile body are assigned to the first operator or the autonomous travel system at mutually different timings.

4. The information processing method according to claim 3, wherein
the responsibility for the first mobile body is assigned to the first operator or the autonomous travel system at an earlier timing than the right to operate the first mobile body is.

5. The information processing method according to claim 3, wherein
the right to operate the first mobile body is assigned to the first operator or the autonomous travel system at an earlier timing than the responsibility for the first mobile body is.

6. The information processing method according to claim 2, further comprising:
presenting, to the first operator, that the responsibility for the first mobile body has been assigned to the first operator and that the right to operate the first mobile body has been assigned to the first operator, using mutually different modes.

7. The information processing method according to claim 2, wherein
the assignment request is a request for assigning part of the responsibility for the first mobile body, and
when an operation acknowledging the assignment request is obtained, the part of the responsibility for the first mobile body and part of the right to operate the first mobile body are assigned to the first operator or the autonomous travel system.

8. The information processing method according to claim 1, further comprising:
presenting details of the remote control performed on the first mobile body to the first operator, when the assignment request is obtained; and
after the presenting of the details, obtaining, from the first operator, an operation regarding whether the assignment request is acknowledged.

9. The information processing method according to claim 1, further comprising:
obtaining ability information indicating an ability of each of the one or more operators relating to the remote control; and
determining, based on the ability information obtained, whether the first operator has an ability suited for the remote control performed on the first mobile body, wherein
the assignment request for assigning the responsibility for the first mobile body to the first operator is obtained when the first operator is determined to have the ability suited for the remote control performed on the first mobile body.

10. The information processing method according to claim 1, wherein
the one or more operators include a second operator who performs remote control on the first mobile object,
the information processing method further comprises obtaining, from the second operator, an operation indicating assignment of the responsibility for the first mobile body,
the assignment request to the first operator is notified through the obtaining of the operation, and
the information processing method further comprises presenting, to the second operator, information indicating that the assignment request for the responsibility for the first mobile body is being notified.

11. The information processing method according to claim 1, wherein
the assignment request to the first operator is notified from the autonomous travel system.

12. The information processing method according to claim 2, wherein
the assignment request is transmitted to two or more terminals of two or more operators including the first operator, the two or more operators being included among the one or more operators, and
the responsibility for the first mobile body and the right to operate the first mobile body is assigned to the first operator when, among the two or more operators, the first operator is fastest to perform an operation acknowledging the assignment request.

13. The information processing method according to claim 2, wherein
the one or more mobile bodies include a second mobile body,
the one or more operators includes a third operator who performs remote control on the second mobile body, and
the information processing method further comprises:
obtaining, from the first operator, an operation requesting acceptance of assignment of responsibility for the remote control of the second mobile body;
transmitting, to a terminal of the third operator, an acceptance request requesting acceptance of assignment of the responsibility for the second mobile body, based on the operation obtained; and
transferring the responsibility for the second mobile body and a right to operate the second mobile body, from the third operator to the first operator, when an operation indicating that the third operator has acknowledged the acceptance request is obtained.

14. The information processing method according to claim 2, wherein
the one or more mobile bodies include a third mobile body that is not under remote control by the one or more operators, and
the information processing method further comprises:
presenting, to the first operator, information for remote control of the third mobile body;
obtaining, from the first operator, a fifth operation indicating that remote control of the third mobile body is to be started; and
transferring responsibility for the third mobile body and a right to operate the third mobile body to the first operator, based on the fifth operation obtained.

15. The information processing method according to claim 1, wherein
the one or more mobile bodies include a fourth mobile body,
the information processing method further comprises:
presenting, to the first operator, an operation component for receiving an operation indicating that remote control of the fourth mobile body is to be started, and
the operation component is enabled when an ability of the first operator relating to the remote control satisfies an ability relating to remote control required to continue autonomous travel of the fourth mobile body.

16. The information processing method according to claim 2, wherein
when the responsibility for the first mobile body and the right to operate the first mobile body are assigned to the first operator, another operator other than the first operator among the one or more operators is not permitted to bear the responsibility for the first mobile body without permission of the first operator.

17. The information processing method according to claim 2, further comprising:
causing the first mobile body to execute a Minimal Risk Maneuver (MRM) that causes the first mobile body to take evasive action, when an operation refusing the assignment request is obtained from the first operator.

18. The information processing method according to claim 2, further comprising:
causing the first mobile body to execute a Minimal Risk Maneuver (MRM) that causes the first mobile body to take evasive action, when an anomaly relating to communication between a terminal of the first operator and the first mobile body or an anomaly in a system including the terminal and the first mobile body is detected after the responsibility for the first mobile body and the right to operate the first mobile body are assigned to the first operator.

19. A terminal for remote control of one or more mobile bodies including a first mobile body by one or more operators including a first operator, the terminal comprising:
a first obtainer that obtains an assignment request for assigning responsibility for remote control of the first mobile body to the first operator or an autonomous travel system of the first mobile body;
a second obtainer that obtains, from the first operator or the autonomous travel system, information on whether the assignment request obtained is acknowledged; and
a processing unit that assigns the responsibility for the first mobile body to the first operator or the autonomous travel system, when information acknowledging the assignment request is obtained from the first operator or the autonomous travel system.

20. A non-transitory computer-readable recording medium having recorded thereon a program for causing a computer to execute the information processing method according to claim 1.
